(19) United States
(12) Patent Application Publication
(10) Pub. No.: US 2025/0029381 A1
(43) Pub. Date: Jan. 23, 2025

(54) METHOD EXECUTED BY ELECTRONIC DEVICE, ELECTRONIC DEVICE AND STORAGE MEDIUM PROVIDING AN EVENT RELATED TO A BEHAVIOR OBJECT

(71) Applicant: SAMSUNG ELECTRONICS CO., LTD., Suwon-si (KR)

(72) Inventors: Feiyu HUANG, Beijing (CN); Shizhuo Liu, Beijing (CN); Zhezhu Jin, Beijing (CN); Mengfei Yin, Beijing (CN); Dafeng Zhang, Beijing (CN); Xiaobing Wang, Beijing (CN); Woojhon Choi, Suwon-si (KR); Jiangbo Guo, Beijing (CN)

(73) Assignee: SAMSUNG ELECTRONICS CO ., LTD., Suwon-si (KR)

(21) Appl. No.: 18/640,232

(22) Filed: Apr. 19, 2024

(30) Foreign Application Priority Data
Jul. 20, 2023 (CN) 202310900041.5

(51) Int. Cl. G06V 20/40; G06T 5/20; G06T 7/194; G06V 10/25; G06V 10/44; G06V 10/80

(52) U.S. Cl. CPC G06V 20/44; G06T 5/20; G06T 7/194; G06V 10/25; G06V 10/44; G06V 10/806; G06V 2201/07

(57) ABSTRACT

According to an embodiment of the disclosure, a method may include acquiring behavior objects and relevant events associated with the behavior objects in a video to be processed by using an artificial intelligence (AI) network. According to an embodiment of the disclosure, the method may include providing a behavior object selection interface based on the acquired behavior objects. According to an embodiment of the disclosure, the method may include receiving a behavior object selected through the selection interface by a user. According to an embodiment of the disclosure, the method may include providing an event related to the behavior object selected by the user.

### CROSS REFERENCE TO RELATED APPLICATION(S)

The present application claims benefit of priority to Chinese Patent Application No. 202310900041.5 filed on Jul. 20, 2023; the content of the above application is hereby incorporated by reference.

### TECHNICAL FIELD

The present application relates to the technical field of artificial intelligence and computer vision, and in particular to a method executed by an electronic device, an electronic device, and a storage medium.

### BACKGROUND

With the increasing popularity and changing frequency of electronic devices such as mobile phones, users have higher and higher demands on the functions of electronic devices, one of which is the video processing capability. How to improve the video processing capability of electronic devices to better satisfy the actual application requirements is a persistent goal in the art.

### SUMMARY

According to an embodiment of the disclosure, a method may include acquiring behavior objects and relevant events associated with the behavior objects in a video to be processed by using an artificial intelligence (AI) network. According to an embodiment of the disclosure, the method may include providing a behavior object selection interface based on the acquired behavior objects. According to an embodiment of the disclosure, the method may include receiving a behavior object selected through the selection interface by a user. According to an embodiment of the disclosure, the method may include providing an event related to the behavior object selected by the user.

According to an embodiment of the disclosure, an electronic device may comprise at least one processor. According to an embodiment of the disclosure, the at least one processor may be configured to acquire behavior objects and relevant events associated with the behavior objects in a video to be processed by using an artificial intelligence (AI) network. According to an embodiment of the disclosure, the at least one processor may be configured to provide a behavior object selection interface based on the acquired behavior objects. According to an embodiment of the disclosure, the at least one processor may be configured to receive a behavior object selected through the selection interface by a user. According to an embodiment of the disclosure, the at least one processor may be configured to provide an event related to the behavior object selected by the user.

According to an embodiment of the disclosure, a computer-readable non-transitory storage medium having computer programs stored thereon that, when executed by a processor, implement the method. According to an embodiment of the disclosure, the at least one processor may be configured to acquire behavior objects and relevant events associated with the behavior objects in a video to be processed by using an artificial intelligence (AI) network. According to an embodiment of the disclosure, the at least one processor may be configured to provide a behavior object selection interface based on the acquired behavior objects. According to an embodiment of the disclosure, the at least one processor may be configured to receive a behavior object selected through the selection interface by a user. According to an embodiment of the disclosure, the at least one processor may be configured to provide an event related to the behavior object selected by the user.

### BRIEF DESCRIPTION OF THE DRAWINGS

In order to more clearly explain the technical solutions in the embodiments of the present application, the figures required to be used in the description of the embodiments of the present application will be briefly described below.

FIG. 1 is a schematic flowchart of a method executed by an electronic device according to an embodiment of the present application;

FIG. 2 is a principle diagram of a convolution operation according to an embodiment of the present application;

FIG. 3A is a schematic diagram of an adjacent dazzle transformer (ADT) network according to an embodiment of the present application;

FIG. 3B is a schematic diagram of an implementation principle of a specific convolution operation according to an embodiment of the present application;

FIG. 4 is a schematic flowchart of a method executed by an electronic device according to an embodiment of the present application;

FIG. 5 is a schematic flowchart of a video processing method according to an embodiment of the present application;

FIG. 6 is a schematic diagram of the flow of a video processing method and an AI network according to an embodiment of the present application;

FIG. 7 is a schematic flowchart of a video processing method according to an embodiment of the present application;

FIG. 8 is a schematic flowchart of another video processing method according to an embodiment of the present application;

FIG. 9A is a schematic diagram of generating an event clip according to an embodiment of the present application;

FIG. 9B is a schematic diagram of showing an event clip to a user according to an embodiment of the present application;

FIG. 10 is a schematic diagram of the flow of a video processing method and an AI network according to an embodiment of the present application;

FIG. 11 is a schematic flowchart of a video processing method according to an embodiment of the present application;

FIG. 12 is a schematic diagram of the visualization effect of a neural network according to an embodiment of the present application;

FIG. 13 is a schematic structure diagram of a neural network according to an embodiment of the present application;

FIG. 14 is a schematic structure diagram of a feature extraction module in a neural network according to an embodiment of the present application;

FIG. 15A is a principle diagram of feature extraction of a neural network according to an embodiment of the present application;

FIG. 15B is an effect diagram of an attention mechanism according to an embodiment of the present application;

FIG. 15C is a schematic diagram of a feature extraction process according to an embodiment of the present application;

FIG. 16A is a principle diagram of a convolution operation according to an embodiment of the present application;

FIG. 16B is an effect diagram of a convolution operation according to an embodiment of the present application;

FIG. 16C is a schematic diagram of comparison effects of different convolution operations according to an embodiment of the present application;

FIG. 17A is a principle and effect diagram of the offshoot of a patch in a feature map according to an embodiment of the present application;

FIG. 17B is a schematic diagram of a feature extraction process of a neural network according to an embodiment of the present application;

FIG. 18 is an effect diagram of a neural network according to an embodiment of the present application;

FIG. 19 is a schematic structure diagram of a neural network according to an embodiment of the present application;

FIG. 20A is a schematic diagram of a feature extraction process of a neural network according to an embodiment of the present application;

FIG. 20B is a principle diagram of feature extraction of a neural network according to an embodiment of the present application;

FIG. 21 is a schematic diagram of a feature processing process of a neural network according to an embodiment of the present application;

FIG. 22 is a comparison diagram of a high-quality behavior object and a low-quality behavior object according to an embodiment of the present application;

FIGS. 23A and 23B are effect diagrams of a neural network according to an embodiment of the present application;

FIGS. 24A and 24B are schematic diagrams of a feature extraction process of a neural network according to an embodiment of the present application;

FIG. 25 is a schematic diagram of the aggregation result of behavior objects according to an embodiment of the present application;

FIG. 26 is a schematic diagram of a process of generating an event clip according to an embodiment of the present application;

FIG. 27 is a process diagram of a video processing method according to an embodiment of the present application;

FIG. 28A is a schematic diagram of a user interface according to an embodiment of the present application;

FIG. 28B is a schematic diagram of a user interface according to an embodiment of the present application; and

FIG. 29 is a schematic structure diagram of an electronic device according to an embodiment of the present application.

### DETAILED DESCRIPTION

The following description with reference to the accompanying drawings is provided to assist in a comprehensive understanding of various embodiments of the present application as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present application. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present application. Accordingly, it should be apparent to those skilled in the art that the following description of various embodiments of the present application is provided for illustration purpose only and not for the purpose of limiting the present application as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. When a component is said to be “connected” or “coupled” to the other component, the component can be directly connected or coupled to the other component, or it can mean that the component and the other component are connected through an intermediate element. In addition, “connected” or “coupled” as used herein may include wireless connection or wireless coupling.

The term “include” or “may include” refers to the existence of a corresponding disclosed function, operation or component which can be used in various embodiments of the present application and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present application includes any or all of combinations of listed words. For example, the expression “A or B” may include A, may include B, or may include both A and B. When describing multiple (two or more) items, if the relationship between multiple items is not explicitly limited, the multiple items can refer to one, many or all of the multiple items. For example, the description of “parameter A includes A1, A2 and A3” can be realized as parameter A includes A1 or A2 or A3, and it can also be realized as parameter A includes at least two of the three parameters A1, A2 and A3.

Unless defined differently, all terms used herein, which include technical terminologies or scientific terminologies, have the same meaning as that understood by a person skilled in the art to which the present application belongs. Such terms as those defined in a generally used dictionary are to be interpreted to have the meanings equal to the contextual meanings in the relevant field of art, and are not to be interpreted to have ideal or excessively formal meanings unless clearly defined in the present application.

At least some of the functions in the apparatus or electronic device provided in the embodiments of the present application may be implemented by an AI model. For example, at least one of a plurality of modules of the apparatus or electronic device may be implemented through the AI model. The functions associated with the AI can be performed through a non-volatile memory, a volatile memory, and a processor.

The processor may include one or more processors. At this time, the one or more processors may be general-purpose processors such as a central processing unit (CPU), an application processor (AP), etc., or a pure graphics processing unit, such as a graphics processing unit (GPU), a visual processing unit (VPU), and/or an AI specialized processor, such as a neural processing unit (NPU).

The one or more processors control the processing of input data according to predefined operating rules or artificial intelligence (AI) models stored in the non-volatile memory and the volatile memory. The predefined operating rules or AI models are provided by training or learning.

Here, providing, by learning, refers to obtaining the predefined operating rules or AI models having a desired characteristic by applying a learning algorithm to a plurality of learning data. The learning may be performed in the apparatus or electronic device itself in which the AI according to the embodiments is performed, and/or may be implemented by a separate server/system.

The AI models may include a plurality of neural network layers. Each layer has a plurality of weight values. Each layer performs the neural network computation by computation between the input data of that layer (e.g., the computation results of the previous layer and/or the input data of the AI models) and the plurality of weight values of the current layer. Examples of neural networks include, but are not limited to, a convolutional neural network (CNN), a deep neural network (DNN), a recurrent neural network (RNN), a restricted Boltzmann machine (RBM), a deep belief network (DBN), a bi-directional recurrent deep neural network (BRDNN), generative adversarial networks (GANs), and deep Q-networks.

The learning algorithm is a method of training a predetermined target apparatus (e. g., a robot) by using a plurality of learning data to enable, allow, or control the target apparatus to make a determination or prediction. Examples of the learning algorithm include, but are not limited to, supervised learning, unsupervised learning, semi-supervised learning, or reinforcement learning.

The method executed by an electronic device provided in the embodiment of the present application may be implemented by an AI network. The video (image sequence) to be processed may be used the input data of the AI network, and behavior objects appearing in the video and event clips related to the behavior objects may be recognized by the AI network. The AI network may also be referred to as an AI model, neural network or neural network model, and the AI network is obtained by training. The network parameters or model parameters refer to network parameters of the AI network obtained by training and learning, such as the weight and offshoot of the neural network. Here, “obtained by training” means that predefined operating rules or AI models configured to perform desired features (or purposes) are obtained by training a basic AI model with multiple pieces of training data through training algorithms.

The method provided in the present application may relate to the visual understanding field of the AI technology. Visual understanding is a technology for recognizing and processing objects like human vision, including, for example, object recognition, object tracking, image retrieval, human recognition, scene recognition, 3D reconstruction/positioning, or image enhancement.

In actual life, with the increasing popularity of short videos on various social media platforms, people like to share events related to the user-preferred specific object. Recognizing events in a long video (long and short in the long and short videos are relatively speaking) is one of the demands in people's lives. In the related art, although some solutions can recognize events in a video, but the recognition result is undesirable. Particularly for the events containing fast motion behavior, it is difficult for the related art recognize the fast motion behavior, and the events related to the specific object cannot be recognized from the video. The user wants to find events related to a specific object in a long video, but the related art cannot realize this. Therefore, there are at least the following problems to be solved in the related art:
Problem A. Events in a video cannot be recognized accurately, so the event containing complete behavior among the events containing fast motion behavior cannot be provided to the user accurately.
Problem B. The behavior objects/behavior subjects in the video cannot be recognized, so the events related to the specific behavior object cannot be recognized and provided to the user.

The solutions provided in the embodiments of the present application are to improve or solve one of the problems in the related art. In an embodiment, in accordance with the method provided in the embodiments of the present application, the problem that the behavior objects and their relevant event clips in the video cannot be recognized or the problem that the recognition accuracy of event clips it not enough in the related art can be solved, especially for the video containing fast motion behavior.

The technical solutions in the embodiments of the present application and the technical effects produced by the technical solutions of the present application will be described below by referring to an embodiment. It should be noticed that the implementations in the following alternative embodiments can be implemented separately or can be referred to, learned from or combined with each other if not conflicted, or one or some steps in different implementations can be replaced with each other. The same terms, similar characteristics and similar implementations steps in different implementations are not repeated.

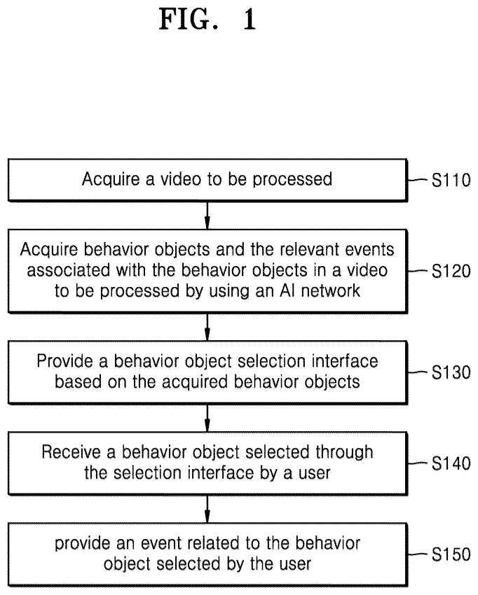

An embodiment of the present application provides a method executed by an electronic device. The electronic device may be any electronic device, which may be a terminal device or a server. As shown in FIG. 1, the method includes the following.

In step S110, a video to be processed is acquired.

In step S120, behavior objects in the video to be processed are acquired by using an AI network.

In an embodiment, the step S120 may be implemented as: acquiring behavior objects and their relevant events in the video to be processed by using an AI network.

As shown in FIG. 1, the method may further include the following.

In step S130, a behavior object selection interface is provided based on the acquired behavior objects.

In step S140, a behavior object selected through the selection interface by a user is received, and in step S150, an event related to the behavior object selected by the user is provided.

In the embodiment of the present application, the video to be processed is a video including a plurality of video frames to be processed. The source of the video to be processed will not be limited in the embodiment of the present application, and the video to be processed may be an original video or a video obtained after preprocessing the original video. The original video may be any video, which may be a video acquired by the video acquisition device of the terminal device itself (e.g., the camera of the smart phone), a video already stored in the electronic device or a video to be transmitted, or may be a video downloaded from the network or a video transmitted to the electronic device by other electronic devices.

In an embodiment, the video to be processed may be an image sequence composed of some video frames in the original video. For example, a video image sequence may be obtained by performing frame extraction on the original video at a set time interval, or an image sequence may be obtained by sampling the original video at a preset sampling rate. The video to be processed includes a plurality of consecutive video frames. It should be understood that, if the video to be processed is a video obtained by sampling/frame extraction, and the video frames being consecutive means that the video frames obtained by sampling/frame extraction are relatively consecutive. For example, there are total 100 frames in the image sequence in the original video, e.g., the 1st frame 1, the 2nd frame, . . . , the 100th frame. If one frame is extracted every two frames, the obtained video to be processed includes the 1st frame, the 4th frame, the 7th fame or the like. In the video to be processed, the 1st frame and the 4th frame are consecutive, the 4th frame and the 7th frame are consecutive, and the 1st frame and the 7th frame are directly adjacent to the 4th frame.

In the embodiment of the present application, the object may also be called subject or object, and the behavior object means that a specific behavior or preset behavior occurs in the object. For example, the behavior object may include, but not limited to, the object whose position is changed/moved in the video. For example, in a video containing a scene where an athlete is playing football, the athlete is a behavior object in the video. For example, if there is a bright moon hanging on the horizon in a video frame, the moon may also be a behavior object even if it may not move.

The event clip in the video, also called an event in the video, refers to a video clip where an event occurs in the video and can be construed as an event clip containing a preset behavior in the video. Recognizing the event in the video means recognizing whether one or some preset behaviors occur in the video, and the video clip composed of video frames where a preset behavior occurs is an event. The preset behavior may be preset according to the actual application requirements or application scenes. For example, in a scene related to sports, the preset behavior may include high jump, long jump, shooting, playing football or other behaviors. Correspondingly, the event related to a behavior object may be construed as an event clip corresponding to an object with the preset behavior.

In the method provided in the embodiment of the present application, behavior objects in the video to be processed may be recognized by the trained AI network, and the events related to the behavior objects can be found. Based on this, the recognized behavior objects may be provided to the user, the user may select a behavior object of interest, and the electronic device may provide, based on the user's selection, the event of the behavior object selected by the user to the user. Based on the solution provided in the embodiment of the present application, even if there is a fast motion object in the video, the solution can also recognize this object and its relevant behaviors/events accurately.

In an embodiment, in step S120, the acquiring behavior objects and their relevant events in the video to be processed includes:
extracting semantic features of the video to be processed, the semantic features including semantic features in each video frame to be processed, the semantic features in each video frame to be processed including spatial semantic features and temporal semantic features; and
determining, based on the extracted semantic features, behavior objects and the relevant events in the video to be processed.

The video frame to be processed is a frame in the video to be processed. The video frame to be processed may be all frames in the original video, or may be some video frames obtained by performing frame extraction or sampling from the original video. In an embodiment, for each video frame to be processed (may directly referred to as video frame hereinafter) in the video to be processed, the semantic features of the video frame may also be called the semantic feature map, spatial-temporal features, or spatial-temporal feature map of the video frame. The semantic features of any video frame to be processed may be obtained by performing feature extraction on the video frame and an adjacent frame by using an AI network. The adjacent frame of any video frame to be processed may include a preceding frame of this video frame, and the preceding frame may at least include a previous video frame of this video frame. For example, the preceding frame may be one frame or multiple frames, for example, two frames before this video frame.

For any video frame to be processed, based on this video frame, the spatial features of the image content of this video frame itself may be extracted. Since this video frame and its preceding frame are multi-frame images that are consecutive in temporal, the temporal features of this video frame may be extracted based on the interaction between this video frame and the preceding frame of this video frame. Therefore, based on this video frame and its preceding frame, the spatial-temporal features (e.g., spatial-temporal features containing both spatial feature information and temporal feature information) of this video frame may be learned by the AI network. Thus, based on the spatial-temporal features of each video frame in the video to be processed, event clips in the video can be recognized more accurately.

For a video, if there are more scene information changes (image content changes) in each image of the video, the probability of occurrence of events in the image is higher. For example, for an event clip, the change in image content between video frames in this clip is relatively large. For example, for an event clip containing a long jump behavior, the long jump is a fast motion behavior, and the position of the long jumper constantly varies in different video frames. For adjacent frames in this event clip, the same position across frames is not within the same object range due to the movement of the long jumper. Therefore, if only the image features of each frame in the video are obtained or the temporal features at the same position of different video frames are obtained, it is impossible to recognize and locate the event (e.g., the long jump behavior) in the video accurately. In the solution provided in the embodiment of the present application, considering the above factors, events in the video are recognized by acquiring the semantic features of each video frame with both temporal feature information and spatial feature information by using the trained AI network, so that the accuracy of the recognition result is improved. Even if the video contains a fast motion behavior, the features of this behavior can also be learned based on the interaction between the video frame and its preceding frame.

The network structure of the AI network used in the method provided in the embodiment of the present application will not be uniquely limited in the embodiment of the present application.

As an embodiment, the semantic features of the video frame to be processed may be extracted in the following way:
for each video frame to be processed in the video to be processed, extracting, based on a convolution module, a first semantic feature of the video frame and a second semantic feature of an adjacent frame;
determining, based on the first semantic feature and the second semantic feature, first semantically related patches in the video frame and second semantically related patches in the adjacent frame;
extracting, from the first semantically related patches in the video frame, first spatial semantic features of objects in the video frame, and extracting, from the second semantically related patches in the adjacent frame, first temporal semantic features of objects in the video frame; and
fusing the extracted first spatial semantic features and the first temporal semantic features to obtain the semantic features of the video frame.

In the embodiment of the present application, the blocks in the video frame may also be patches, and one patch corresponds to one image block of the video frame. For a video frame to be processed in the video, if the video frame contains an object, the patches occupied by this object in the video frame should be semantically related. For a behavior object that may exist in the video, e.g., a behavior object to be recognized, since the behavior object is an object with a specific behavior, if a video frame and its adjacent frame contain the same object, the patches where the object is located in the video frame and the patches where the object is located in the adjacent frame of the video frame should be semantically related. Therefore, the spatial semantic features of the object in this video frame can be extracted based on the semantically related patches in the video frame, and the temporal semantic features of the object in the adjacent frame of the video frame can be extracted based on the semantically related patches in the adjacent frame, so that the semantic features of the video frame can be obtained by fusing the spatial semantic features extracted from the video frame and the temporal semantic features extracted from the adjacent frame of the video frame.

The specific neural network structure of the convolution module used to extract the first semantic feature of the video frame and the second semantic feature of the adjacent frame will not be uniquely limited in the embodiment of the present application. As an embodiment, for each video frame to be processed, the extracting, based on a convolution module, semantic features of the video frame includes:
performing convolution on the video frame by using a first convolution layer;
spatially rearranging features of each channel in the features extracted by the first convolution layer; and
performing convolution on the rearranged features by a second convolution layer, and performing channel rearrangement on features of each space in the features extracted by the second convolution layer to obtain semantic features of the video frame.

It is to be noted that, in the embodiment of the present application, during performing feature extraction on the video frame or the patches in the video frame by using a neural network, it is possible to directly perform feature extraction on the video frame by using a neural network, or it is possible to perform feature extraction on the features/feature map of the video by using a neural network structure. For example, during performing convolution on the video frame by using the first convolution layer, the input of the first convolution layer may be the video frame or the features of the video frame, for example, the feature map of the video frame obtained by feature extraction using a common convolutional network, and the first convolution layer performs further feature extraction based on this feature map.

In an embodiment of the present application, a new convolutional feature extraction scheme is provided. For the convenience of description, this feature extraction scheme is called a specific convolution operation hereinafter. By using this convolution operation, each feature point in the extracted semantic features of the video frame can obtain a global receptive field, and the global information of the video frame can be learned. Thus, based on the feature map extracted by the convolution operation, the semantic features of the video frame with better feature expression capability can be obtained, and a better basis is provided for more accurately recognizing the objects and their relevant events in the video.

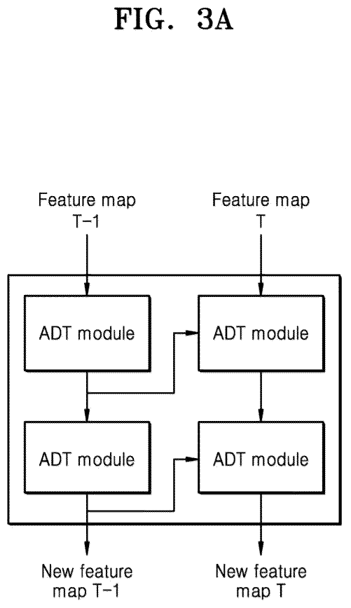

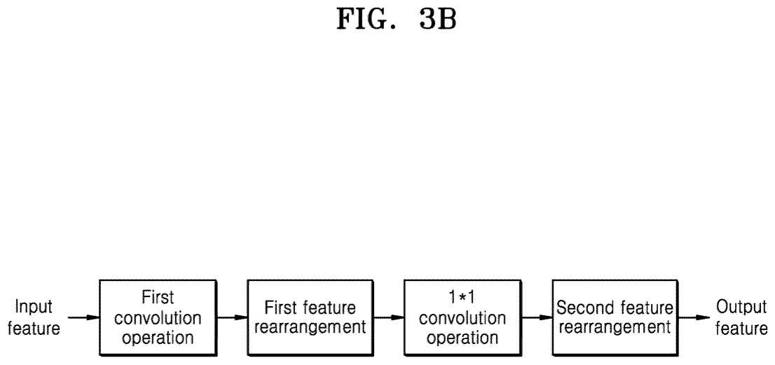

As an example, FIG. 3B shows a schematic diagram of an example implementation of the specific convolution operation according to an embodiment of the present application. As shown in FIG. 3B, the input feature is the video frame or the features of the video frame. It is assumed that the input is a feature map of H*W*C1, where H and W represent the height and width of the feature map, respectively, and C1 is the number of channels of the feature map. The first convolution operation (e.g., first convolution layer) may be a conventional convolution operation, and the size of the convolution kernel may be greater than 1. For any feature point in the input feature map, the feature point can learn the local information of the feature map by the first convolution operation. In an embodiment, the size of the feature map obtained by the first convolution operation remains unchanged, and the output of the first convolution operation is a feature map of H*W*C2, where C1 and C2 may be or may not be equal. Subsequently, a first feature rearrangement operation may be performed on the output feature map of the first convolution operation. Specifically, the channel features of the output feature map may be rearranged in space (e.g., spatially rearranged) to obtain a feature map of 1*C2*(H*W), where H*W is the number of channels of the rearranged feature map, and 1*C2 is the size of the feature map of one channel. For example, the feature map of one channel after rearrangement is a feature map composed of feature the feature values of one feature point in the C2 channel before rearrangement. Subsequently, each feature point can learn the global receptive field of the feature map by a 1*1 convolution operation to obtain a new feature map of 1*C2*H*W with fused global information. Then, a second feature rearrangement operation (e.g., channel rearrangement) is performed on the new feature map to obtain an output feature map of H*W*C2. Each feature point in this feature map can learn the local information and global information in the feature map.

For each video frame to be processed in the video to be processed, the semantic features of each frame (for example, the first semantic feature of any video frame to be processed and the second semantic feature of the adjacent frame) can be obtained by the specific convolution operation. After the semantic features of each video frame to be processed is obtained, further feature extraction may be performed based on the first semantic feature of this video frame and the second semantic feature of the adjacent frame to obtain semantic features including spatial semantic features and temporal semantic features of this video frame. In an embodiment, the semantically related patches in the video frame and the semantically related patches in the adjacent frame may be determined based on the first semantic feature of the video frame and the second semantic feature of the adjacent frame, and then the corresponding spatial semantic feature and temporal semantic feature of the object in this video frame may be extracted based on the determined semantically related patches.

In an embodiment, the determining, based on the first semantic feature of the video frame and the second semantic feature of the adjacent frame, semantically related patches in the video frame and semantically related patches in the adjacent frame includes:
fusing the first semantic feature and the second semantic feature to obtain a first fused feature;
determining, based on the first fused feature and in the video frame and the adjacent frame, spatial position offshoot information of other patches semantically related to each patch in the video frame relative to the patch, respectively; and
determining, based on the spatial position offshoot information, the first semantically related patches in the video frame and the second semantically related patches in the adjacent frame.

The specific way of fusing the first semantic feature and the second semantic feature will not be uniquely limited in the embodiment of the present application. In an embodiment, the first semantic feature and the second semantic feature may be spliced to obtain the first fused feature. Since the first fused feature contains the semantic features of at least two adjacent video frames (e.g., the current video frame and its adjacent frame), for the current video frame, the patches semantically related to each patch in the current video frame can be determined more accurately based on the fused feature. The semantically related patches include the semantically related patches in the current video frame and the semantically related patches in the adjacent frame. Specifically, the position offshoot information of the patches semantically related to each patch relative to this patch can be determined based on the fused feature, and it can be known, based on the position offshoot information, that the semantically related patches are which patches.

By using the above embodiment, for each video frame to be processed, other patches related to each patch in the video frame can be found accurately in the video frame, so that more accurate object outline information of an object that may exist in the video frame can be acquired based on these patches. By accurately finding other patches related to each patch in the adjacent frame of this video frame, more accurate relative position information of the object in the video frame can be obtained based on these patches. Therefore, based on the semantically related patches in the current video frame to be processed and the adjacent frame, the spatial semantic features and temporal semantic features of the object in the current video frame can be better learned, wherein the temporal semantic features integrate the relative position information of the position of the object in the current video frame and the position of the object in the adjacent frame. Thus, the motion information of the object can be better learned.

After the semantic features of each video frame to be processed fusing the spatial semantic features and the temporal semantic features are obtained, behavior objects present in the video frame can be recognized based on the semantic features of each video frame, so that the relevant events of the behavior objects can thus be determined. In an embodiment, the determining, based on the extracted semantic features, behavior objects and the relevant events in the video to be processed includes:
determining, based on the semantic features of each video frame to be processed and by using an object mask module, a region where an object in each video frame to be processed is located;
for each video frame to be processed, determining, based on the semantic features of the video frame and the region where the object in the video frame is located, region features of the region where the object in the video frame is located; and
determining, based on the region features of the region where the object in each video frame to be processed is located, behavior objects and their relevant events in the video to be processed.

The object mask module may perform semantic segmentation on the video frame based on the semantic features of the video frame, to obtain an object region (e.g., a region where the object is located) and a non-object region in the video frame. The specific neural network structure of the object mask module will not be limited in the embodiment of the present application. The object mask module may be any image segmentation network in theory. A mask feature map of the video frame may be obtained based on the semantic features of the video frame by using the image segmentation image. The mask feature map is a binary feature map, and the feature values of the object region and the feature values of the non-object region in the mask feature map are different. For example, the feature values of the object region are all 1, and the feature values of the non-object region are all 0. The object region and the non-object region in the video frame can be known based on the mask feature map.

In an embodiment, to determine the object region in the video frame more accurately, the determining, based on each video frame to be processed and by using an object mask module, a region where an object in each video frame to be processed is located may include:
for each video frame to be processed, fusing the first semantic features of the video frame and the second semantic features of the adjacent frame to obtain a first fused features; and
performing object segmentation on the first fused features by using the object mask module to obtain a region where the object in the video frame is located.

Since video processing is to recognize a behavior object present in the video and the behavior object is a motion object, the position and/or shape of the behavior object in different video frames are different. Therefore, to determine the position of the object in the video frame more accurately, object segmentation may be performed based on the semantic features of the video frame and the semantic features of the adjacent frame, and the region where the object in the video frame is located may be obtained based on the segmentation result. In an embodiment, it is possible that the semantic features of the video frame and the semantic features of the adjacent frame are spliced, the spliced features are used as the input of the object mask module and the object segmentation result of the video frame is output as the mask feature map by the object mask module.

After the object region in the video frame is determined by the object mask module, region features of the object region may be obtained based on the semantic features of the video frame. For example, a pixel value is filled in the object region in the mask feature map by using the semantic features of the video frame, the filled pixel value of the object region in the mask feature map is the same as the pixel value of the corresponding region in the sematic features of the video frame, and the pixel value of the non-object region is 0.

After the region features of the region where the object in each video frame to be processed in the video to be processed is located is determined, the behavior objects and their relevant events in the video to be processed may be determined based on the region features of the region where the object is located.

In an embodiment, the determining, based on the region features of the region where the object in each video frame to be processed is located, behavior objects and the relevant events in the video to be processed includes:
for each video frame to be processed, obtaining object features corresponding to the video frame based on the region features of the region where the object in the video frame is located;
determining, based on the object features of the video frame and by an object recognition model, whether behavior objects are contained in the frame video; and
obtaining behavior objects and the relevant events in the video to be processed based on the determined behavior object features, the behavior object features are object features of video frames containing behavior objects.

The object recognition model is used to determine whether there are behavior objects in the video frame. The object features corresponding to one video frame to be processed may be the region features of the region where the object in the video frame is located, or may be features obtained by further processing the region features. For example, according to the set feature size, the region features of the region where the object is located may be adjusted as features of the corresponding size, and the features may be used as the object features. Since the object features represent the related information of the object in the video frame and the object features integrate the spatial semantic features of the object in the video frame and the temporal semantic features of the object in the adjacent frame, it is determined, based on the object features corresponding to the video frame and by using the object recognition model, whether there are behavior objects in the video frame.

The specific structure of the object recognition model will not be uniquely limited in the embodiment of the present application. In an embodiment, the object recognition model may be a classification model, and there are two different classification results, e.g., there are behavior objects in the video frame and there is no behavior object in the video frame.

In an embodiment, to improve the accuracy of the result of behavior object recognition, the obtaining object features corresponding to the video frame based on the region features of the region where the object in the video frame is located includes:
fusing the region features of the region where the object in the video frame is located and the semantic features of the video frame to obtain target features of the video frame; and
fusing the target features of the video frame and the region features of the region where the object in the video frame is located to obtain object features of the video frame.

In an embodiment, it is also possible to fuse the semantic features of the video frame and the region features of the region where the object in the video frame is located to obtain object features of the video frame.

By fusing the features (e.g., semantic features or target features) of the video frame and the region features of the region where the object in the video frame is located to obtain object features, the obtained object features can not only the local features of the object region in the video frame but also integrate the global features of the video frame. Based on the object features obtained by this solution, it can be more accurately determined whether there are behavior objects in the video frame.

The specific way of fusing the features of the video frame and the region features will not be limited in the embodiment of the present application. In an embodiment, the features of the video frame and the region features may be adjusted as features of the preset size, respectively, and the adjusted features of the video frame and the adjusted region features may be spliced to obtain the object features.

In an embodiment, the fusing the region features of the region where the object in the video frame is located and the spatial-temporal features of the video frame to obtain target features of the video frame includes:
fusing the region features of the region where the object in the video frame is located and the semantic features of the adjacent frame, and extracting, from the region where the object in the video frame is located, target region features of the object in the video frame; and
fusing the target region features and the spatial-temporal features of the video frame to obtain target features of the video frame.

In the embodiment, the region where the object in the video frame is located determined based on the semantic features of the video frame by using the object mask module can be construed as the recognition result of a coarse-grained object region. To further improve the accuracy of the determined object region, the region features of the object region determined by object segmentation and the semantic features of the adjacent frame of this video frame may be fused, and the object outline may be further calculated in the segmented object region based on the fused features to obtain the target region features of the object in the video frame. Compared with the region features obtained by segmentation, the target region features are features with more fine-grained object outline and absolute position. By fusing the obtained target region features and the semantic features of the video frame, the target features of the video frame can be obtained, and the target features can assist in better recognition of objects in the video. In an embodiment, as described above, it is possible to fuse the features of the video frame and the region features of the region where the object in the video frame is located to obtain the object features of the video frame.

After the object features corresponding to each video frame to be processed in the video to be processed are obtained, each video frame containing the behavior object can be determined based on the object features of the video frame by using the object recognition module, so that the behavior objects in the video can be recognized based on the determined behavior object features and the events related to the behavior objects can be obtained based on the result of behavior object recognition. In an embodiment, the obtaining behavior objects and their relevant events in the video to be processed based on the determined behavior object features includes:
aggregating the behavior objects features to obtain at least one aggregation result; and
obtaining, based on each video frame corresponding to the at least one aggregation result, behavior objects and their relevant events corresponding to the at least one aggregation result.

Since the behavior objects contained in different video frames may be the same or different, to obtain the event related to each behavior object, all behavior object features of the same behavior object may be found by feature aggregation after the behavior object features are determined. Specifically, the video frames corresponding to all behavior object features in one aggregation result can be considered as containing the same behavior object, and the behavior object and its relevant events corresponding to this aggregation result can be obtained based on the video frames corresponding to all behavior object features in this aggregation result.

The specific way of aggregating the behavior object features will not be limited in the embodiment of the present application and may theoretically be any feature aggregation scheme. For example, the behavior object features may be aggregated based on the similarity between the behavior object features.

As an embodiment, the determined behavior object features may be aggregated in the following way:
for each behavior object feature, determining at least one similar object feature of the behavior object feature from the object features;
extracting second fused features of behavior objects based on the behavior object features and the at least one similar object features; and
aggregating the second fused features corresponding to the behavior object features.

In this embodiment provided by the present application, the similar object feature of each behavior object feature may be found based on the similarity between features. In an embodiment, the similar object feature of one behavior object feature may refer to a behavior object feature whose similarity with the behavior object feature is greater than a set threshold. The specific way of calculating the feature similarity can be selected according to actual needs, and the similarity between features can be obtained by methods including but not limited to calculating the cosine similarity or Euclidean distance between features.

For each behavior object feature, this behavior object feature and its similar object feature can be considered as the object features of the same object corresponding to different angles and different scenes. Therefore, the semantic information of the multi-angle scene of the behavior object can be learned from the behavior object feature and its similar object feature, so that the fused feature of the behavior object with better feature expression capability is obtained. By aggregation based on the fused feature, the accuracy of the aggregation result can be further improved.

The specific way of extracting the fused features of behavior objects from the behavior object features and their similar object features will not be uniquely limited in the present application. In an embodiment, the behavior object feature and its similar object feature may be added, or averaged after addition, or weighted and summated to obtain the fused feature.

As an embodiment of the present application, the extracting the second fused features of behavior objects based on the behavior object features and their similar object features includes:
fusing each similar object feature of the behavior object features to obtain third fused features.
performing feature extraction on the third fused features in at least two different feature extraction modes to obtain at least two fused object features;
obtaining a weight corresponding to each fused object feature based on the correlation between the behavior object features and each fused object feature; and
performing weighted fusion on the fused object features by using the weight corresponding to each fused object feature to obtain the second fused features of the behavior objects.

For each behavior object feature, this feature object feature and its similar object feature may be spliced, and feature extraction may be performed on the spliced feature in at least two different feature extract modes to obtain at least two fused object features. By performing feature extraction on the spliced vector in different feature extraction modes, multiple features (e.g., fused object features) corresponding to different feature spaces and containing different dimension information can be obtained. Then, weighted fusion can be performed on the multiple features based on the correlation between the behavior object feature and each feature in the multiple features to obtain the fused feature corresponding to the behavior object feature which fuses the multi-angle and multi-scene information of the behavior object.

For example, third fused features may include the fused features of each similar object feature of the behavior object features.

In an embodiment, the multiple features may be fused by an attention mechanism. The weight corresponding to each feature in the multiple features may be calculated by using the behavior object feature as the query vector of the attention mechanism and the multiple features corresponding to this behavior object feature spliced as the key of the attention mechanism, and the multiple features are weighted and summated based on the weight corresponding to each feature to obtain the fused feature corresponding to this behavior object feature. This fused feature may be used as the target object feature corresponding to this behavior object feature, and the target object features corresponding to all behavior object features are aggregated to obtain at least one aggregation result.

In an embodiment, for each aggregation result, the behavior object in the video frame corresponding to any behavior object feature in this aggregation result may be used as the behavior object (e.g., the representative behavior object) corresponding to this aggregation result, and the video frames (or these video frames after processed) corresponding to all behavior objects in this aggregation result are sorted in the precedence order of the video frames in the video to obtain events related to the behavior objects corresponding to this aggregation result.

As an embodiment, the obtaining, based on each video frame corresponding to each aggregation result, behavior objects and their relevant events corresponding to each aggregation result includes:
for each aggregation result, determining, based on each behavior object feature in the aggregation result, the quality of the behavior object in the video frame corresponding to each behavior object feature; and
determining a behavior object in the video to be processed based on the quality of the behavior object in the video frame corresponding to the aggregation result, and determining relevant events of this behavior object based on each video frame corresponding to the aggregation result.

In an embodiment, for each aggregation result after the object quality corresponding to each behavior object in this aggregation result is determined, the behavior object in the video frame corresponding to the highest-quality behavior object feature may be used as the representative behavior object corresponding to this aggregation result, and each video frame corresponding to the aggregation result is combined to obtain the relevant event of this behavior object. The representative behavior object may be used as the tag of this event. For example, the video frame of the highest-quality behavior object or the region image (e.g., sub-image) of the behavior object in this video frame may be used as the tag of the corresponding event, and this tag is associated with an event clip to obtain the event clip associated with this tag. The tag of each behavior object in the video may be provided to the user. In an embodiment, object recognition may be performed on the behavior object features of the representative behavior object to recognize which object (e.g., which person) specifically corresponds to this feature, so that the user may be provided with the event clip of the specific object (object tag). Of course, it is also possible to not perform recognition, use the sub-image of the representative behavior object as the object tag and provide the user with the object tag and its associated event clip.

In an embodiment, the quality of the behavior object corresponding to one behavior object feature may be realized by a classification network. This behavior object feature may be input to the trained classification network to obtain an object quality score corresponding to this vector. The higher the score is, the higher the object quality is. The evaluation standard for quality will not be limited in the embodiment of the present application and can be configured according to requirements. By training the object quality recognizer, the object quality recognizer can learn the corresponding quality evaluation standard. For example, whether the object in the video frame faces front, whether the pixels are high or whether the human face is clear may be used as the evaluation standard.

For each aggregation result, the determining relevant events of this behavior object based on each video frame corresponding to the aggregation result may include at least one of the following:
way 1: the background in each video frame corresponding to the aggregation result is removed, and relevant events are obtained based on each video frame with the background removed; and
way 2: each video frame is clipped based on the object region in each video frame corresponding to the aggregation result, and relevant events are obtained based on each clipped video frame.

For way 1, by removing the background in the video frame to obtain an event clip, the size of the video frame can remain unchanged; and, for way 2, by clipping the non-object region in the video frame to obtain an event clip, only the sub-image of the object region in the video frame is received in the image of the event clip.

After each behavior object in the video to be processed and the event related to each behavior object are determined, the tag (the highest-quality video frame or sub-image) of each behavior object may be provided to the user, for example, being shown to the user through a user terminal. The user may select a behavior object of interest, and the event of the selected behavior object may be provided to the user based on the user's selection. In an embodiment, the user may also view, forward, store or edit the event of the behavior object of interest.

In some practical application scenarios, the user may only want to know the highlight clip in the video, and does not pay special attention to which object's highlight clip. Considering this requirement, in another embodiment of the present application, a method executed by an electronic device is further provided. The method may include the following:
obtaining events in a video to be processed by using an AI network, and providing the events in the video to be processed.

In this solution, it is possible to pay no attention to the objects in the video and only recognize the event clips contained in the video to be processed. Of course, in this solution, it is also possible to perform object recognition on the events to obtain objects corresponding to the events after the events in the video to be processed are obtained.

In the embodiment of the present application, the obtaining events in a video to be processed by using an AI network may include:
extracting semantic features of each video frame to be processed in the video to be processed by using the AI network, the semantic features including spatial semantic features and temporal semantic features; and, determining events in the video to be processed based on the extracted semantic features of each video frame to be processed.

In this embodiment, the embodiment of obtaining the semantic features of each video frame to be processed in the video to be processed by using the AI network can adopt the solution of obtaining the semantic features of the video frame to be processed provided in any of the above embodiments, and will not be repeated here.

In an embodiment, the determining events in the video to be processed based on the extracted semantic features of each video frame to be processed may include:
fusing the semantic features of each video clip in the video to be processed to obtain clip features corresponding to each video clip; and
determining events in the video to be processed based on the clip features of the video clips.

Any video clip may be a preset number of consecutive video frames in the video to be processed. For example, every 5 or 10 consecutive video frames are used as a video clip. Similarly, the video to be processed in this embodiment may be an original video or may be a video obtained by sampling the original video.

After the semantic features of each video frame to be processed in the video to be processed are extracted by the AI network, the semantic features of multiple video frames contained in each video clip may be fused, and it may be determined based on the fused clip features whether this video clip is an event clip. The specific way of fusing the semantic features of the video frames in the video clip to obtain the video clip will not be limited in the embodiment of the present application. In an embodiment, the semantic features of each video frame may be spliced to obtain clip features; or, after the semantic features of each video frame in the video to be processed are obtained, further feature extraction may be performed to obtain new features of each video frame, and the new features of each video frame in the video clip may be fused to obtain clip features. As an embodiment, feature extraction may be performed based on the semantic features of each video frame to obtain target features of each frame video. For example, the target features of the video frame may be obtained by the solution provided above. The target features of each video frame in each video clip are spliced to obtain clip features of this video frame, or feature extraction is performed on the spliced features to obtain clip features.

After the clip features of each video clip are obtained, in an embodiment, the score that the video clip is an event clip is obtained by a score model (e.g., classification model). The higher the score is, the higher the probability that the video clip is an event clip. The video clip with a score not less than the preset threshold may be determined as an event clip and then shown to the user, while the clip with a score less than the threshold is not shown to the user.

In an embodiment provided in the embodiment of the present application, based on the semantic features including temporal semantic features and spatial semantic features of the video frame, the events in the video, or the behavior objects in the video and the events associated with the behavior objects, can be recognized accurately. In practical applications, the solution in the corresponding embodiment can be adopted according to the practical application requirements (for example, it is necessary to recognize behavior objects or event clips in the video, or it is necessary to recognize behavior objects and their relevant event clips).

In an embodiment, the semantic features of each video frame to be processed in the video to be processed may be obtained in the following way:
encoding each video frame to be processed to obtain a first feature map of each video frame; and
for each video frame to be processed in the video to be processed, performing at least one first operation on the video frame, and obtaining a semantic feature map (e.g., semantic feature) of this video frame based on the second feature map of this video frame obtained by the last first operation, wherein the first operation includes:
extracting, based on the current feature map of this video frame and the current feature map of a preceding frame (e.g., previous frame) of this video frame, a first outline feature map and a first position feature map of an object in this video frame, and obtaining a second feature map of this video frame based on the first outline feature map and first position feature map corresponding to this video frame;
wherein the current feature map of this video frame corresponding to the first first operation is the first feature map of this video frame, and the current feature map of this video frame corresponding to the first operation except for the first first operation is the second feature map of this video frame obtained by the previous first operation, and the current feature map of the preceding frame is the second feature map of this preceding frame obtained by the current first operation.

The way of obtaining the first feature map of each video frame in the video will not be limited in the embodiment of the present application. The first feature map of each video frame may be theoretically realized by any feature extraction network, or the video frame may be directly used as the first feature map of this video frame. In an embodiment, the first feature map of each video frame may be extracted by a convolutional neural network. For example, the AI network includes a convolutional neural network. The input of the convolutional neural network is the video frame, while the output thereof is the first feature map of the video frame. In an embodiment, when feature extraction is performed on each video frame by the convolutional neural network, it may be first determined whether the size of the video frame is the preset fixed size; and if the size of the video frame is not the preset fixed size, each video frame is processed as an image of the fixed size and then input to the convolutional neural network.

In an embodiment, the preceding frame of any video frame may be only one previous frame of this frame, or may be few previous frames of this frame. When the preceding frame of any current frame are multiple frames, during processing based on the feature map of the current frame and the feature map of the preceding frame, the feature map of the preceding frame may be the fused feature map of the feature maps of the multiple frames. For example, if the preceding frame is two previous frames of the current frame, the fused feature map may be obtained by averaging the feature values of the corresponding positions in the feature maps of the two previous frames. For example, the input of the first first operation may be the first feature map of the current frame and the fused feature map of two previous frames of the current frame, and the input of the second first operation may be the second feature map of the current video frame and the fused feature map of new feature maps of the two previous frames obtained by the second operation.

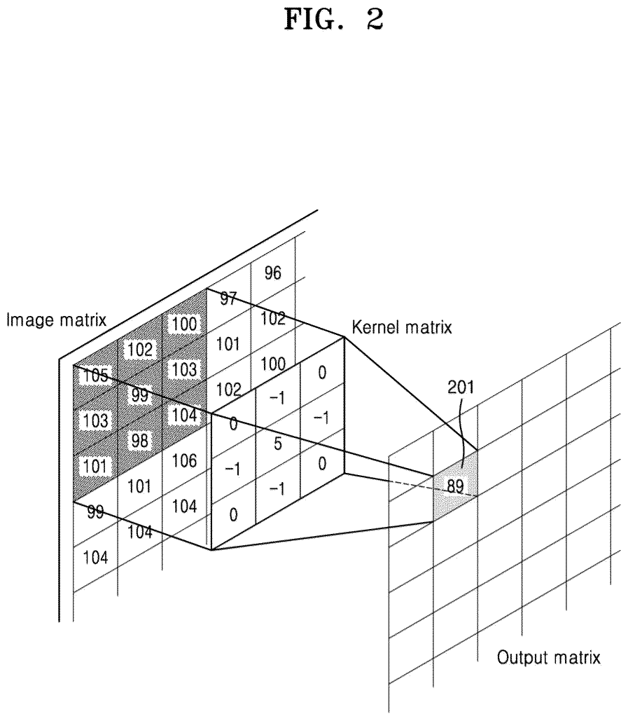

As an example, FIG. 2 shows a principle diagram of encoding a video frame into a fixed number of patches according to an embodiment of the present application, where the image matrix in FIG. 2 is a video frame; the numerical values in this matrix are pixel values of the corresponding positions in the video frame; the kernel matrix is the model parameter (weight matrix) of the convolutional neural network; the size of the matrix is the size of the convolution kernel, and the size of the convolution kernel is 3*3 in this example; and the output matrix is the first feature map of the video frame. By multiplying and adding 9 pixel values of 3*3 image patches in the video frame and the weight values of the corresponding positions in the 3*3 convolution kernel, a feature value of one position in the first feature map is obtained. For example, in FIG. 2, the feature value 89 201 in the output matrix is obtained by multiplying and adding the kernel matrix and the pixel values (9 filled pixel values) of the image patches at the top left corner of the image matrix.

Feature extraction is performed in each video frame by the convolutional neural network, and each video frame may be encoded into a fixed number of patches (also referred to as blocks). One patch corresponds to one image patch of the video frame, and the size of the image patch is determined by the size of the receptive field of the convolutional neural network.

To enable the frame feature map of each video frame to learn temporal and spatial features, after the first feature map of each video frame is obtained, for any video frame, further feature extraction is performed on this video frame based on the first feature map of this video frame and the first feature map of the preceding frame of this video frame by using the AI network, to obtain a spatial-temporal feature map of this video frame. In the above embodiment provided by the present application, for any video frame, a set number of first operations may be performed on this video frame by using the AI network, and the spatial-temporal feature map of this video frame may be obtained based on the second feature map obtained by the last first operation.

In the embodiment of the present application, the neural network for implementing the at least one first operation may be called an ADT network, and the ADT network may include multiple cascaded ADT modules. Each ADT module implements one first operation, and the input of one ADT module includes the output of the previous ADT module. The feature map containing object outline and relative position information (e.g., the semantic features of the video frame) can be obtained by the ADT network.

For the convenience of description, in some of the following embodiments, the preceding frame of each video frame to be processed will be described by taking the previous video frame of this video frame as an example.

As an example, FIG. 3A shows a principle diagram of performing feature extraction on a video frame by the ADT network, and the ADT network in this example includes two ADT modules, where the feature map T represents the first feature map of the current frame, and the feature map T−1 represents the first feature map of the previous frame of the current frame. It can be seen from FIG. 3A that, for any current video frame, the input of the first first operation (first ADT module) includes the first feature map T of this video frame and the output feature map of the first first operation corresponding to the previous video frame of this video frame, and the input of the second first operation includes the feature map of this video frame output by the first first operation and the output feature map of the second first operation corresponding to the previous video frame of this video frame.

For each video frame, by the first operation, the static attitude information in spatial and the dynamic relative position information in temporal of the object (which may be called an object, target or subject) of this video frame can be learned based on the feature map of the current frame and the feature map of the previous frame of the current frame, so that a new feature map containing object outline information and position information can be obtained. Thus, based on the new feature map of each video frame in the video, the behavior transpose of the motion object can be better recognized, and the motion behavior can be recognized accurately. The number of first operations (e.g., the number of ADT modules contained in the ADT network) will not be limited in the embodiment of the present application.

In an embodiment, for any video frame, the extracting, based on the first current feature map of this video frame and the first current feature map of a preceding frame (e.g., previous frame) of this video frame, a first outline feature map and a first position feature map of an object in this video frame may include:
extracting, based on the first current feature map of this video frame and the first current feature map of the preceding frame of this video frame, a first weight feature map corresponding to the preceding frame of this video frame and a second weight feature map corresponding to this video frame; and
obtaining the first position feature map corresponding to this video frame based on the first current feature map and the first weight feature map of the preceding frame of this video frame, and obtaining the first outline feature map corresponding to this video frame based on the first current feature map and the second offshoot feature map of this video frame.

Since the events in the video are caused by the specific actions of an object in the video, if there are events in the video and the object (e.g., the position, attitude or the like of the object) in the video is changing, the position relationship between related image contents in video frames is also changing. To recognize the region related to the object in the video more accurately, in this embodiment provided in the embodiment of the present application, for any video frame, the first weight feature map and the second weight feature map corresponding to this video frame can be learned based on the feature map of this video frame and the feature map of the previous frame by using the AI network, wherein the weight feature map may also be called an offshoot feature map. The first weight feature map may be construed as an offshoot map of the image information in the previous frame relative to the object/subject of the previous frame, and the second weight feature map may be construed as an offshoot map of the image information in the current video frame relative to the object in this video frame. The first weight feature map and the second weight feature map may represent the spatial position offshoot of each patch in the previous frame semantically related to the patch in the current video frame and the position offshoot of the patch in the current video frame semantically related to the patch in this video frame, respectively. By learning the weight feature map, the semantically related patches in the feature map of the video frame can be found more accurately, instead of simply taking adjacent patches in the feature map as related patches, so that the accuracy of event recognition can be improved.

After the weight feature map corresponding to the current frame and the weight feature map corresponding to the previous frame of the current frame are obtained, the weight feature map may be used as the offshoot feature map in the calculation of the deformable convolutional network, and the feature map of the corresponding frame may be convolved to obtain a new feature map. In this embodiment of the present application, a new solution of calculating the offshoot in the deformable convolution operation is provided. For the previous frame of the current frame, during the convolution operation on the feature map of the previous frame (e.g., which may be the first current feature map of the pervious frame or the new feature map obtained by performing feature extraction on the first current feature map), the deformation convolution of this frame may be implemented by using the weight feature map of the previous frame obtained in the above way to generate a relative position result. Similarly, the deformable convolution of the feature map of the current frame may be implemented based on the weight feature map of the current frame to generate an outline result.

In an embodiment, for each video frame to be processed, the first current feature map of this video frame and the first current feature map of the preceding frame of this video frame may be fused to obtain a fused feature map, and the first weight feature map and the second weight feature map corresponding to this video frame may be extracted based on this fused feature map. The specific way of fusion will not be limited in the embodiment of the present embodiment, including but not limited to splicing.

As an embodiment, for each video frame to be processed, the first weight feature map and the second weight feature map corresponding to this video frame may be obtained in the following way:
performing a second operation on the third feature map of this video frame and the third feature map of the preceding frame to obtain fourth feature maps corresponding to this video frame and this preceding frame, respectively, wherein the third feature map of any video frame is the first current feature map of this video frame or a feature map obtained by performing feature extraction on the first current feature map of this video frame; and
splicing the fourth feature map of this video frame and the fourth feature map of the preceding frame of this video frame, and extracting, based on the spliced fused feature map, the first weight feature map corresponding to the preceding frame of this video frame and the second weight feature map corresponding to this video frame, wherein the second operation includes:
performing feature rearrangement on the third feature map to obtain a fifth feature map, the number of channels in the fifth feature map being the number of feature points in the feature map of one channel in the third feature map, the height and weight of the fifth feature map being 1 and the number of channels in the third feature map, respectively; performing feature extraction on the fifth feature map to obtain a sixth feature map, which has the same size as the fifth feature map; and, performing feature rearrangement on the sixth feature map to obtain a fourth feature map with the same size information as the third feature map.

The second operation is the specific convolution operation described in the above embodiments. By this convolution operation, each feature point/patch in the feature map can obtain a global receptive field and thus obtain the global information of the feature map, so that the feature map obtained based on this convolution operation can learn the more accurate weight feature map and the more accurate object outline and relative position can be obtained.

It should be understood that, in practical implementations, the second operation may be executed for one time or multiple times. If the second operation is executed for multiple times, the input of the current second operation is the output of the previous second operation. For any current video frame and its preceding frame, the process of executing the second operation is the same. By taking the current video frame as an example, in an embodiment, for any one first operation, the input of the first second operation (e.g., the third feature map) in this first operation may be the input of this first operation (e.g., the first current feature map of the current video frame), or may be the feature map obtained by performing feature extraction on this feature map. In an embodiment, a deformable convolution operation may be performed on the first current feature map of this video frame by using a deformable convolutional network to obtain a third feature map of this video frame, and the third feature map may be used as the input feature map of the specific convolution operation. An example implementation of the feature convolution operation is shown in FIG. 3B.

For any video frame, after the fourth feature map of this video frame and the fourth feature map of the preceding frame of this video frame are obtained by the specific convolution operation, the fourth feature map of this video frame and the fourth feature map of the preceding frame may be fused (e.g., spliced), the first weight feature map and the second weight feature map corresponding to this video frame may be extracted based on the fused feature map, and a feature map containing more accurate object outline and position information may be obtained based on the weight feature maps.

In an embodiment, for each video frame to be processed, the obtaining a second feature map of this video frame based on the first outline feature map and the first position feature map corresponding to this video frame may include:
fusing the first position feature map and first outline feature map corresponding to this video frame and the first current feature map of this video frame to obtain the second feature map of this video frame.

The fusion way will not be uniquely limited in the embodiment of the present application. In an embodiment, the first position feature map, the first outline feature map and the first current feature map corresponding to each first operation may be feature maps of the same size. The output feature map (e.g., the second feature map) of the current first operation may be obtained by adding the first position feature map, the first outline feature map and the first current feature map (or the feature map obtained by performing feature extraction on the first current feature map, e.g., the third feature map described in the following embodiments) corresponding to the current first operation.

In an embodiment, for each video frame to be processed, after the second feature map of the last first operation corresponding to this video frame is obtained, the second feature map of this video frame obtained by the last first operation may be used as the spatial-temporal feature map (e.g., semantic feature) of this video frame, or feature extraction is performed on the second feature map of this video frame obtained by the last first operation to obtain the spatial-temporal feature map of this video frame.

In an embodiment, to further improve the accuracy of the recognition result, for any video frame, when the first weight feature map and the second weight feature map corresponding to this video frame are extracted based on the first current feature map of this video frame and the first current feature map of the preceding frame of this video frame, a more fine-grained weight feature extraction method can be adopted. Specifically, the third feature map of any video frame includes multiple patches, and each patch is the region where at least one feature point in the third feature map is located, wherein the third feature map of any video frame is the first current feature map of this video frame or the feature map obtained by performing feature extraction on the first current feature map of this video frame. For example, one block (e.g., one patch) of any feature map may be one pixel point in the feature map, or may be multiple pixel point regions.

The extracting the first weight feature map corresponding to the preceding frame of this video frame and the second weight feature map corresponding to this video frame may include:
using each patch in the third feature map of this video frame as a query patch, splicing, for each query patch, this query patch and the fused feature map to obtain a spliced feature map, and extracting, based on the spliced feature map, the first weight feature map the second weight feature map corresponding to this query patch; and
for each query patch of this video frame, obtaining a first feature patch corresponding to this query patch based on the third feature map of this video frame and the second weight feature map corresponding to this query patch, and obtaining a second feature patch corresponding to this query patch based on the third feature map of the preceding frame of this video frame and the first weight feature map corresponding to this query patch, wherein the first outline feature map corresponding to this video frame includes the first feature map corresponding to each query patch of this video frame, and the first position feature map corresponding to this video frame includes the second feature corresponding to each query patch of this video frame.

In this embodiment, the first weight feature map corresponding to one video frame includes the first weight feature map of each query patch of this video frame, and the second weight feature map corresponding to this video frame includes the second weight feature map of each query patch of this video frame. Correspondingly, the first outline feature map of each video frame includes the first feature patches corresponding to all query patches of this video frame, and the first position feature map of this video frame include the second feature patches corresponding to all query patches of this video frame. The first weight feature map corresponding to one query patch of one video frame represents the spatial position offshoot information of each patch semantically related to this query patch in the previous video frame of this video frame, and the second weight feature map corresponding to this query patch represents the spatial position offshoot information of each patch semantically related to this query patch in this video frame.

By the embodiment, for each query patch of one video frame, several patches related to this query patch may be found from the feature map of this video frame based on the fused feature map of this video frame and its preceding frame, and several patches (e.g., patches related to this query patch in the preceding frame) related to the target patch in the preceding frame may be found from the preceding frame of this video frame. The target patch refers to the patch related to the query patch in the preceding frame. Thus, new query patches (e.g., new feature patches corresponding to this query patch that have learned more semantic information) can be obtained by learning the information of these related patches.

In practical implementations, the number of patches related to each patch may be preconfigured, and is assumed as M, where the related patches of one patch may include this patch itself and surrounding M−1 patches. Assuming that M=9, the surrounding patches of one patch include 8 patches (8 neighborhoods) around this patch. The second weight feature map corresponding to any query patch can be construed as the offshoot feature map of M semantically related patches of this query patch. Here, the “offshoot” can be construed as the offshoot of the related patch relative to the object of the video frame. Based on the offshoot feature map, the patches related to the query patch can be found from the feature of the current video frame more accurately. Similarly, based on the first weight feature map, the patches related to the query patch can be found from the preceding frame more accurately.

In this embodiment of the present application, a new deformable convolution operation is provided. The second weight feature map corresponding to one query patch in the current video frame can be construed as the offshoot (e.g., the offshoot of deformation of the deformable convolution) corresponding to M patches related to this query patch in the extracted input feature map (e.g., the third feature map of the current video frame). Based on the input feature map and the offshoot corresponding to the M patches, the convolution operation can occur on the offshoot M blocks, so that the shape of the convolution operation is closer to the shape of the object in the video frame. Therefore, based on this solution, the object outline information and relative position information of the video frame can be obtained more accurately.

In an embodiment, the obtaining a second feature map of this video frame based on the first outline feature map and the first position feature map corresponding to this video frame includes:
for each query patch of this video frame, fusing the first feature patch and the second feature patch corresponding to this query patch with this query patch to obtain a new feature patch corresponding to this query patch; and
obtaining the second feature map of this video frame based on the new feature patch corresponding to each query patch of this video frame.

In an embodiment, for each query patch, the first feature patch and the second feature patch corresponding to this query patch may be added with this query patch to obtain a new feature patch corresponding to this query patch. The second feature map of any video frame includes the new feature patch corresponding to each query patch of this video frame.

As described above, for any video frame, after the second feature map of this video frame output by the last operation (e.g., the feature map of this video frame output by the last ADT module in the multiple cascaded ADT modules) is obtained by one or more first operations, the second feature map may be used as the spatial-temporal feature map (e.g., semantic feature) of the video frame, or further feature extraction may be performed on the second feature map to obtain the spatial-temporal feature map.

It should be understood that, during the implementation of the solution provided in the embodiment of the present application, some feature extraction steps may be or may not be executed. For example, the input feature of the ADT network may be each video frame or may be the feature of each video frame encoded by the image patch. During the further feature extraction of the input feature by using the ADT network, the first specific convolution operation may be performed based on the input feature of the ADT network; or, feature extraction (e.g., deformable convolution) is first performed on the input feature, and the specific convolution operation is then performed on the extracted feature.

After the semantic features of each video frame are obtained, the behavior objects and their relevant events in the video frame may be determined based on the semantic features of each video frame. To recognize behavior objects and their relevant events more accurately, further feature extraction may be performed based on the semantic features of each video frame to be processed in the following way to obtain target features of each video frame:
for each video frame to be processed in the video, performing at least one third operation on the video frame, and obtaining target features of this video frame based on the seventh feature map of this video frame obtained by the last third operation, wherein the third operation includes:
recognizing, based on the second current feature map of this video frame and the second current feature map of the preceding frame of this video frame, an object in this video frame to obtain a first object feature map of this video frame (the region feature of the region where the object in the video frame is located), the feature value of the target region where the object is located in the first object feature map being the pixel value of the corresponding region in this video frame, the feature value of the non-target region in the object feature map being 0; and, obtaining the seventh feature map of this video frame based on the first object feature map of this video frame and the second current feature map of this video frame;
wherein the second current feature map of this video frame corresponding to the first third operation is the second feature map of this video frame obtained by the last first operation; the second current feature map of this video frame corresponding to the third operation except for the first third operation is the seventh feature map of this video frame obtained by the previous third operation; and, the second current feature map of the preceding frame of this video frame is the seventh feature map of this preceding frame obtained by the current third operation.

In the embodiment of the present application, the neural network for implementing the at least one first operation may be called an adjacent variation transformer (AVT) network, and the AVT network may include multiple cascaded AVT modules. Each AVT module implements one third operation, and the input of one AVT module includes the output of the previous AVT module. The feature map containing more accurate outline information and absolute position information of the object can be obtained by the AVT network. The feature extraction process of the AVT network is similar to the feature extraction process of the ADT network shown in FIG. 3A, except that the input and output feature maps are different.

For any video frame, the feature extraction principle of the first AVT module corresponding to this video frame is described below. The input feature map includes the output feature map of this video frame obtained by the ADT network (e.g., the feature map of this video frame output by the last ADT module, e.g., the input feature map of the AVT module of this video frame) and the output feature map of the first AVT module corresponding to the previous video frame of this video frame. Based on the feature maps of the two video frames (e.g., the spliced feature map of the two video frames), the AVT module may recognize an object in this video frame to obtain a first object feature map. Based on this object feature map and the input feature map of this video frame, the output feature map (e.g., the seventh feature map) containing the outline and position of the object in this video may be obtained.

In an embodiment, for any video frame, the first object feature map of this video frame may be obtained in the following way:
splicing the second current feature map of this video frame and the second current feature map of the preceding frame of this video frame (e.g., fusing the semantic features of this video frame and the semantic features of the adjacent frame), and obtaining a mask feature map of this video frame based on the spliced feature map, the feature value of the region where the object is located in the mask feature map being 1, the feature value of the region where no object is located being 0; and
for the region with a feature value of 1 in the mask feature map, filling the feature value of this region by using the feature value of the corresponding region in the second current feature map of this video frame, to obtain the first object feature map.

In an embodiment, the mask feature map may be obtained by an image segmentation network. The input of the image segmentation network includes the feature map of the current frame and the feature map of the preceding frame. Based on the feature maps of multiple frames, the network segmentation network may recognize the object region and the non-object region in the feature map of the current frame and then output a mask feature map. This mask feature map is a binary feature map. Subsequently, the pixel value of the object region in the binary feature map may be filled by using the pixel value in the current feature map of this video frame (for example, only the pixel value of the object region in the input feature map is reserved, and the pixel values of other regions are set as 0) to obtain the first object feature map. In an embodiment, the first object feature map of this video frame may be used as the seventh feature map of this video frame, or feature extraction may be performed on the first object feature map to obtain the seventh feature map of this video frame. To further improve the accuracy of object recognition, as an embodiment, the seventh feature map of this video frame may be obtained in the following way:
using the first object feature map of this video frame as the first current feature map of this video frame and the second current feature map of the preceding frame of this video frame as the first current feature map of this preceding frame, and performing the first operation to obtain a second object feature map of this video frame; and
fusing the second current feature map and the second object feature map of this video frame to obtain the seventh feature map of this video frame.

In the embodiment, in addition to the neural network (e.g., image segmentation network) for recognizing the region where the object in the image is located, the AVT module may further include an ADT module. The principle of the ADT module is the same as the principle of the above-described ADT, except that the input feature maps are different. The input feature map of the ADT module in any AVT module includes the first object feature map of the current video frame and the seventh feature map of the preceding frame of this video frame (e.g., the output feature map of the preceding frame obtained by the current AVT module), and the output feature map is the more fine-grained object feature map of the current video frame. Subsequently, the output feature map of this AVT module corresponding to this video frame may be obtained by fusing the input feature map of the AVT module of this video frame and the fine-grained object feature map. After each video frame is processed by the AVT network, a new spatial-temporal feature map (e.g., target feature) of each video frame may be obtained.

It is to be noted that, regardless of the AVT module or the ADT module, since the first video frame in the video has no preceding frame, the feature map of the preceding frame of the video frame may be a preset feature map.

After the target feature map of each video frame of the video to be processed is obtained by the solution provided in any embodiment of the present application, since the target feature map of each video frame contains image features in spatial and temporal, the events in the video can be recognized accurately based on the target feature maps of these video frames. In an embodiment, by the solution provided by the present application, the behavior objects (e.g., non-static objects in the video) of the events in the video and the associated events can also be recognized, and the events related to a specific object can be provided to the user. For example, if the video is a video related to playing football, based on the solution provided in the embodiment of the present application, video clips of a specific football player in the video can be recognized.

As an embodiment, the recognizing event clips in the video based on the target features of each video frame may include:
for any video frame, obtaining object features (e.g., subject features) of this video frame based on the target features and the first object feature map of this video frame, and determining based on the object features whether there is a behavior object in this video frame; and
recognizing event clips in the video based on each first behavior object feature, the first behavior object being the object feature of the video frame containing the behavior object.

In the embodiment of the present application, the behavior object may refer to an object with a preset behavior or preset action. In practical applications, some objects present in the video may not be behavior objects. For example, if there is a cat lying in each frame of the video to be processed and the position of this cat in each frame is the same or basically unchanged, this cat may be considered as the background in the video frame and does not belong to the behavior object. To improve the accuracy of event recognition, after the target feature map of each video frame is obtained, for each frame, it may be determined according to the target feature map whether the object in the video frame is a behavior object, and then event recognition may be performed on only the video frame corresponding to the behavior object.

In an embodiment, for any video frame, the object features corresponding to this video frame may be obtained based on the first object feature map and the target feature map of this video frame. Since the first object feature map identifies the region where the object in the video frame is located, the object feature map may be clipped to obtain a feature sub-map of the region where the object in the feature map is located. For example, the minimum bounding rectangle surrounding the region where the object is located in the first object feature map may be used as the feature sub-map. Subsequently, a feature vector of the object in this video frame is obtained by fusing the target feature map of this video frame and the feature sub-map where the object is located, and it is determined based on the object feature vector whether the object is a behavior object. In an embodiment, the target feature map of the video frame and the feature sub-map may be transposed into feature vectors of the fixed size, respectively, the two transposed feature vectors are spliced to obtain an object feature vector, and a classification result is obtained based on this vector by a classification network. The classification network may be a binary classification network. It may be determined according to the output of the network whether the object is a behavior object. For example, the output of the classification network may be a probability value (e.g., which may be called a score), and the probability value represents the probability that the object is a behavior object. If the probability value is less than a preset threshold, it is determined that the object is not a behavior object; and, if the probability value is greater than the preset threshold, it is determined that the object is a behavior object.

In an embodiment, after it is determined whether the object in each frame of the video frame is a behavior object, the recognizing event clips in the video based on each first behavior object feature includes:
aggregating each second behavior object feature to obtain at least one aggregation result, the second behavior object feature is the first behavior object feature or the target object feature obtained by performing feature extraction on the first behavior object feature; and
for each aggregation result, generating an event clip corresponding to this aggregation result based on each video frame corresponding to the second behavior object feature in this aggregation result.

By vector aggregation, each behavior object feature corresponding to the same behavior object can be found, and each video frame corresponding to each behavior object feature in one aggregation result can be taken as a video frame containing the same object/subject. Thus, after the aggregation result corresponding to each behavior object is obtained, a corresponding event clip may be generated according to each video frame corresponding to the aggregation result.

In an embodiment, for each first behavior object feature, the target object vector corresponding to this first behavior object feature is obtained in the following way:
using the first behavior object feature as a query object feature, and determining at least one similar feature of this query object feature from each first behavior object feature except for this query object vector; and
performing at least one fourth operation based on this query object feature and the at least one similar feature of this query object feature, and using the new object feature obtained by the last fourth operation as a target object feature, wherein the first operation includes:
obtaining a weight corresponding to the at least similar feature based on the correlation between the current object feature corresponding to this query object feature and the at least one similar feature, and fusing the at least one similar feature based on the weight corresponding to the at least one similar feature to obtain a new object feature corresponding to this query object feature;
wherein the current object feature corresponding to the first fourth operation is the query object feature, and the current object vector corresponding to the fourth operation except for the first fourth operation is the new object feature obtained by the previous fourth operation.

In this embodiment provided by the present application, one first behavior object feature and its at least one similar feature may be considered as the features of the same behavior object in different angles or different scenes. By using this embodiment, each first behavior object feature can learn, from this first behavior object feature itself and several other behavior object feature similar to this first behavior object feature, the multi-angle and multi-scene semantic information of the behavior object corresponding to this feature, and the learned target object feature has better feature expression capability, so that it is more advantageous for the accurate recognition of behavior objects and their related event clips.

In the embodiment of the present application, the neural network for implementing the at least one fourth operation may be called a context contrast transformer (CCT) network. The CCT network is a neural network based on the attention mechanism, where the query object feature is the Q (query vector) in the attention mechanism, and both the K vector (key vector) and the V vector (value vector) in the attention mechanism may be obtained based on at least one similar feature of this Q vector. A weight vector may be calculated based on the Q vector and the K vector, and the V vector may be weighted by using the weight vector to obtain a new feature corresponding to the Q vector. This is an example of a weighted fusion.

As an embodiment, for each query object feature, the weight of at least one similar feature corresponding to this query object feature may be obtained in the following way:
splicing each similar feature, and performing feature extraction on the spliced feature in at least two different feature extraction modes to obtain at least two new features;
splicing the at least two new feature to obtain a spliced feature; and, determining, based on this spliced vector and this query object feature, weights corresponding to this query object feature and each similar feature.

By performing feature extraction on the spliced feature in different feature extraction modes, multiple features corresponding to different feature spaces and containing different dimension information can be obtained, and these vectors are spliced and then used as the K vector of the attention mechanism, so that the query vector can better learn the multi-angle and multi-scene semantic information of the same object. In an embodiment, for the V vector, the K vectors of the features extracted in multiple different feature extraction modes in a way similar to the above way may be the same as or different from the K vector.

Each first behavior object feature may be processed in the above way to obtain the corresponding target object feature, and the objects and their relevant events in the video may be recognized based on all target object features corresponding to the video.

After all behavior object features are aggregated to obtain the aggregation results, for each aggregation result, the event clip corresponding to this aggregation result may be obtained in the following way:
performing at least one of the following operations on each video frame corresponding to this aggregation result, and generating an event clip corresponding to this aggregation result based on each video frame after the operation:
operation 1: clipping the video frame based on the object region in the video frame; and
operation 2: setting the pixel value of the background region in the video frame as 0;
wherein the object region is the region where the object in the video frame is located, and the background region is the region outside the object region.

By the operation 1, the video frame may be clipped based on the region where the object in the video frame is located, and an event clip may be obtained based on the clipped sub-map containing the object. For example, the clipped sub-map corresponding to each aggregation result may be processed as the uniform size, and each sub-map of the uniform size is sorted in the chronological order of the video frame where the sub-map is located to obtain event clips composed of these sub-maps. In an embodiment, for each aggregation result, each video frame may also be filtered based on the time interval between video frames corresponding to this aggregation result. For example, if the time interval between one video frame and adjacent video frames before and after this video frame is too large, this video frame may be considered as an isolated frame and may be deleted. An event clip may be generated based on each video frame before the isolated frame, and an event clip may be generated based on each video frame after the isolated frame. Of course, if the number of images contained in an event clip is too small, for example, being less than the set number, this event clip may also be deleted.

By the operation 2, the background of each video frame may be deleted to generate an event clip with a pixel value of 0 in the background region.

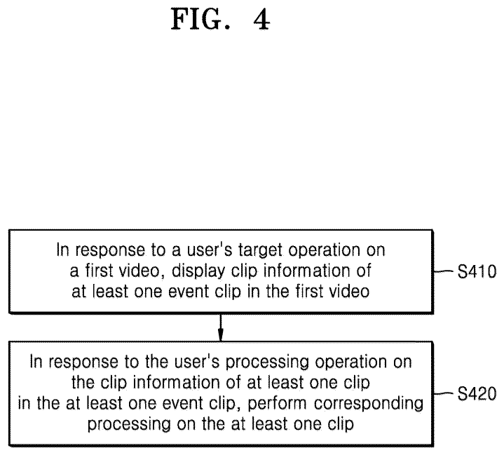

After the events or the behavior objects and their relevant events in the video to be processed are recognized, the events or objects may be provided to the user. An embodiment of the present application further provides a method executed by an electronic device. As shown in FIG. 4, the method may include the following.

In step S410, in response to a user's target operation on a first video, clip information of at least one event clip in the first video is displayed.

In step S420, in response to the user's processing operation on the clip information of at least one clip in the at least one event clip, corresponding processing is performed on the at least one clip.

The at least one event clip may be some or all event clips in the first video. The first video may be any video, and the event clips in the video frame may be recognized by the method provided in any one of the above embodiments of the present application. In an embodiment, the first video may be sampled to obtain a video to be processed; and, by any solution provided in the embodiments of the present application, each event clip in the video to be processed is recognized, or each behavior object in the video to be processed and at least one event clip associated with each behavior object are recognized.

In the embodiment of the present application, the target operation may be any operation in the preconfigured first operation set. The processing operation may be any operation in the preconfigured second operation set. For any target operation, the information displayed to the user in response to this target operation may be the related information of one or more behavior objects in the video (e.g., the tags of the behavior objects), or may be the related information of clips (e.g., the image sequence of the clips, or the covers of the clips (e.g., any image in the clip), etc.), or may be the related information of behavior objects and the related information of the relevant event clips. When multiple pieces of information are displayed, the multiple pieces of information may be displayed simultaneously; or, some information may be first displayed, and other information may be then displayed after the user's related operation is received.

In an embodiment, the target operation may include, but not limited to, at least one of the following:
a video playback operation; a video information viewing operation, and, a specific operation for any behavior object or a specific region in the video frame.

In an embodiment, the processing operation may include at least one of the following:
a clip saving operation; a clip sharing operation; a clip playback operation; a clip merging operation; a clip deletion operation; an operation of triggering the displaying of the image sequence in clips; a clip edition operation; and, a clip issuing operation.

As an embodiment, the displaying, in response to a target operation, clip information of at least one event clip in the first video may include at least one of the following.

The related information of at least one event clip is displayed.

The related information of behavior objects associated with the at least event clip and related information of at least one event clip associated with each behavior object are displayed.

The related information of at least event clip of a target behavior object associated with the target operation is displayed. For example, the user may long-press on a certain object in the video frame in the video playback process. If this object is a behavior object, the information of the event clip associated with this behavior object may be displayed to the user.

The related information of behavior objects associated with at least one event clip is displayed, and in response to the user's trigger operation on the second prompt information of any behavior object, the related information of at least one event clip related to the any behavior object is displayed. For example, the tags of all behavior objects recognized in the video may be displayed to the user, and the user may select the behavior object of interest. Then, the information of the event clip of the behavior object selected by the user may be presented to the user.

An event viewing control of the target behavior object associated with the target operation is displayed, and in response to the trigger operation on the event viewing control, the related information of at least one event clip of the target behavior object is displayed. For example, the user may select a behavior object of interest in the video frame. This selection operation may be regarded as the target operation. In response to the target operation, an operable control may be displayed, and the user may be prompted through this control to view the highlight clip (e.g., the event clip) of the behavior object corresponding to this target operation. The user may click this control, and then the information of the behavior clip of this behavior object is displayed to the user.

Of course, in practical implementations, if the user selects a certain event clip or performs an operation on a certain event clip/behavior object, the corresponding event clip may be directly played to the user. The implementation form of the “operation” described in the above implementations may include, but not limited to, a touch operation, or may be a speech operation or the user's input/operation obtained in other ways.

To better understand and explain the method provided in the embodiments of the present application, the alternative implementations of the method provided by the present application will be further explained below by referring to the principle of the solutions provided by the present application and some alternative embodiments, and the steps in different embodiments can be combined or replaced with each other if not conflicted.

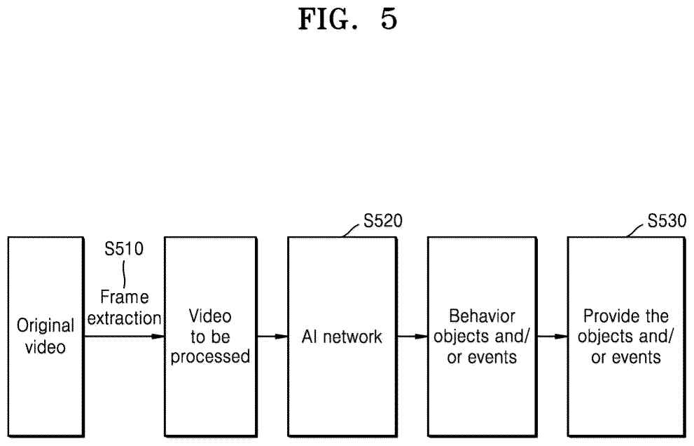

FIG. 5 shows a principle diagram of a method executed by an electronic device according to the present application. The electronic device may be a user terminal/terminal device, or may be a server, e.g., a server of an application. The following description will be given by taking a terminal device as the executive body of this method. As shown in FIG. 5, the method may include the following operation steps.

In step S510, an original video is acquired, and frame extraction is performed on the original video to obtain a video to be processed.

The step of performing frame extraction on the original frame is an alternative step, and the original video may also be directly used as the video to be processed. The specific way of performing frame extraction on the original video will not be limited in the embodiment of the present application. In an embodiment, feature extraction may be performed on the original video according to the set frame interval or the set time interval. For example, one frame is extracted every two frames, or one frame is extracted every set millisecond. The extracted video frame sequence is taken as the video to be processed.

In step S520, the video to be processed is input to an AI network, and the video to be processed is processed by the AI network to obtain events in the video or behavior objects and their relevant events in the video.

The event is a video clip where an event occurs, for example, a video clip containing/appearing the set action; and, the event clip is obtained based on at least some video frames in the video to be processed. In an embodiment, in addition to the event clip, the output of the AI network may also include the behavior object of the event (e.g., which may also be called an event object), which refer to a target object associated with the event in the event clip, for example, the executive body of the set action in the event clip. As an example, if a person's action in the long jump appears in the video to be processed, this person is a behavior object, and the event clips corresponding to this behavior object are generated based on each video frame of this person in the long jump. For example, the video frames of this person doing the long jump are combined to obtain event clips, or the video frames of this person doing long jump actions are clipped in regions where this person appears in the video frames and the clipped frames containing this person are combined to obtain event clips.

In step S530, the events or the behavior objects and their relevant events are provided.

In an embodiment, the terminal device may directly display each event clip output by the AI network to the user. The specific display form will not be limited in the embodiment of the present application. For example, the event clips may be displayed to the user in the form of a list. In an embodiment, the terminal device may display each behavior object in the video to the user, the user may select a behavior object of interest, and the terminal device may display event clips to the user according to the behavior object selected by the user. For example, the cover of the event clips of the behavior object (e.g., any image containing the behavior object in the event clips) is displayed to the user, or the images of the event clips are displayed to the user in the form of a list, thumbnail or tabulated list or in other forms. It is also possible play the event clips of this behavior object to the user after the user clicks the behavior object of interest.

The embodiment provided by the present application will be further described below based on the principle shown in FIG. 5 by referring to an embodiment of the present application. The neural network involved in the embodiment of the present application may be called a network, module or model. For example, the ADT network may be called an ADT module or ADT model.

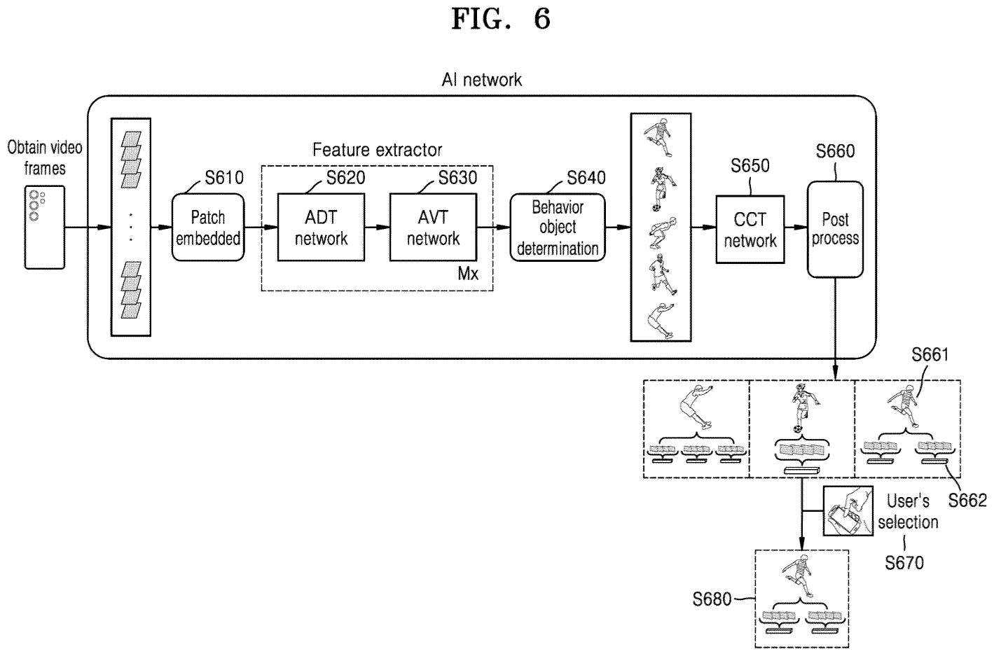

In an embodiment, as shown in FIG. 6, the AI network in this embodiment may include an image patch encoding module, an ADT network that can obtain the spatial outline information and temporal relative position information of an object (or called an object or subject), an AVT network that can obtain the absolute position information and fine-grained outline information of the object, and a CCT network and a post-processing network that can multi-angle and multi-scene information of the object, which are all cascaded. The input of the later network in the cascaded networks includes the output of the previous network.

The input of the AI network is multiple consecutive video frames in the video to be processed. The image patch encoding module may encode each input video frame into a preset number of patches (or called blocks). The ADT network may further extract the semantic information of each video frame based on the output of the image patch encoding module to recognize a fast motion behavior in the image. Specifically, the ADT network may locate the relative position of the same behavior object between adjacent frames and capture the coarse-grained outline of the behavior object, and may accurately recognize the behavior transpose of the object in combination with the both (outline and position), so that the ADT network can accurately recognize the fast motion behavior.

Based on the output of the ADT network, the AVT network may locate the absolute position of the behavior object, so as to obtain the real position of the object in the frame. The AVT network may obtain the fine-grained outline containing the semantic information (e.g., color and attitude) of the object. In combination with the both, the AVT network may accurately recognize the behavior object. Based on the output of the AVT network, the behavior object module may determine whether the object in the video frame is a behavior object, and may give a quality score for each behavior object. Based on all behavior objects determined by the behavior object module, the CCT network may learn the multi-angle and multi-scene semantic information of each behavior object. The post-processing network is configured to aggregate behavior objects and to recognize the related event of each behavior object in the video.

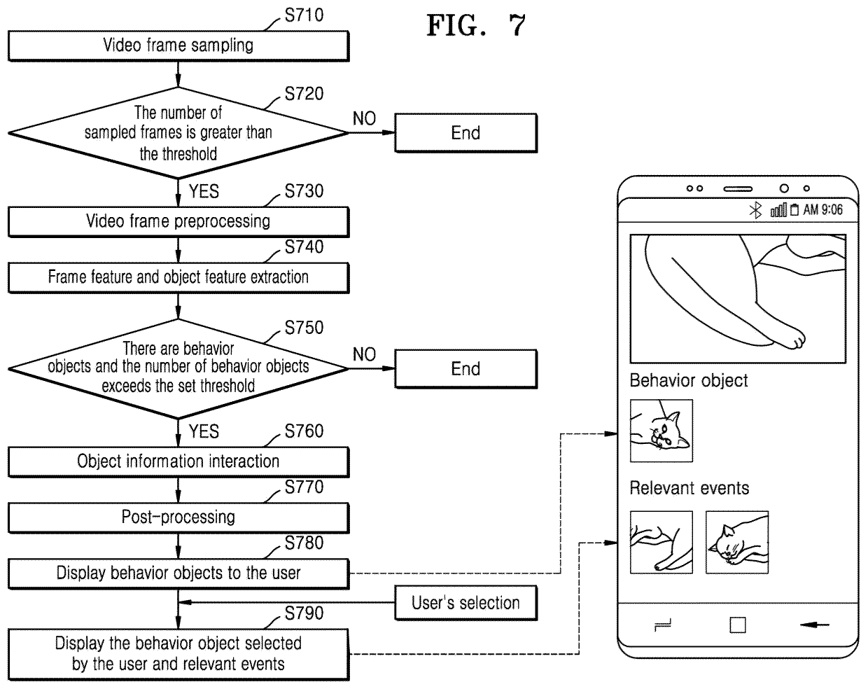

FIG. 7 shows a schematic flowchart of a video processing method (e.g., a method executed by an electronic device) according to this embodiment. The method will be described by referring to the AI network architecture shown in FIG. 6 and the schematic flowchart shown in FIG. 7. The method may include the following.

In step S710, video frames of a video are sampled; In step S720, it is determined whether the number of sampled video frames reaches the set number; when the number of video frames is lower than a threshold, the process ends, and no content is output; and, when the number of video frames is greater than or equal to the threshold, the object and event recognition starts.

The input of the step S710 is a video (e.g., an original video to be processed). Sampling/frame extraction is performed on the original video, and the video to be processed with the number of sampled video frames not less than the set threshold is processed. If the number of video frames in the video to be processed is small, the video to be processed will not be processed. In an embodiment, the step S710 may also be replaced by determining the number of video frames included in the original video. If the number of video frames in the original video is not less than the preset threshold, the original video is sampled, and the sampled video is used as a video to be processed for further processing; and, if the number of video frames in the original video is small, video sampling and subsequent processing may not be performed.

In step S730, the original video frames are preprocessed.

This step S730 is an alternative step. Each sampled video frame in the video to be processed may be preprocessed. The preprocessing may include, but not limited to, scaling of the video frame. Since the original video frame is generally high in resolution, in order to accelerate the calculation and improve the processing efficiency, the size of the video frame may be readjusted. For example, if the size of the video frame is greater than the set size, the video frame is scaled down to the set size; and, if the size of the video frame is not greater than the set size, the size of the video frame may not be adjusted, or the video frame may be adjusted to the set size.

In step S740, object and event recognition is performed on each video frame to be processed by an AI network, to obtain a recognition result of event clips.

The input of this step S740 is all sampled and preprocessed video frames. This step may include the following steps S610 to S660.

In step S610, each video frame is encoded into multiple patches of the same size by image patch encoding (patch embedded).

The input of this step is all sampled and preprocessed video frames, and each video frame is preliminarily encoded. In this embodiment, each video frame may be encoded by image patch encoding to obtain an initial encoded result (e.g., initial feature map) of each video frame. In an embodiment, the image patch encoding of this step may be implemented by a convolutional network, and feature extraction is performed on each video frame by the convolutional network to obtain an initial feature map of each video frame. Each pixel point (e.g., feature point) in the initial feature map of each video frame corresponds to one image patch in the video frame. In an embodiment, the kernel size and the convolution stride of the convolution kernel of the convolutional network may be the same, so that each pixel point on the feature map obtained by encoding may not be overlapped with the corresponding image patch in the video frame. Of course, the convolution stride may also be less than the kernel size of the convolution kernel, so that there will be some overlapping regions between the image patches corresponding to adjacent feature points on the initial feature map. For each video frame, it is also possible to divide the video frame into multiple image patches according to the preset size and then perform feature extraction on each image patch to obtain an encoded result of each image patch in the video frame. At this time, the encoded result of one video frame includes the encoded result corresponding to each image patch in this video frame.

For the convenience of description, hereinafter, the initial feature image of each video frame obtained by image patch encoding is called a feature map A, e.g., the first feature map described above.

In step S620, each video frame is input to an ADT network composed of ADT modules, and the ADT network extracts object coarse-grained outline and relative position information and outputs a frame feature map with the object coarse-grained outline and relative position information.

The input of this step is the output of the image patch encoding, e.g., the feature map A of each vide frame. Based on the feature map A of each video frame, a frame feature and an object feature are further extracted from each video frame by the trained ADT network to obtain a new feature map of each video frame. Hereinafter, the feature map of each video frame extracted by the ADT network is called a feature map B, e.g., the second feature map of each video frame output by the last ADT network described above.

In step S630, the feature map of each video frame output in the previous step is input to an AVT network composed of AVT modules, and the AVT network extracts object absolute position and fine-grained outline information and outputs a frame feature map with the above information and a segmented object feature map.

The input of this step is the feature map B of each video frame output by the ADT network. Based on the feature map B of each video frame, fine feature extraction is performed by the AVT network to a feature map C of each video frame. The feature map C of each video frame output in this step includes a feature map C1 (the seventh feature map output by the last AVT module) of each video frame and a feature map C2 (the object feature map output by the last AVT module) of an object contained in each video frame.

The “M×” shown in FIG. 6 means that the ADT network may include M (M≥1) superimposed ADT modules and the AVT network may also include M superimposed AVT modules. The number of feature extraction modules corresponding to the ADT network and the AVT network may be the same or different. The ADT network and the AVT network may be called feature extractors in the solutions provided in the embodiments of the present application.

In step S640, the extracted object features are determined; if the extracted objects are behavior objects and the number of objects exceeds a set threshold, the subsequent operation is performed; otherwise, the process ends, and no content is output.

This step is determining, based on the feature map of each video frame output in the previous step and by a behavior object determination module (behavior object recognizer), whether each video frame contains a behavior object.

In an embodiment, for each video frame, a rectangular feature map may be clipped on the object feature map C2 of this video frame according to the object outline, the frame feature map C1 of this video frame and the clipped object feature map are adjusted as vectors of the same size for splicing, and the spliced vector (behavior object feature) is processed by the trained behavior object recognizer to generate a score (behavior object recognition score). The vector with a score exceeding a score threshold will be used as a behavior object vector (the object in this video frame is a behavior object) for further processing. If the behavior object recognition score corresponding to one video frame is less than the score threshold, it is considered that this video frame does not contain any behavior object, and this video frame may not be processed any more.

In an embodiment, for a video to be processed, if the number of determined video frames containing behavior objects is small, the video may not be processed subsequently; and, if the number of video frames containing behavior objects exceeds the set threshold, based on the video frames containing behavior objects, each video frame may be processed subsequently.

In an embodiment, for the determined behavior object vectors, these behavior object vectors may be processed by a trained object quality recognizer, and a quality score is given for each vector. The quality score corresponding to one video frame represents the quality of the behavior subject/object contained in this video frame. The higher the score is, the higher the quality is.

In step S650, object information interaction is performed. In this step, the behavior objects may perform information interaction by using a trained information interaction network (CCT network), to assist in better recognition of behavior objects.

The input of this step is all behavior object vectors determined in the previous step. The correlation between these behavior object vectors can be learned by a neural network, so that each behavior object vector can integrate the information of the associated behavior object vectors to obtain a new behavior object vector corresponding to each video frame.

In an embodiment, for each behavior object vector, several behavior object vectors most similar to this behavior object vector may be found from all behavior object vectors. For example, K vectors similar to this behavior object vector may be found by using cosine similarity. Then, each behavior object vector is used as a query vector. For each query vector, this query vector and its K similar vectors are input to a network (CCT network) composed of context contrast transformers. This query vector performs information interaction with the K vectors, so that the query vector obtains its multi-angle and multi-scene semantic information from the K vectors. The network outputs a new query behavior object vector with the multi-angle and multi-scene semantic information. Each behavior object vector can learn the corresponding new behavior object vector through the CCT network.

In step S660, the behavior objects are post-processed.

The input of this step is each new behavior object vector obtained by the CCT network. This step may include a behavior object aggregation stage S661 and an event confirmation stage S662.

In the first post-processing stage S661, all new behavior object vectors obtained in the previous step may be aggregated to obtain at least one aggregation result. The specific way of aggregation will not be limited in the embodiment of the present application. In an embodiment, all behavior object vectors may be aggregated by graph propagation, and all aggregated behavior object vectors are classified into multiple different aggregations. The behavior objects corresponding to these behavior object vectors in each aggregation after aggregation are regarded as the same behavior object, for example, the same person. The output of behavior aggregation is the behavior object vectors with aggregation tags, and the specific tag of one aggregation represents the behavior object in this aggregation.

In the second post-processing stage S662, the frame where the behavior object vector in each aggregation is located may be found, and the frame where each behavior object is located is clipped into a rectangular frame according to the shape of the behavior object. The new clipped rectangular frames form a consecutive clip according to a certain frame pitch. This clip is an event. In an embodiment, for each aggregation, the frame corresponding to a behavior object vector with the highest quality score in the aggregation may be found, and this behavior object is segmented from this frame. The output of this post-processing step may include the behavior object segmented in each aggregation and the corresponding event.

In step S670, the whole video is shown to the user, and the user is allowed to select a behavior object from the video.

In step S680, the behavior object selected by the user and its relevant events are output.

In the schematic diagrams shown in FIGS. 6 and 7, the output of post-processing includes three behavior objects and the event clips corresponding to the behavior objects. All behavior objects segmented in the post-processing stage S662 are displayed to the user, the user may then select a behavior object of interest, and this behavior object and its relevant events are output. Of course, it is also possible to display all behavior objects and their relevant events to the user.

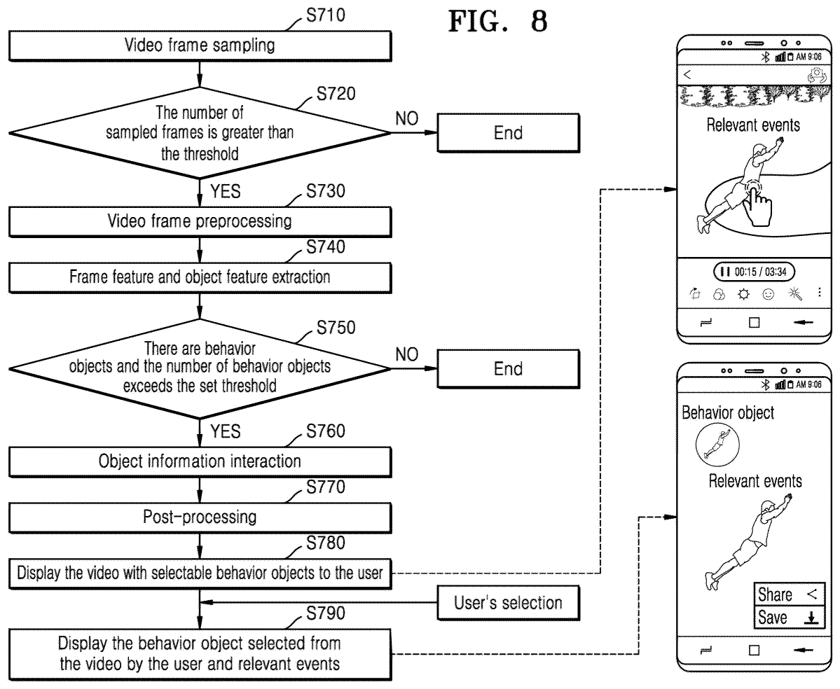

In an embodiment, the video processing principle in the embodiment may continuously refer to FIG. 6. FIG. 8 shows a schematic flowchart of a video processing method according to an embodiment of the disclosure. There may be different implementations of the second post-processing stage S662 and steps S670 and S680. The embodiment may provide a user interaction mode.

The steps before the post-processing stage and the first stage of the post-processing stage in Embodiment 2 may be the same as the steps S610 to S650 and the first post-processing stage S661 in the embodiment. The steps after the first post-processing stage in the embodiment may be described below.

In the second post-processing stage S662, the frame where the behavior object vector in each aggregation may be found. The background in the frame where each behavior object is located is removed. For example, the pixel value of the background region in the frame where the behavior object is located may be set as 0. The original pixel value in the behavior object region is reserved, and only each video frame containing the behavior object is output. These new video frames may form a consecutive clip according to a certain frame pitch. This clip is an event. Then, the frames corresponding to all behavior objects in the aggregation are found, and behavior objects are segmented from the frames to obtain behavior objects and events segmented in each aggregation.

In the embodiment, it can be seen that the second post-processing stage may be different: In the embodiment, each video frame is clipped according to the shape of the behavior object in the video frame, and an event clip is obtained based on the new clipped video frame containing the behavior object; In the embodiment, the background region in each video frame is removed, and an event clip is obtained based on each video frame with background removed. Of course, in practical implementations, it is also possible to not clip the video frame or not remove the background, and directly obtain an event clip corresponding to each aggregation based on each video frame corresponding to each aggregation.

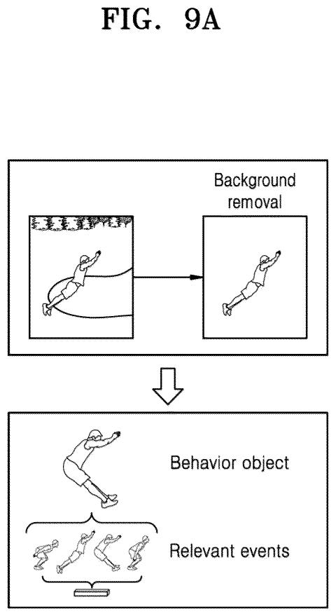

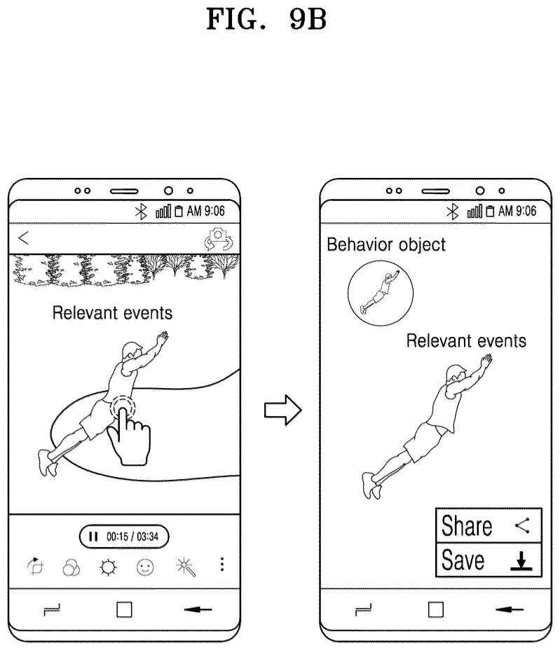

As an example, FIG. 9A shows an effect diagram of the embodiment. By removing background, the obtained background region is white, and the behavior object region is an image obtained by processing the original pixel value in the video frame. For each aggregation, an event corresponding to this aggregation may be obtained according to all processed images corresponding to all behavior object vectors in this aggregation. The behavior object corresponding to this aggregation is the behavior object in the image with the highest quality score. The behavior object in this example is a person, and the event is that a person is doing long jump.

When the user watches a video, the behavior objects obtained in the second post-processing stage 362 may be displayed to the user. In an embodiment, if the user is interested in a certain behavior object, the user may long-press on this behavior object in the video, and a related event button will be shown on the page after a long press. The user clicks this button, and this behavior object and its relevant events will be displayed to the user. As shown in the schematic diagrams of FIGS. 8 and 9B, the user recognizes two events in the watched video, for example, the covers of the two event clips shown in the lower side of FIG. 9B. When the user long-presses on a behavior object in the video frame displayed on the user interface in the process of watching the video, the “hand-shaped” button shown in FIG. 9B will be displayed in the user interface. If the user clicks this button, the behavior object and its relevant event shown on the right side of FIG. 9B may be displayed. In an embodiment, as shown, the user may also perform a further operation on the relevant event, for example, sharing the information of this event, saving this video clip, clicking the event clip for playback, etc.

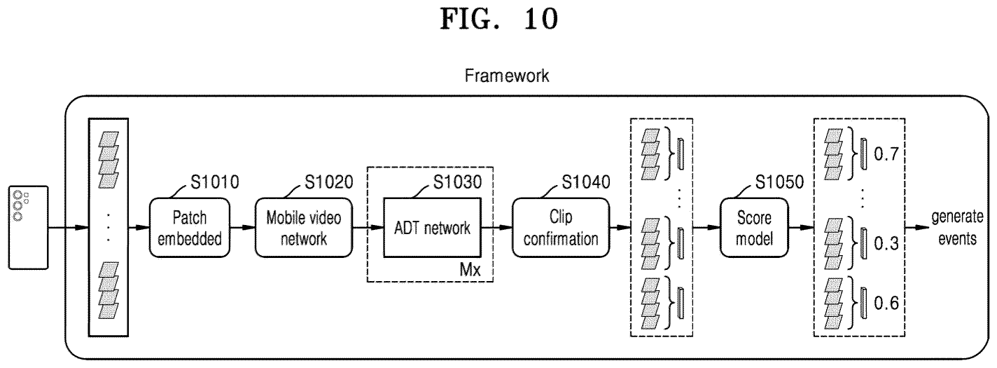

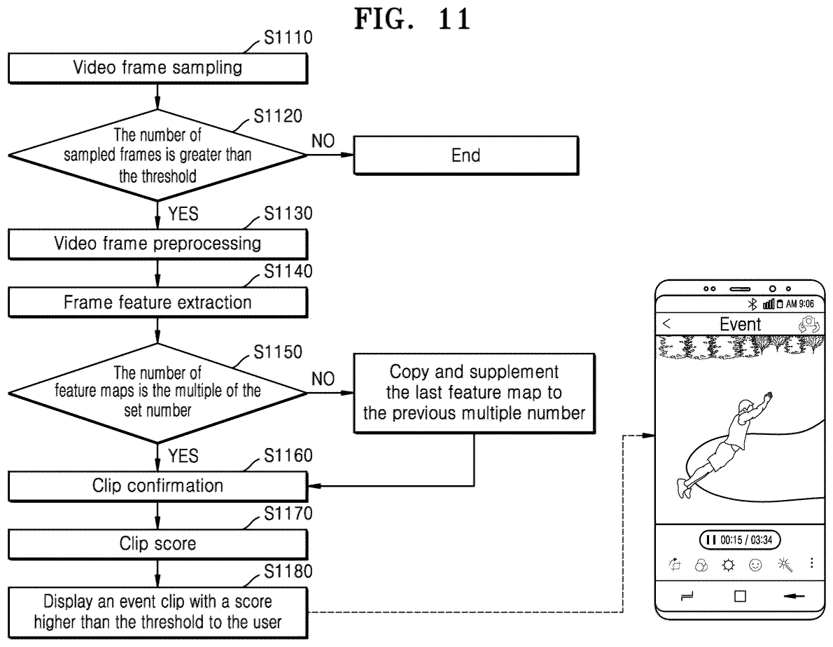

FIG. 10 shows a schematic flowchart of a video processing method in the embodiment, and FIG. 11 shows a schematic structure diagram of the framework of the video processing system corresponding to the embodiment. The video sampling, video preprocessing and image patch encoding steps in the embodiment may be the same as the steps (steps S710, S730 and S610) in the embodiment. As shown in FIGS. 10 and 11, in the embodiment, after the feature map of each video frame is obtained by image patch encoding, the processing steps may be given below.

In step S1020, each video frame is input into the trained mobile video network (MoViNet), and the MoViNet extracts the semantic information of this video frame and outputs a frame feature map with the information.

The input of this step is the output of the previous step, e.g., the feature map of each video frame output by the image patch encoding module. Based on the feature map of each video frame, the mobile video network may extract a new feature map with the semantic information corresponding to each video frame.

In step S1030, the frame feature map output in the previous step is input into an ADT network, and the ADT network extracts object coarse-grained outline and relative position information and outputs a frame feature map with the information.

In step S1040, the frame feature map output in the previous step is input into a clip confirmation module, and the clip confirmation module may process the same number of consecutive frame feature maps and output the multiple consecutive frame feature maps as vectors (e.g., clip vectors) of a fixed size, representing a video clip.

As shown in FIG. 10, the input of this step is the output of the ADT network. The clip confirmation module is also a trained neural network. The network may process the features of a set number of video frames and output feature vectors of a set length corresponding to the set number of video frames. In this step, the feature maps of the set number of video frames may be processed by one or more of feature fusion, feature extraction, feature pooling or other processing methods. By this step, feature dimension reduction may be performed on the feature maps of multiple video frames to obtain clip vectors of the multiple video frames.

For example, the set number is 10. If the output of the ADT network is the feature maps of 27 frames, the features of 27 frames may be supplemented by the feature maps of 30 frames (the integer multiple of the set number). For example, the feature frame of the last frame is copied and supplemented to the previous multiple number of frames (the multiple of the result of rounding up the ratio of the number of video frames to the set number), every 10 frames are regarded as a video clip, and the feature maps of every 10 frames are input to the clip confirmation module to obtain a clip vector.

In step S1050, each clip vector output in the previous step is input into a score model, and this clip vector is scored.

The network structure of the score model will not be limited in the embodiment of the present application. Optionally, the score model is composed of multiple trained fully-connected layers. After each clip vector is input to this model, a score of this clip vector is output, for example, the scores 0.6, 0.3, . . . , 0.7 shown in FIG. 10. The score of one clip vector represents the probability that the video clip corresponding to this clip vector is an event clip. The higher the score is, the higher the probability is. The video clip with a score higher than the set score threshold may be displayed to the user as an event clip, while the clip with a score lower than the threshold is not displayed to the user. The specific display mode can be configured as required, and may adopt, but not limited to, the event display mode in the embodiment. For example, each event clip is directly displayed to the user; or, as shown in FIG. 11, the user may long-press on a video frame (for example, long-press on an object in the video frame, e.g., a person) when watching the video, and the event clip of this video frame may be displayed to the user. Or, the user may click any clip in the event clips shown in the lower side of FIG. 11 (the covers of two events are shown in FIG. 11). The terminal device displays the event clip selected by the user to the user. The user may also save, share or play this event clip.

As an embodiment, the ADT network in the embodiment may also be replaced with the AVT network.

In the embodiment of the present application, the ADT network, the AVT network and the CCT network are innovatively provided. The feature extraction steps in the alternative embodiments described above may be combined or replaced if not conflicted. In practical implementations, the AI network in the alternative embodiments may include one or more of the ADT network, the AVT network and the CCT network. In the AI network, some structures are alternative structures, while some structures may be replaced with other networks. For example, the image patch encoding module or mobile video network in FIG. 10 may be omitted, or may be implemented by other feature extraction networks.

The alternative implementations of the steps that can be involved in the alternative embodiments of the present application and the neural network structure (e.g., image patch encoding, ADT network, AVT network, CCT network, etc.) that can be included in the AI network will be described below.

In an embodiment of the video preprocessing, for a video acquired on the terminal device (e.g., mobile device), all video frames may be sampled at the fixed frame rate; then, it is determined whether the image format of the video frames is a set image format; and, if the image format of the video frames is not the set image format, the sampled video frames may be converted into the set image format, e.g., RGB (red, green, blue) format. In an embodiment, for each video frame in the set image format, this video frame may be converted into a preset size. For example, the short side of each video frame may be scaled down or up to the fixed size, and the size of the long side is also changed according to the scaling ratio of the short side. Then, a new video frame with fixed length and width may be clipped according to the center of each frame, and then input to the AI network for subsequent calculation.

In an embodiment of the image patch encoding (e.g., patch embedded), the patch embedded may adopt a two-dimensional convolution kernel to sample image patches of each input video frame (e.g., each preprocessed video frame). The calculation formula for the convolution principle may be expressed as:

$$c o n {v}_{x , y} = {\sum }_{i}^{p * q} {w}_{i} {v}_{i} \qquad ( 1 )$$

where x and y represent the x-coordinate (horizontal coordinate) and the y-coordinate (vertical coordinate) of one pixel point in one video frame; p*q represents the size of the convolution kernel, p and q may be the same, and the convolution kernel is a square with a size of p*q at this time; w represents the weight of the convolution kernel (the network parameter of the convolutional network); and, v represents the pixel value of the coordinate (x, y). One convolution calculation is to multiply each pixel value in the image patch with a size of p*q in the video frame with the corresponding weight in the weight matrix of the convolution kernel with a size of p*q, then add p*q multiplication products to obtain a feature value in the feature map, and continuously perform sliding and convolution on the video frame by using the convolution kernel to obtain an initial feature map corresponding to the video frame.

In the principle diagram of the convolution calculation shown in FIG. 2, the kernel matrix represents the weight matrix of the convolution kernel in the formula (1), the size of the matrix is p*q, and the numerical value in the kernel matrix represents the weight w of the convolution kernel. In the schematic diagram of FIG. 2, the size of the convolution kernel is 3*3, the weight is {0, −1, 0, −1, 5, −1, 0, −1, 0}, and the weight values in the weight matrix are obtained by training the neural network based on training samples. The convolution stride may be 3.

The output matrix in FIG. 2 represents the feature map of the video frame after convolution. For the image patch with a pixel value of {105, 102, 100, 103, 99, 103, 101, 98, 104} shown in FIG. 2, the feature value after convolution is 89. The specific calculation process is:

$$0 * 105 + ( - 1 ) * 102 + 0 * 100 + ( - 1 ) * 103 + 5 * 99 + ( - 1 ) * 103 + 0 * 101 + ( - 1 ) * 98 + 0 * 104 = 89.$$

After the same video frame is subjected to the convolution operation by C different convolution kernels, a feature map with a channel of C will be output. Each video frame is down-sampled and encoded by a convolution kernel, and the output feature map with a channel of C is input to the subsequent AI network for feature extraction of the video frame.

In an embodiment of the ADT network, the ADT network provided in the embodiment of the present application is a network composed of adjacent dazzle transformers (ADTs). The network can extract the coarse-grained outline and relative position information of the object in the frame, so that the recognition rate of fast motion behaviors can be improved.

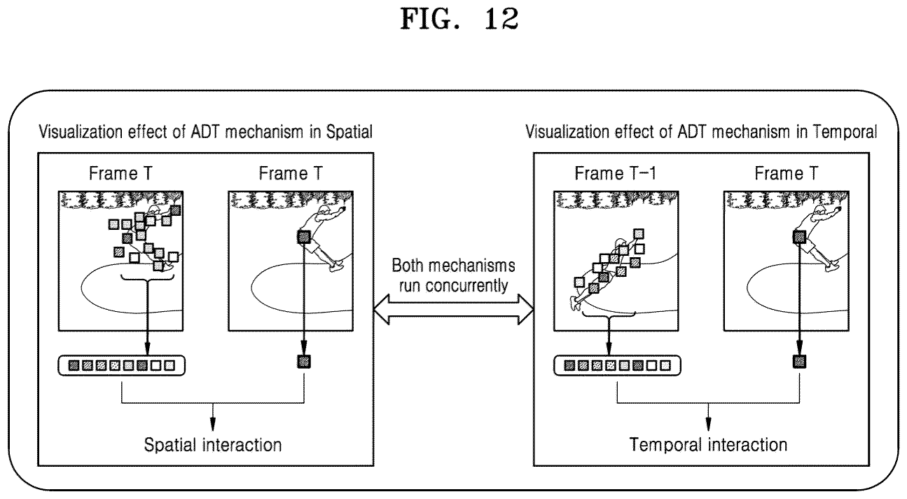

FIG. 12 shows a visualization effect diagram of the ADT network. As shown in FIG. 12, when processing the feature map of each video frame, the ADT network requires the feature map of the current video frame and at least one preceding frame of the current frame. The at least one preceding frame includes at least the previous frame of the current frame. In the following embodiments, the preceding frame takes the previous frame of the current frame as an example.

Each video frame in the video to be processed is processed by image patch encoding and then divided into multiple patches of the same size (here, it should be understood that each pixel point in the feature map after image patch encoding corresponds to one image block/patch on the video frame), for example, a small patch in the video frame shown in FIG. 12. Each patch in each frame needs to perform information interaction with the regions where other related patches are located in the current frame and the previous frame. As shown in the schematic diagram in the left part of FIG. 12, one patch of the current frame T may perform information interaction with other patches related to this patch in the frame T, thereby obtaining object outline information in spatial. As shown in the schematic diagram in the right part of FIG. 12, one patch of the frame T may temporally interact with other patches related to this patch in the previous frame (frame T−1) of the frame T to obtain the relative position information of the object. Information interaction can be performed between video frames in both spatial and temporal by the ADT network to obtain the coarse-grained object outline and relative position in the video frame, so the fast motion behavior in the video can be recognized accurately.

In the example shown in FIG. 12, this video contains an event that an athlete is doing long jump. By the ADT network provided in the embodiment of the present application, the coarse-grained outline can be generated based on the spatial object shape and relative position by temporally tracking the same object (athlete) in the previous frame. Each video frame is regarded as a patch sequence of the same size (a small rectangular box in FIG. 12 represents one patch). For each query patch in each video frame, for example, a small rectangular box in the frame T during the spatial interaction or temporal interaction shown in FIG. 12, the position of the query patch is the athlete's thigh in the frame T. Multiple rectangular patches in the left frame Tin spatial interaction are the related patches of this query patch (e.g., patches that perform information interaction with the query patch), and multiple rectangular patches in the left frame T−1 in temporal interaction are the related patches corresponding to this query patch in the feature map of the previous frame. The related patches of this query patch on the current frame and the previous frame can locate the whole body of the athlete in the coarse-grained range of the T frame. Specifically, the interaction between the query patch and the related patches on the T frame can obtain the outline information of the person. Therefore, the ADT network can obtain the coarse-grained outline of the fast motion object. The interaction between the query patch and the related patches on the frame T−1 is to obtain the relative position of the person, so the ADT network can obtain the relative position of the fast motion object. By combining the both, the behavior transpose of the fast motion object can be obtained, and the fast motion behavior can be recognized accurately.

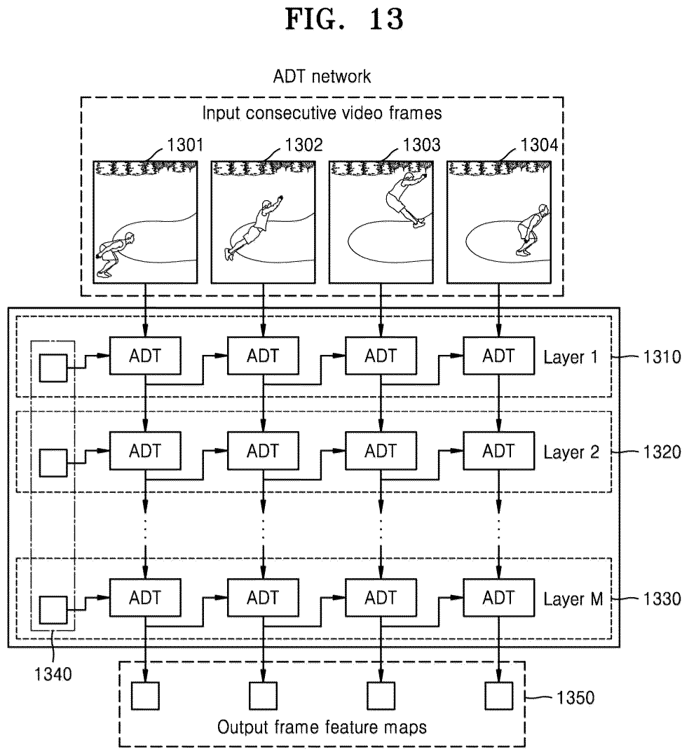

FIG. 13 shows an alternative network structure diagram of the ADT network according to an embodiment of the present application. As shown in FIG. 13, the ADT network is mainly composed of multiple superimposed ADT modules. In the network structure shown in FIG. 13, the ADT network includes M layers of ADT modules 1310 1320 1330. The input of the ADT network is the feature maps 1301 1302 1303 1304 of consecutive frames after Patch Embedded. During processing the feature map of each frame, the feature map of the current frame and the processing result of the previous frame of the current frame need to be used as the input. During processing the feature map of the first frame, the feature map of the previous frame may be a feature map of the same preset size (shown by the rectangular block 1340 in the leftmost dashed box in FIG. 13), for example, a feature map with feature values of 0. The feature map of each video frame is extracted by M layers of ADT modules to obtain a new frame feature map 1350. For any video frame, the input of the ADT module in any layer includes the feature map of this video frame output by the ADT module in the previous layer of this layer and the feature map of the previous frame of this video frame output by the ADT module. The semantic information of the video frame can be learned from shallow to deep by multiple layers of ADT modules.

The process of performing feature extraction by the ADT network may include the following.

(1) The spatial-temporal information of the feature map of the current video frame is extracted by the ADT module in the first layer. In an embodiment, the size of the output feature map is unchanged. The calculation principle of the ADT module may be expressed by the following formula (2):

$$K = Concat ( Conv ( Movement ( {X}_{t - 1} ) ) , Conv ( Movement ( {X}_{t} ) ) ) {W}_{t} = C onv ( Concat ( K , {Q}_{t} ) ) [ : , : , 1 : 2 N ] {W}_{t - 1} = Conv ( Concat ( K , {Q}_{t} ) ) [ : , : , 2 N + 1 : 4 N ] {X}_{output} = {W}_{t - 1} * Vt - 1 + {W}_{t} * {V}_{t} + {Q}_{t} {Q}_{t} = {X}_{t} {V}_{t - 1} = {X}_{t - 1} {W}_{v} \\ {V}_{t} = {X}_{t} {W}_{v} \qquad ( 2 )$$

where Xₜ represents the feature map at the current moment T; Xₜ₋₁ represents the output result feature map of the previous frame of the current frame at the moment T−1, e.g., the feature map obtained by performing feature extraction on the feature map of the previous frame by the ADT module in the first layer; and, Xₒᵤₜₚᵤₜ represents the feature map at the current moment T output after one ADT operation, e.g., the output of the ADT module in the first layer corresponding to the current frame.

In the above formula, Movement(a) means that further feature extraction is performed on the feature map a by a movement module, wherein the movement module may be implemented based on a deformable convolutional network (DCN). Conv(b) means that a convolution operation is performed on the feature map b, and Concat(c, d) means that the feature map c and the feature map d are spliced. Wᵥ means that feature mapping is performed on the feature map V, and the feature mapping may be implemented by the trained mapping matrix or feature extraction network. Q may be original feature map X, or may be a new feature map obtained by performing feature extraction on X. In the above formula, the number of channels in the feature map output after feature extraction by Conv(Concat(K, Qₜ)) is 4N, [:,;, 1:2N] represents the feature map of first 2N channels among the 4 channels, and [:,:, 2N+1:4N] represents the feature map of 2N+1 to 4N channels (last 2N channels).

As shown in the formula (2), during processing the feature map of the current frame at the moment T, the feature maps of the current frame and the previous frame need to be input. For an object in the current frame at the moment T, the spatial outline information of the object may be acquired from the current frame, and the temporal relative position information of the object may be acquired from the previous frame, thereby realizing the extraction of the spatial-temporal information, as shown in the effect diagram of FIG. 12.

(2) The ADT module in the second layer is continuously used to extract the spatial-temporal information from the feature map of the current frame. The size of the output feature map is unchanged, and the calculation principle is shown by the above formula (2). The input of the ADT module in the second layer is the output of the ADT module in the first layer, including the output of the current frame and the output of the previous frame of the current frame.

(3) By that analogy, after multiple layers of ADT operations, a new feature map of each frame is output. The size of the output remains unchanged.

An alternative implementation of performing feature extraction by the ADT module will be described below in detail.

The ADT module may be mainly composed of two parts. As shown in the above formula (2), the first part may acquire the coarse-grained outline and relative position information of the object by the Movement module, and the second part may further perform feature extraction by the transformer. This embodiment of the present application provides a new transformer. The Q (query vector), K (key vector) and V (value vector) of the attention mechanism (which may be called AD attention) in the transformer can acquire more accurate coarse-grained outline and relative position information of the object. The ADT module provided in the embodiment of the present application can acquire the spatial-temporal attitude change of the object more accurately and can thus better recognize the fast motion behavior.

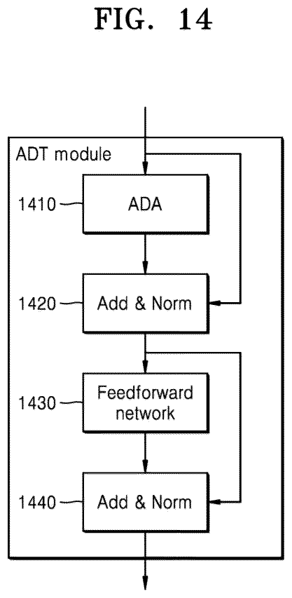

The specific neural network structure of the ADT module will not be uniquely limited in the embodiment of the present application, and the ADT module includes an ADT attention layer. As an embodiment, FIG. 14 shows a schematic diagram of an alternative structure of the ADT module according to an embodiment of the present application. As shown in FIG. 14, the ADT module may include an adjacent dazzle attention (ADA) layer, a residual connection and normalization (Add & Norm) layer, a feedforward network layer and an Add & Norm layer, which are all cascaded. The structures other than the ADA layer are alternative structures (there may be or may not be these structures, or these structures may be replaced with other feature extraction networks). For the network structure shown in FIG. 14, after the input feature map of the ADT module is subjected to feature extraction by the ADA layer, the obtained new feature map and the input feature map of the ADT module are used as the input of the Add & Norm layer, and then subjected to feature map addition and layer normalization to obtain the output feature map of the Add & Norm layer. This output feature and the feature map obtained after processing the output feature map by the feedforward network are used as the input of a new Add & Norm layer, and the output of this Add & Norm layer is used as the output of the ADT module. Each ADT in FIG. 13 represents the ADT operation of the current frame. The ADT module in the layer 1 1310 extracts the shallow semantic information of the video frame, and the ADT module in the layer M 1330 extracts the deep semantic information of the video frame.

The ADT network provided in the embodiment of the present application will be described below. This ADT network includes one or more cascaded ADT modules.

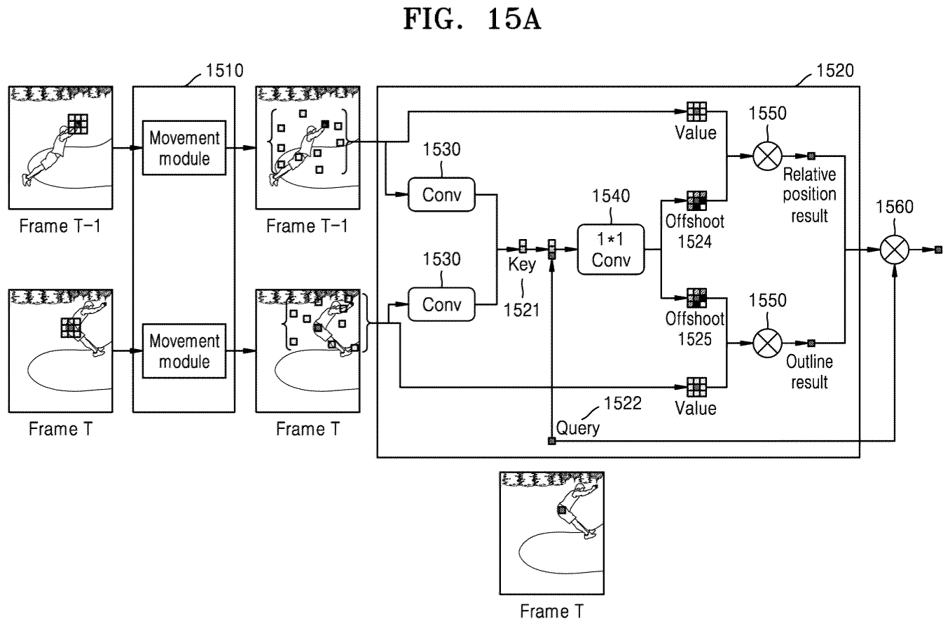

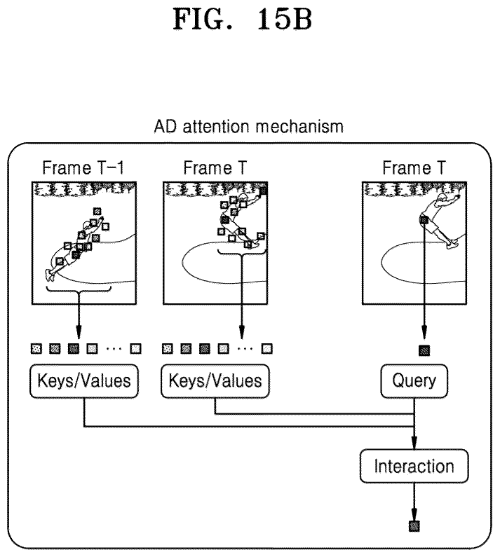

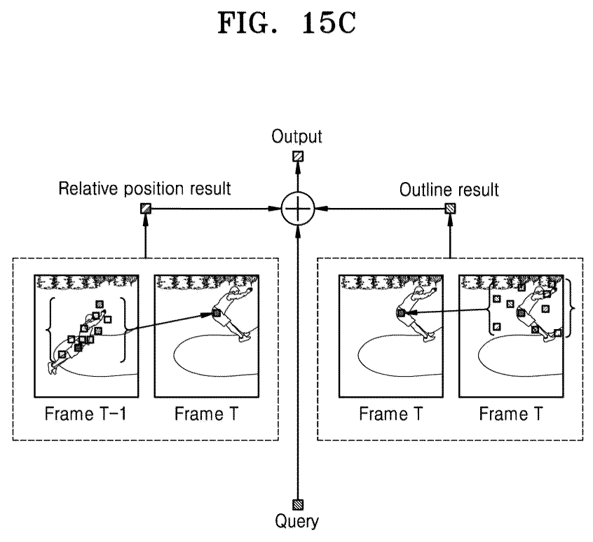

FIG. 15A shows a schematic diagram of the network structure and the feature extraction principle of the ADA mechanism in an ADT module according to an embodiment of the present application. The feature extraction process of the ADT module will be described below by referring to the network structure.

For each video frame, since the frame feature map after passing through the Patch Embedded module is composed of multiple patches of the same size, each patch may be construed as a feature point/pixel point in the feature map, and one feature point corresponds to one image patch in the video frame. For the information extraction of the feature map of each frame, it is necessary to complete the calculation of all patches on this feature map. FIG. 15A schematically shows the calculation process of one patch of the feature map of a single frame at moment T by ADT (for the frame Tin FIG. 15A, it should be understood that, although the input of the ADT module and the output of the movement module are represented in the form of video frames in FIG. 15A, the input and the output are feature maps in the actual processing process), and all other patches in the video may be calculated synchronously in the same way.

For each patch of the frame T, during the calculation of this patch, this patch is used as a query patch. As shown in FIG. 15A, the process of calculation of a patch on the feature map of a single frame at the moment T by the ADT module may include the following.

(1) For the calculation of a query patch on the feature map at the moment T, it is necessary to input the frame feature maps at the moment T and moment T−1.

For the ADT module in the layer 1 (e.g., the first ADT module), the frames T−1 and T in FIG. 15A represent the feature map of the frame T−1 and the feature map of the frame T obtained by image patch encoding. Here, the frame T corresponds to the current frame, and the frame T−1 corresponds to the previous frame of the current frame. For the ADT modules other than the layer 1, in FIG. 15A, the frame T is the output feature map of the previous ADT module of the frame T as the current frame, and the frame T−1 is the output feature map of the ADT module in the current layer of the precious frame. For example, in practical implementations, it is necessary to perform the ADT operation of the current layer on the previous frame and then perform the ADT operation of the current layer on the current frame, because the ADT operation of the current layer on the current frame needs to use the output feature map of the ADT operation of the current layer on the previous frame.

In the following description, the frame T may be described as the feature map at the moment T or the feature map of the frame T, and the frame T−1 may be described as the feature map at the moment T−1 or the feature map of the frame T−1.

For the query patch at the moment T, N patches for generating offshoot around this query patch may be defined in advance, for example, multiple small patches (small rectangular boxes) in the frame T shown in FIG. 15A. For the patch with the same position as the query patch on the feature map at the moment T−1, N patches for generating offshoot at the same position are also defined in advance, as shown in the frame T−1 in FIG. 15A.

(2) The Movement module is composed of trained deformable convolutional networks. After passing through the Movement module, N patches on the feature maps at the moment T and moment T−1 will generate an offshoot (e.g., weights), and these patches will be shifted to the object region related to the position of the query patch.

As shown in the schematic diagram of FIG. 15A, the object in the video frame is a person who does long jump. Before being processed by the movement module 1510, the patches associated with the query patch are several patches adjacent to the query patch; and, after being processed by the movement module 1510, the positions of the patches associated with the query patch in the feature map are shifted to the region where the person in the video frame is located. It should be understood that, the associated patches of the query patch can be found in the region close to the object in the video frame by the movement module 1510, so that the outline and position information of the object in the image can be recognized more accurately.

(3) After the feature maps at the moment T and moment T−1 output in the previous step are subjected to a specific convolution operation 1530 (Conv connected to the movement module in FIG. 15A), two new feature maps will be output. Each patch on the new feature maps can obtain global information. This specific convolution operation is a convolution processing mode provided in the embodiment of the present application and will be described below.

(4) The two feature maps output in the step (3) are spliced (e.g., concatenated). The spliced feature map may be called Keys 1521. The Keys 1521 is a feature map in which the spatial information at the moment T and the temporal information at the moment T−1 are merged (e.g., concatenated).

(5) The Keys 1521 and a query patch 1522 (query in FIG. 15A) on the feature map at the moment T are spliced (e.g., concatenated) to obtain a new feature map. The query patch 1522 and the spatial-temporal information are merged by this operation, so that leading role of the query patch is enhanced.

(6) The new feature map output in the step (5) is input to a 1*1 convolution 1540, and two offshoots 1524 1525 (e.g., offshoot feature maps or weight feature maps) are output, e.g., the offshoots 1525 at the moment T and offshoots 1524 at the moment T−1, which are used for the offshoots of N patches on the feature map at the moment T and the offshoots of N patches on the feature map at the feature map, respectively, thereby assisting in finding other patches related to the query patch more accurately. The detailed description of the obtained offshoots will be given below.

(7) In the current step, the two feature maps at the moment T and moment T−1 after passing through the Movement module are defined as Values at the moment T and Values at the moment T−1.

The Offshoots at the moment T is used as the offshoot of the deformable convolution operation, and a convolution operation is performed based on the offshoot and the feature map Values at the moment T to output a new feature map (outline result). The way of calculating Offshoots provided in the embodiment of the present application is a new way, unlike the existing offshoot calculation method of the deformable convolution operation. By using the Offshoots provided in the embodiment of the present application as the offshoot of the deformable convolution calculation to realize the deformation convolution calculation, other patches related to the query patch can be found on the feature map at the moment T more accurately, and more accurate object outline information can be obtained.

Similarly, the Offshoots at the moment T−1 is used as the offshoot corresponding to the feature map at the moment T−1, and multiplying weights 1550 is performed in combination with the feature map Values at the moment T−1 to output a new feature map (relative position result). By the Offshoots calculation way provided in the embodiment of the present application, other patches related to the query patch can be found on the feature map at the moment T−1 more accurately, and more accurate relative position information can be obtained.

(8) The feature Outline result (second feature patch) at the moment T, the feature Relative Position result (first feature patch) at the moment T−1 and the query patch are fused (e.g., added) 1560 to obtain a new query result, e.g., a new feature obtained after performing one ADT operation on the query patch.

After each patch corresponding to each video frame is processed as above in the same way, the new query result corresponding to each patch is obtained. The feature map of one video frame after one ADT operation is the new query results of all patches corresponding to this video frame.

It should be understood that, during the first ADT operation on each video frame, the input feature map is the feature map of the video frame obtained by image patch encoding; and, during the ADT operation except for the first ADT operation, the input feature map is the feature map output by the previous ADT operation.

In the neural network structure of the ADT module in FIG. 15A provided in the embodiment of the present application, the AD attention mechanism is the core component of the ADT module. For each video frame, when the semantic information of the image is further learned by the ADT module, convolution (deformable convolution) calculation may be performed on the input feature map of the video frame by the movement module of the movement network containing multiple convolution modules, and the movement direction and distance of each patch may be predicted by each convolution calculation. Then, this patch may be moved to the coarse region of the object. Thus, the moved patch may form the coarse-grained outline of the object in the frame T and form the relative position in the frame T−1. Furthermore, the Query, Keys and Values in the novel attention mechanism provided in the embodiment of the present application integrate the information of the frames T and T−1 in the early stage, so the outline and relative position information of the object can be well integrated. The behavior transpose/change of the object can be well recognized.

FIG. 15B shows a schematic diagram of the visualization effect of the AD attention mechanism in the ADT module according to an embodiment of the present application. As shown in FIG. 15B, Query is the Q vector in the attention mechanism and is one patch in the video frame (e.g., the feature value of one feature point), and the K vector (Keys shown, corresponding to Keys in the step (4)) and the V vector (Values shown, corresponding to Values in the step (7)) of the attention mechanism are obtained based on the frames T and T−1. By interacting the K vector with the Q vector, the corresponding weight feature map can be learned, and the new feature (e.g., new Query corresponding to the Q vector) with the object outline information and the relative position information in the image after interaction can be obtained based on the weight feature map and the V vector. The new feature obtained by this solution obtains the coarse-grained outline of the object from the related patches of the frame T and obtains the relative position of the object from the related patches of the frame T−1.

FIG. 15C shows an effect diagram of a process of calculating a new Query of one patch (query patch) in the frame T, where Query represents the query patch and the output represents the new Query. Based on the frame T, by the convolution calculation in the movement module, the preset number of related patches of Query in the frames T and T are moved to the new positions in the frames T and T−1, and the moved patches form the coarse-grained outline of the object in the frame T and form the relative position in the frame T−1. The next step is the operation of Q, K and V in the novel attention mechanism, where Q comes from the query patch, and the query patch may be directly used as Q or feature extraction or feature transpose may be performed on the query patch to generate Q; K is obtained based on the feature convolution operation; and V comes from the feature map output by the movement module. After Q and K are connected, the weights of the frames T and T−1 are generated by the convolution operation. Then, the weight and value of the frame T−1 are multiplied to generate a relative position result, and the weight and value of the frame T are multiplied to generate an outline result. The output may be generated by adding the query patch, the relative position result and the outline result.

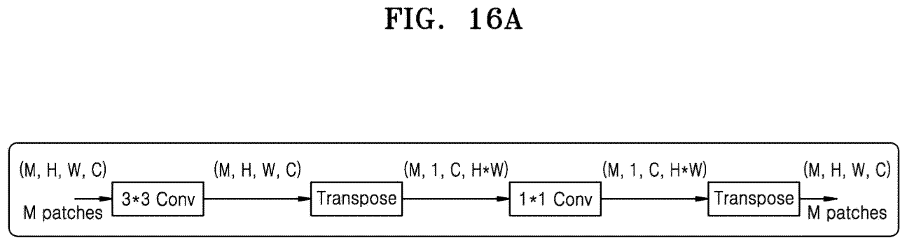

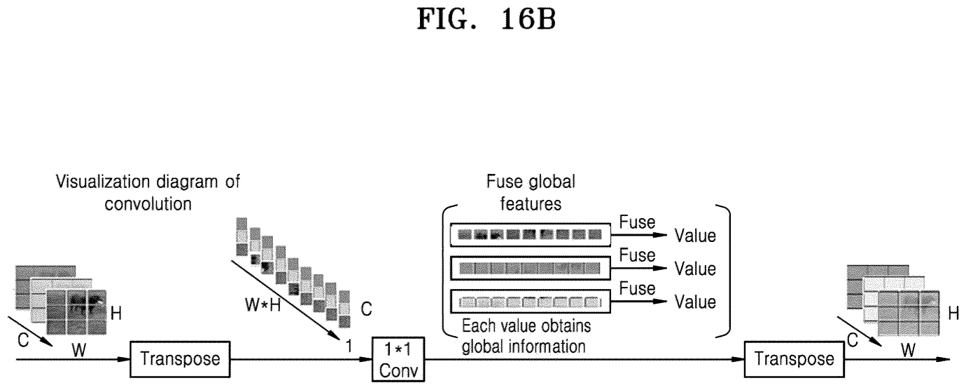

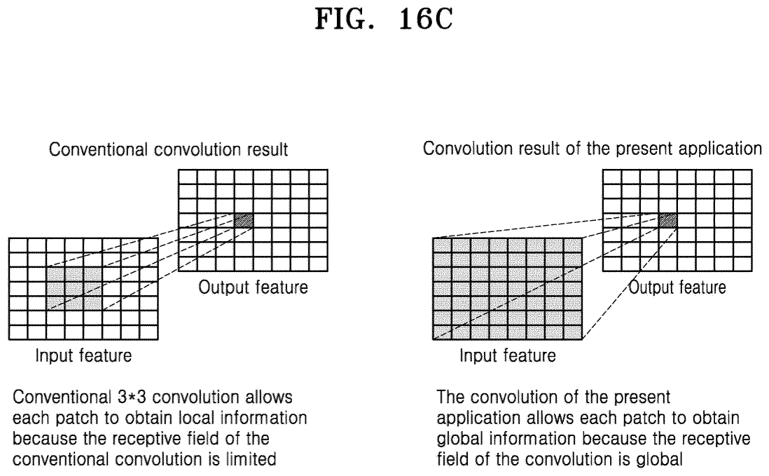

In an embodiment of the new convolution operation, FIG. 16A shows a principle diagram of a new specific convolution operation in ADT according to an embodiment of the present application, FIG. 16B shows a schematic diagram of the visualization effect of this convolution operation, and FIG. 16C shows a comparison diagram of the convolution result of this convolution operation and the conventional convolution result. The new convolution operation provided in the embodiment of the present application will be described below with reference to FIGS. 16A to 16C. The following description is given by taking one video frame as an example. As shown in FIG. 16A, the process of this convolution operation may include the following.

(1) The input is the frame feature map output by the movement module, and each feature map is composed of M patches (the feature map output by image patch encoding includes M patches) of the same size.

As shown in FIG. 16A, (M, H, W, C) represents the parameter of the feature map, M represents the number of patches, H and W represent the height and width of the feature map, and C represents the number of channels of the feature map. It can be seen that the number of channels and the size of the feature map output by each layer in the convolutional network shown in FIG. 16A are unchanged.

(2) Local information of the feature map is extracted by using a conventional 3*3 convolution kernel.

(3) A transpose operation is performed to rearrange channel features in spatial to obtain the rearranged feature map (M, 1, C, H*W). As shown in FIGS. 16A and 16B, the size of the feature map rearranged by a transpose module is 1*C, and the number of channels of the feature map is H*W. For example, by the transpose operation, C feature values of each feature point in the feature map of C channels obtained by feature extraction through conventional convolution are transposed into a feature map of one channel.

(3) After the transpose operation, each patch can obtain the information of the global receptive field by 1*1Conv.

As shown in FIGS. 16A and 16B, since the number of channels of the transposed feature map is H*W, if the feature map of one channel is a feature map composed of the feature values of one feature point on all channels, during the convolution operation on the transposed feature map by 1*1 convolution, the feature values of H*W channels of each position in the transposed feature map will participate in the convolution calculation. Since the feature values of the H*W channels contain the feature values of all feature points in the feature map before transpose, the feature value of each position after the 1*1 convolution operation fuses the global information of the video frame, instead of the local information.

(5) The feature map output in the step (4) is restored to the input size by the transpose operation, for example, the feature map (M, 1, C, H*W) is rearranged into a feature map (M, H, W, C). Each patch in this feature map obtains the global information.

It can be seen from the convolution operation process that the new convolution operation provided in the embodiment of the present application is different from the conventional convolution. FIG. 16C shows the comparison result of the convolution operation provided in the embodiment of the present application and the conventional convolution operation. It can be seen that the receptive field of the conventional convolution operation is limited and each patch can only obtain the local information. For example, for a convolution operation with a convolution kernel size of 3*3, the result of the convolution operation corresponding to each patch can only obtain the information of 9 patches. However, by the new convolution operation provided in the embodiment of the present application, each patch on the output feature map can obtain the global information, thus assisting in the subsequent generation of more accurate offshoots and obtaining more accurate object outline and relative position.

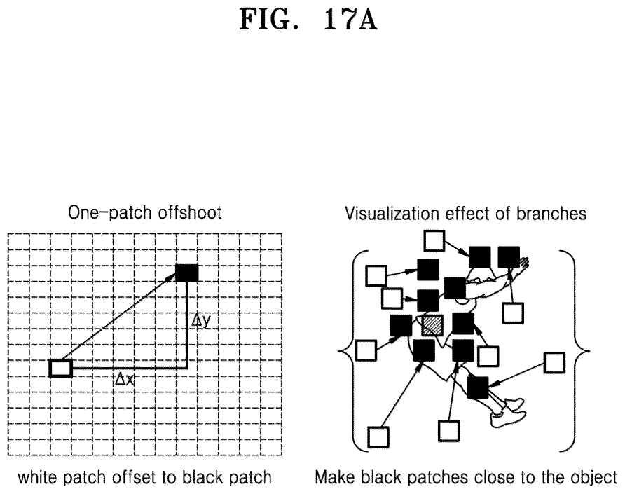

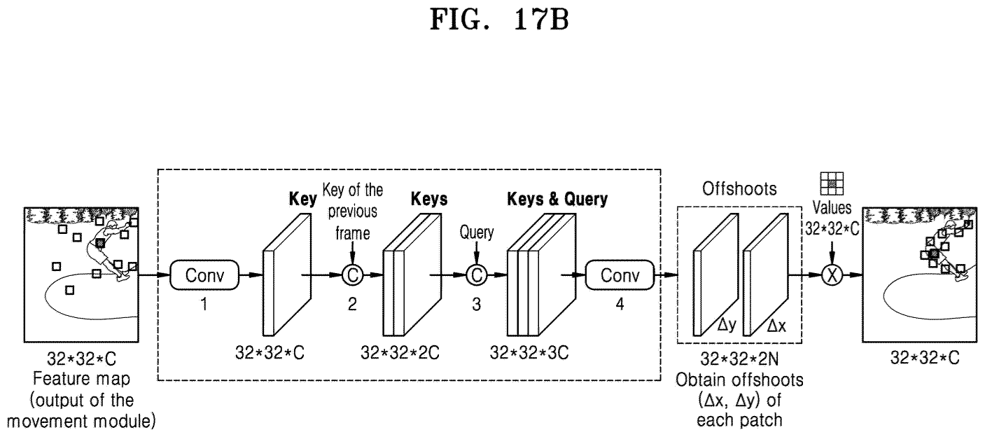

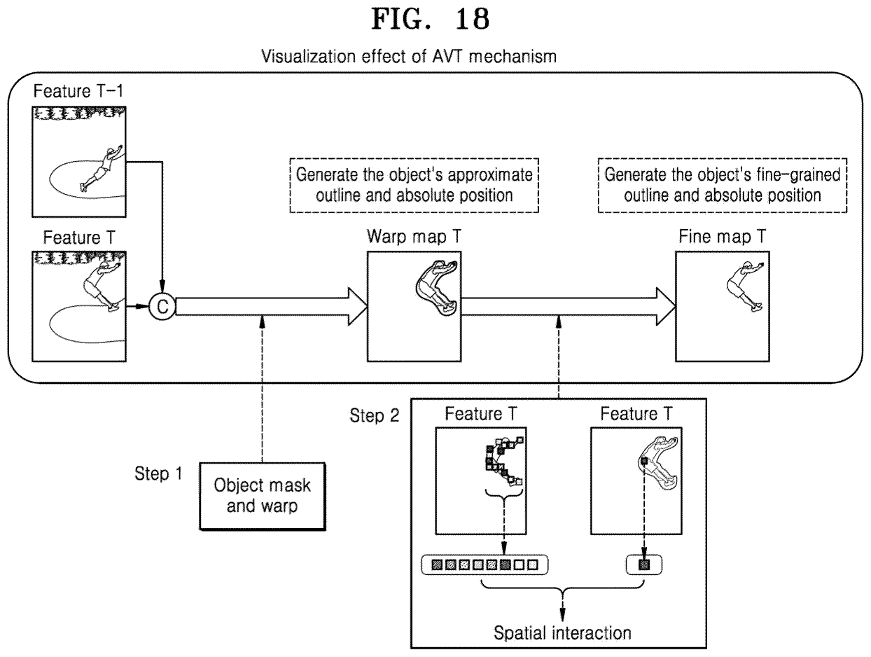

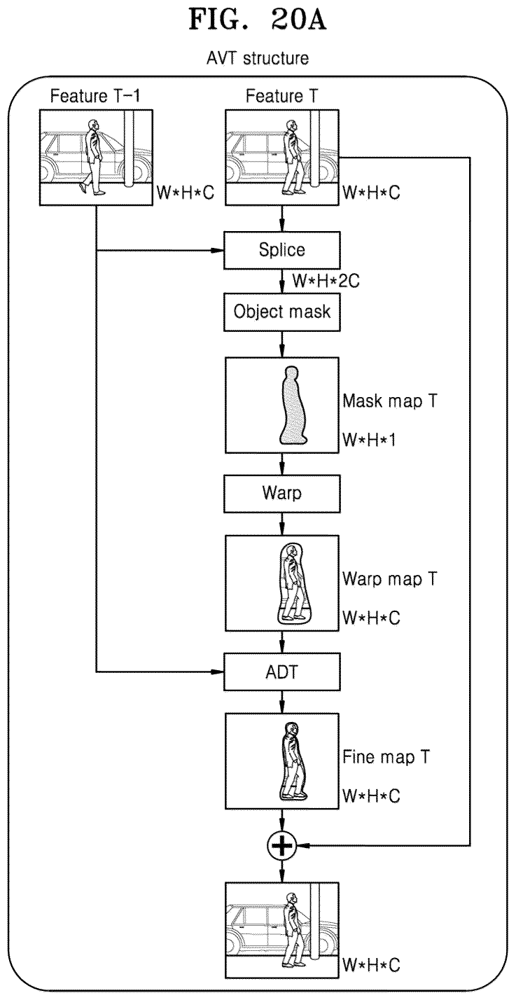

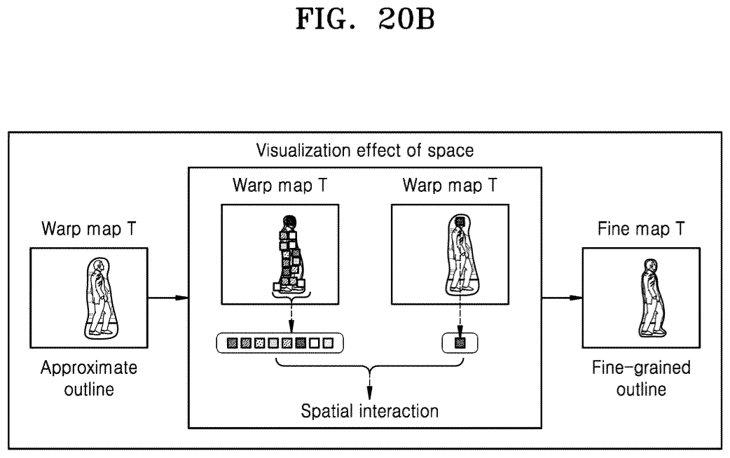

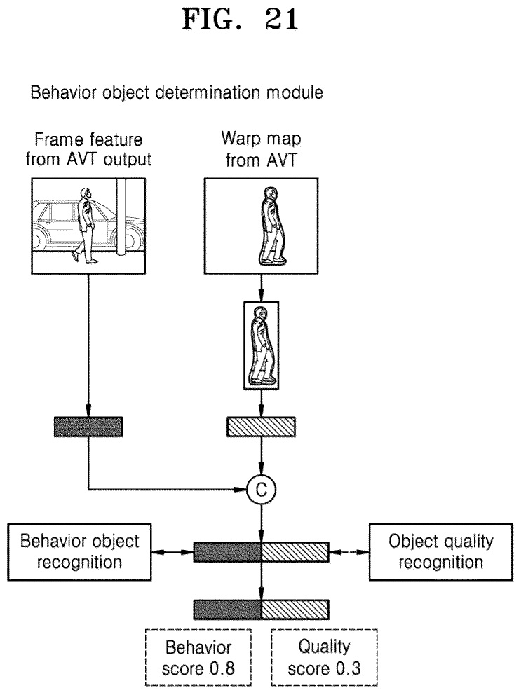

FIG. 16B refers to fusing features (“fuse . . . value”). Fusing of features can be done using, for example, addition or concatenation. For example, see FIG. 15A (the merging arrows), FIG. 15C (the “+” inside the circle), FIG. 17B (the “C” inside the circle), FIG. 18 (the “C” inside the circle on the left), FIG. 20A (the “+” near the bottom), and FIG. 21 (the “C” in the circle near the bottom).

In an embodiment of the calculation of offshoots, FIG. 17A shows a schematic diagram of the visualization effect of the meaning of Offshoots, and FIG. 17B shows a principle diagram of a new deformable convolution operation in the ADT according to an embodiment of the present application. In the embodiment of the present application, Offshoots means that a patch on the feature map obtains an offshoot distance in the X-axis and the Y-axis to find a new patch. The schematic diagram on the left side of FIG. 17A shows the offshoot effect of one patch. The white patch (the patch for example not filled with black) is shifted to the black patch (the patch for example filled with black) based on the offshoot distances Δx and Δy. When N patches are shifted to the region where the object is located, the object outline may be obtained according to these shifted patches, as shown by the visualization effect of Offshoots illustrated on the right side of FIG. 17A, where the patch filled with oblique lines represents a query vector, N white patches that are not filled with black are associated patches corresponding to the query vector before shifting, and the black patches that are filled with black are N associated patches corresponding to the query vector after shifting. It can be seen that the shifted associated patches are closer to the subject/object (the person who does long jump) in the video frame. The meaning of Offshoots may be expressed as:

$$Offshoots = ( Δ x , Δ y ) \qquad ( 3 )$$

In the formula (3), Δx and Δy represent two feature maps of the same size which are used for predicting the offshoots of the patch on the X-axis and Y-axis, for example, each patch corresponds to the offshoots in both the horizontal direction and the vertical direction. The Offshoots are mainly produced by the Q, K and V operations in the second part of the ADT structure. In the ADT module, two adjacent feature map will be operated simultaneously to generate Offshoots. If the set number of associated patches of each query patch is N, corresponding to the ADT structure shown in FIG. 15, the output of the 1*1 convolution is a feature map containing 4N channels, for example, the number of input channels of the 1*1 convolution operation is N, where the feature maps of first 2N channels (feature maps corresponding to each patch in the N patches on the X-axis and Y-axis) are offshoot feature maps corresponding to the current frames in two adjacent video frames, and the feature maps of last 2N channels are offshoot feature maps corresponding to the previous frames.

FIG. 17B shows a specific process of generating Offshoots of a feature map at the moment T. Four steps in the larger dashed box result in the generation of Offshoots. The generation process may include the following.

(1) The input is the feature map at the moment T after passing through the movement module, and the size of the feature map is assumed as 32*32*C, where C is the number of output channels of the movement module. For each patch of the video frame, N patches associated with this patch on the feature map output by the movement module are also shifted, and the coarse outline of the object is obtained according to the region formed by the N patches.

(2) This step corresponds to the step 1 in FIG. 17B. The feature map at the moment T output by the movement module is subjected to a specific convolution operation to obtain a new feature map Key with a size of 32*32*C. Each patch on the feature map Key obtains the global information in the input feature map. By this operation, N patches can clearly determine their own positions, thus assisting in generating more accurate offshoot subsequently and moving to a region for example fitter for the shape of the object.

(3) This step corresponds to the step 2 in FIG. 17B. The feature map Key at the moment T and the feature map Key at the moment T−1 are spliced. The spliced feature map is called a feature map Keys and has a size of 32*32*2C. This operation merges the spatial information at the moment T and the temporal information at the moment T−1. The process of obtaining the feature map Key at the moment T−1 is the same as the process of obtaining the feature map at the moment T.

(4) This step corresponds to the step 3 in FIG. 17B. The feature map Keys and one query patch on the feature map at the moment T are spliced to obtain a new feature map (Keys&Query) with a size of 32*32*3C. During feature splicing, if the size of the feature of each part to be spliced is not the same, the feature needs to be transposed into a feature map of the same size and then spliced.

By the operation in step 3, the query patch and the spatial-temporal information are merged, so that the leading role of the query patch is enhanced, the subsequent shifting of offshoots is performed about the query, and other patches related to the query patch are found.

(5) This step corresponds to the step 4 in FIG. 17B. The feature map Keys&Query is subjected to 1*1 convolution, and Offshoot with a size of 32*32*2N are output for predicting the offshoots of N patches corresponding to one query patch on the feature map at the moment T. The Offshoots corresponding to one video frame are composed of a feature map with a size of 32*32*2N, and the number of channels is 2N. The feature map of first N channels is called Δx with a size of 32*32*N and used for predicting the offshoots of N patches on the X-axis. The feature map of last N channels is called Δy with a size of 32*32*N and used for predicting the offshoots of N patches on the Y-axis.

In combination with the spatial global information obtained in the step (2) and the spatial-temporal information obtained in the step (3) and based on the Query information (feature map Keys&Query) obtained in the step (4), new offshoots are generated after the information fusion in the step (5). Since the offshoots obtain a larger receptive field and better information fusion, the offshoots can make patches shift to more accurate positions.

According to the process of generating Offshoots of the feature map at the moment T, it can be seen that the Offshoots can make patches generate new offshoots, thus assisting in finding other patches related to the query patch more accurately and obtaining more accurate object outline. The process of generating Offshoots of the feature map at the moment T−1 that can be simultaneously performed in the ADT results is similar that at the moment T, so more accurate relative information can be obtained. According to the spatial outline information and the temporal relative position information, the behavior object of the object can be better captured, the events in the video can be recognized more accurately, and a good recognition effect can be achieved even for a fast motion behavior.

The new feature map of each video frame extracted by the ADT network may be used as the input feature map of the AVT network, and fine feature extraction is performed by the AVT network.

In an embodiment of the AVT network, the AVT network provided in the embodiment of the present application is a network composed of AVTs. The network can extract the fine-grained outline and absolute position information of the object in the frame, so that the object can be recognized more accurately. For object recognition, if the attitude and position of the object are acquired more accurately, the accuracy of object recognition is higher. The AVT network can assist in obtaining the absolute position and fine-grained outline of the object in the frame.

FIG. 18 shows a schematic diagram of the visualization effect of an AVT network according to an embodiment of the present application. The input of the AVT network may be the feature map of each feature frame input by the ADT network. Of course, if the AI network does not use the ADT network, the input of the AVT network may also be the feature map of each video frame output by the image patch encoding module. During the AVT operation by the AVT network, the processing of each video frame needs to be based on the feature maps of this video frame and the preceding frame of this video frame. By taking the current video frame being the video frame at the moment T as an example, as shown in the effect diagram of FIG. 18, the AVT network may segment the rough outline and absolute position of the object in the vide frame by an object mask module (the wrap map T in FIG. 18), then perform an ADT operation in the rough outline range to further obtain the fine-grained outline and absolute position (the fine map T in FIG. 18), thereby improving the accuracy of object recognition.

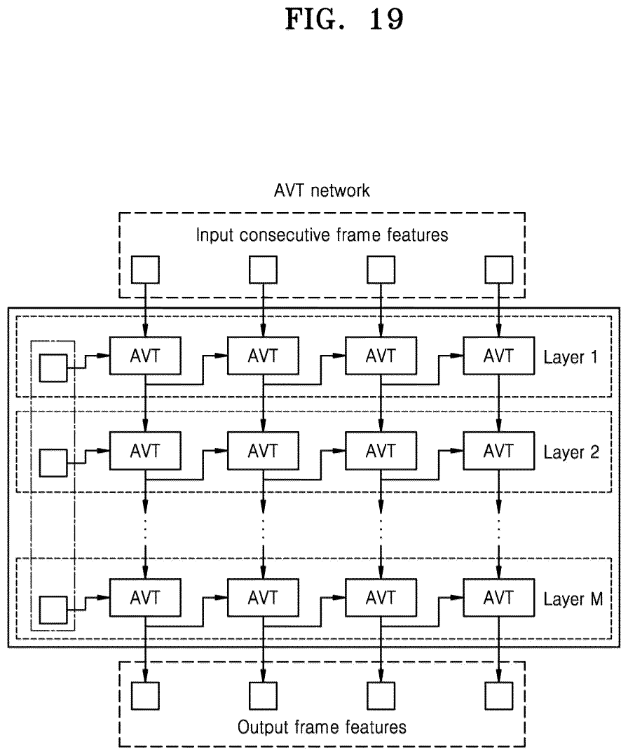

FIG. 19 shows a schematic diagram of an alternative network structure of the AVT network according to an embodiment of the present application. The feature processing principle in the AVT network will be described below with reference to the network structure shown in FIG. 19 and the visualization effect diagram shown in FIG. 18. As shown in FIG. 19, the AVT network may include multiple superimposed AVT modules. In the schematic diagram of FIG. 19, the AVT network includes M layers of AVT modules.

The input of the AVT network is the feature maps of consecutive frames after passing through the ADT network. During processing each frame feature map, it is necessary to use the feature map of the current frame and the result of the previous frame as the input. During processing the feature map of the first frame, the feature map of the previous frame may be a feature map with the same size value of 0. The feature map of each video frame is subjected to the AVT operation of M layers to output a new frame feature map. The processing process of the AVT network may include the following.

(1) The spatial-temporal information of the feature map of the current video frame is further exacted by the AVT module in the first layer, and the size of the output feature map may be changed. The calculation principle of the AVT module may be expressed as:

$${W}_{t} = Warp ( Mask ( Concat ( {X}_{t} , {X}_{t - 1} ) ) ) {X}_{output} = A D T ( {W}_{t} , {X}_{t - 1} ) + {X}_{t} \qquad ( 4 )$$

where Xₜ represents the feature map at the current moment T; Xₜ₋₁ represents the output result feature map of the previous frame of the current frame at the moment T−1, e.g., the feature map obtained by performing feature extraction on the feature map of the previous frame by the ADT module in the first layer; and, Xₒᵤₜₚᵤₜ represents the feature map at the current moment T output after one ADT operation, e.g., the output of the ADT module in the first layer corresponding to the current frame. Wrap(d) means that the feature map is filled with a feature value, and Mask(e) means that an object mask operation (Mask operation) is performed on the feature map e by the object mask module. The object mask module may include an image segmentation network and an activation function layer. ADT(f, m) means that the ADT operation is performed based on the feature map f and the feature m.

As shown in the formula (4), during processing the feature map by the AVT network, the Mask operation is added. For the object in the current frame at the moment T, the absolute position information of the object can be obtained by this operation. In an embodiment, the ADT operation may still be reserved in the AVT network, and the spatial-temporal information may be further extracted, so that the more fine-grained outline and position information of the object is obtained. (2) The AVT module in the second layer is continuously used to further extract the spatial-temporal information from the feature map of the current frame. The size of the output feature map is unchanged, and the calculation formula is shown by the above formula (4).

(3) By that analogy, after multiple layers of ADT operations, a new feature map of each frame is output. The size of the output remains unchanged.

FIG. 20A shows a schematic diagram of the network structure and feature extraction principle of an AVT module according to an embodiment of the present application. As shown in FIG. 20A, one AVT module may include an object mask module, a deformation module and an ADT module. The principle of the AVT module will be described below in detail with reference to FIG. 20A by taking the AVT module performing one AVT operation on the feature map of the video frame at a single moment T as an example. The calculation process of the AVT operation may include the following.

(1) By taking the video frame currently to be processed being the feature map of the video frame at the moment T as an example, the input of the first AVT operation on this video frame is the feature map T of this video frame output by the ADT network and the output feature map T−1 of the first AVT operation on the previous frame of this video frame. For each AVT operation except for the first AVT operation, the input is the output feature map T of the previous AVT operation on this video frame and the output feature map T−1 of the current AVT operation on the previous video frame of this video frame.

(2) The two feature maps (e.g., the feature map T and the feature map T−1) are spliced (e.g., concatenated) to obtain a new feature map. The new feature map represents the features of the current video frame.

As shown in FIG. 20A, it is assumed that the feature map of each video frame output by the ADT network is a feature map with a size of W*H*C, where W and H are the width and height of the feature map, and C is the number of output channels of the feature map output by the ADT network. The feature map T of the current frame at the moment T and the feature map T−1 of the previous frame of the current frame are spliced to obtain a feature map with a size of W*H*2C.

(3) The spliced feature map is input to the object mask module, and a mask feature map T of the current frame is output by this module.

By using the mask module, the approximate outline and absolute position information of the object in the video frame can be obtained. The specific neural network structure of the mask network will not be uniquely limited in the embodiment of the present application. In an embodiment, the object mask module may include multiple layers of trained convolution and activation functions (e.g., Sigmoid functions). The object mask network is a segmentation network. If Fᵢₙ represents the input of the object mask module, the output Four of the object mask module may be expressed as:

Fₒᵤₜ=Sigmoid(H_{conv}(Fᵢₙ))
where Fᵢₙ is the feature map obtained after splicing the feature map T and the feature map T−1, and as shown in FIG. 20A, the input of the object mask module is the feature map with a size of W*H*2C; H_{conv}(.) represents the multi-layer convolution operation; and Sigmoid(.) represents the sigmoid operation. A mask feature map T (or called a shade feature map, shade map or mask map) with the rough outline and absolute position of the object is generated after the object mask operation. The mask feature map is a binary feature map, for example, the mask map T with a size of W*H and the number of channels of 1 as shown in FIG. 20A, the size is w*H. there are only values of 0 and 1 on this feature map. The region with a numerical value of 1 in the mask feature map represents the region where the object is located, and the region with a numerical value of 0 represents no object. By the segmentation network, the absolute position and rough outline of the object in the frame at the moment T can be obtained.

(4) This step is used to fill a feature value in the region with a numerical value of 1 in the mask feature map T. The filled numerical value may come from the feature map T in the step (1). By feature value filling, a warp feature map T (which may also be called an explicit feature map, explicit map or warp map) corresponding to the video frame at the moment T that only contains the segmented object region is obtained.

As shown FIG. 20A, this step may be implemented by a deformation module. This module may process the feature map of each channel in the feature map T with a size of W*H*C based on the mask map T. The processing result is a display feature map T with a size of W*H*C finally obtained by reserving the feature value of each feature point in the feature map of each channel corresponding to each position with a numerical value of 1 in the mask feature map T and removing the feature value of each feature point corresponding to each position with a numerical value of 1 in the mask feature map. In this feature map, only the feature value of the region containing the object in the feature map T of the current frame is reversed, while the feature values of other regions are 0. The approximate outline of the object in the video can be seen from the warp feature map T.

By the deformation operation, the feature value is filled to the rough outline region of the mask map T, so that the warp feature map T containing semantic information such as color and attitude is obtained.

(5) The explicit feature map T obtained in the step (4) and the input feature map T−1 in the step (1) are input to the ADT module, and a fine feature map T is output. Here, the operation of the ADT module is the same as the principle of the ADT module in the ADT network, except that the input of the feature map at the moment Tis different. This ADT module further calculates the object outline in the segmented object region to obtain the fine-grained object outline and absolute position.

The input of the ADT operation in the AVT module has interaction in both spatial and temporal during the ADT operation. The spatial interaction is directed to the warp map T, and the temporal interaction is directed to the warp map T and the feature map T−1. As an example, FIG. 20B shows an effect diagram of the ADT operation in an AVT module in terms of spatial interaction. As shown in FIG. 20B, the spatial interaction is performed in the rough outline region of the warp map T to generate a fine feature map T containing the fine-grained outline and absolute position information of the object, as shown by the fine map T in FIG. 20B.

(6) The fine feature map T obtained in the step (5) and the input feature map T in the step (1) are added to obtain the final output of the current AVT operation.

The above steps show one AVT operation of a single frame, and all other video frames in the video shall be subjected to the above operation. The AVT operation can assist in obtaining the fine-grained outline and absolute position of the object and better recognizing the object.

In an embodiment of the behavior object determination module, the behavior object determination module is mainly configured to screen behavior objects and score the quality of behavior objects. FIG. 21 shows a principle diagram of a behavior object determination module according to an embodiment of the present application. As shown in FIG. 21, the input of this module includes the feature map of each video frame output by the AVT network and the object feature map output by the deformation module of the AVT module in the last layer in the AVT network. For each video frame, the processing process of this module may include the following.

(1) A rectangular feature map fit for the object is clipped from the warp feature map. This rectangle shall contain the feature value region where the whole object is located and is fit for the feature value region. Specifically, the rectangular feature map may be the minimum bounding rectangle of the region containing all non-zero pixel values in the explicit feature map.

(2) The feature map of the video frame and the rectangular feature map are fused to obtain an object vector. In an embodiment, the rectangular feature map may be adjusted in size and stretched to a vector with a fixed length. The frame feature map is also adjusted in size and stretched to a vector with the same fixed length. Then, the two feature vectors with the same length are spliced to form an object vector.

(3) The object vector obtained in the step (2) is input to the behavior object determination module. This module is composed of the trained classification network, and gives a score (The behavior score in FIG. 21) for each object vector to determine whether the object vector is a behavior object vector, for example, whether this object has a preset behavior. The preset behavior may be predefined. For example, the preset behave may include shooting, blinking, jumping, etc. Only the object vector with a score exceeding a certain score threshold is determined as a behavior object vector and enters the subsequent calculation.

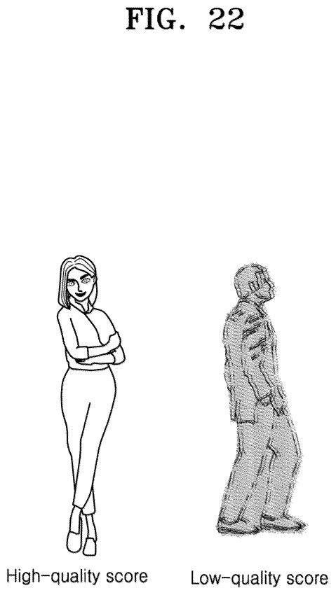

(4) The object vector determined as the behavior object vector will be input to the object/subject quality recognition module. This module is composed of the trained classification network, and gives a quality score (the quality score in FIG. 21) for each behavior object vector. For example, the quality of the behavior object vector may be determined according to whether the object faces front, whether the pixels are high, whether the human face is clear, or other quality contents. If the object has a frontal face, high pixels and clear surface, the quality score is high; and, if the target has not frontal face, low pixels and unclear human face, the quality score is low. The object vector shown on the left side of FIG. 22 is a behavior object vector with a high quality score. The object vector shown the right side of FIG. 22 is a behavior object vector with a low quality score.

As shown in FIG. 21, the behavior object determination module may output the behavior object vector with a quality score corresponding to each video frame in the video to be processed.

In an embodiment of the CCT network, the CCT network provided in the embodiment of the present application is a network composed of context contrast transformers (CCTs). For object recognition, the object can know more about itself in multiple angles and multiple scenes, and the accuracy of object recognition is high. The CCT network can allow the behavior object to obtain its own multi-angle and multi-scene semantic information and can assist in better recognizing the object.

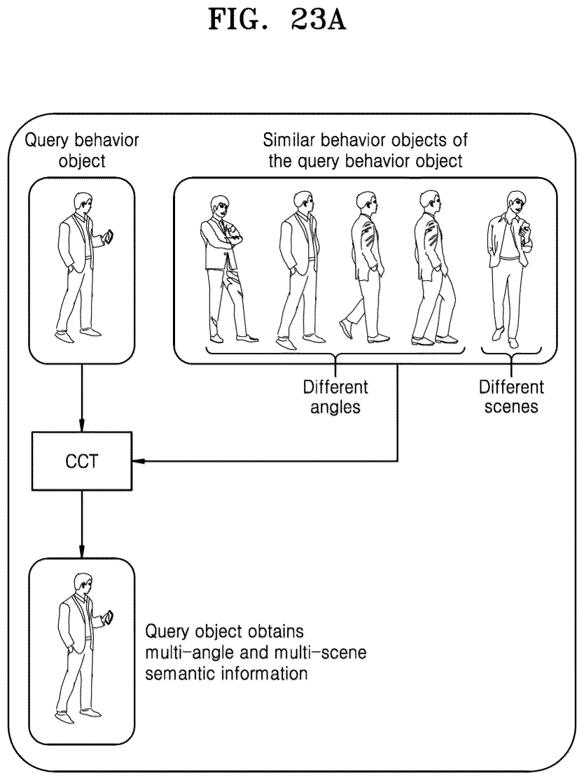

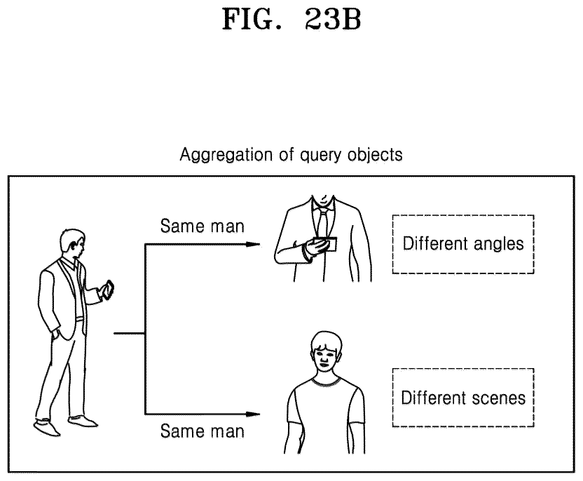

By the efficient information interaction function of the CCT network, each behavior object (query behavior object) can perform information interaction with its similar objects (similar behavior objects), thereby assisting the behavior object in obtaining its multi-angle and multi-scene information from similar objects and improving the accuracy of object recognition. As shown in the schematic diagram of FIG. 23A, by allowing a man wearing a shirt to perform a CCT operation with the same man wearing a shirt from different angles and allowing the man to perform a CCT operation with the same man wearing a suit in different scenes, this man can obtain his own multi-angle and multi-scene information, thereby recognizing the behavior object more accurately.

In the CCT network, the same behavior object may be aggregated to realize the information interaction of the same object in multiple scenes and multiple angles. As shown in FIG. 23B, the man on the left (the behavior object vector corresponding to the video frame where the main is located) is used as a query object. Since the query body has learned scene information when he was wearing a suit, when he encounters an object that wears the same suit and has a similar frontal face, the two objects will be aggregated and considered to be the same man. Since the query object has learned different angles of himself in the shirt, when he encounters an object that wears the same shirt and has a similar lower face, the two objects will be aggregated and considered to be the same man.

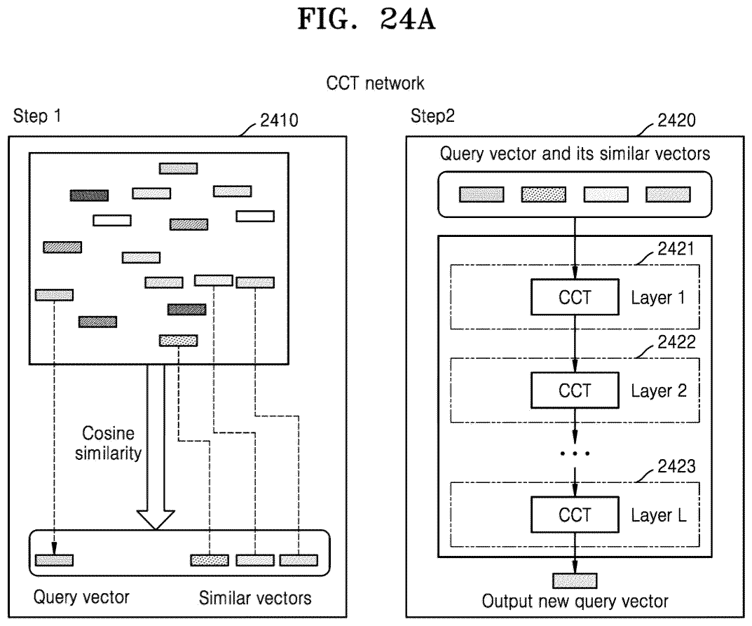

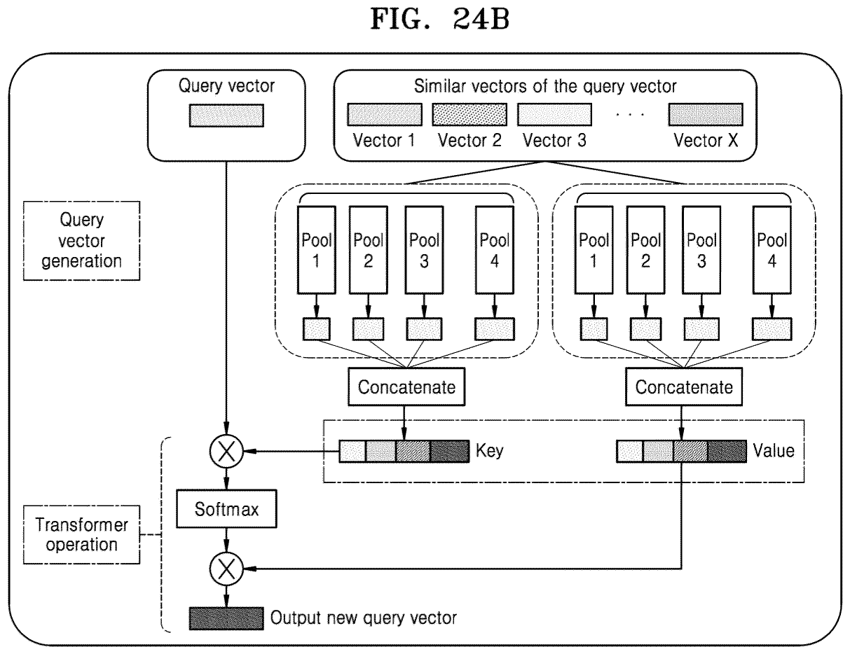

FIG. 24A shows a principle diagram of a CCT network according to an embodiment of the present application. As shown in the step 2 2420 in FIG. 24A, the CCT network is mainly composed of multiple superimposed CCT modules (multiple layers of CCT shown). FIG. 24A shows L CCT modules. By the multiple layers of CCT modules, the interaction of the semantic information may be realized from shallow to deep between behavior object vectors of the same object. The step 1 2410 in FIG. 24A is a pre-step before the CCT network operation. As shown in FIG. 24A, the specific implementation process of the steps 1 2410 and 2 2420 may include the following.

(1) Among all behavior object vectors in one video output by the behavior object determination module, a behavior object vector is selected as a query vector. K vectors most similar to the query vector may be found from other behavior object vectors in the video. For example, K vectors (similar objects in FIG. 24A) most similar to the query vector may be found by calculating the cosine similarity between vectors.

The cosine similarity may be defined by a very high similarity threshold, so the objects in each video frame corresponding to the query vector and the found K similar vectors of this vector may be considered to be the same object.

(2) The query vector and the K similar objects are input to the CCT network. The CCT module in layer 1 2421 (first layer) realizes information interaction between the query vector and the K similar vectors, and outputs a new query vector. The size of the output new query vector is unchanged. As an embodiment, the specific calculation principle of the CCT module may be expressed as:

$${X}_{a} = {Pool}_{1} ( Concat ( {X}_{1} , {X}_{2} , … , {X}_{k} ) ) {X}_{b} = {Pool}_{2} ( Concat ( {X}_{1} , {X}_{2} , … , {X}_{k} ) ) {X}_{c} = {Pool}_{3} ( Concat ( {X}_{1} , {X}_{2} , … , {X}_{k} ) ) {X}_{d} = {Pool}_{4} ( Concat ( {X}_{1} , {X}_{2} , … , {{X}_{k}}_{k} ) ) K = Concat ( {X}_{a} , {X}_{b} , {X}_{c} , {X}_{d} ) V = Concat ( {X}_{a} , {x}_{b} , {X}_{c} , {X}_{d} ) {X}_{o utput} = Softmax ( {X}_{q} \times K ) \times V \qquad ( 5 )$$

where X_{q} represents the input query vector; X₁, X₂, . . . , Xₓ are K vectors similar to the input query vector; Concat represents the feature splicing operation; and Pool₁, Pool₂, Pool₃ and Pool₄ represent 4 vectors output by the convolution operation using 4 different convolution kernels, for example, 4 vectors with different lengths. Softmax represents the activation function, and Xₒᵤₜₚᵤₜ is the output new query vector.

As shown in the formula (5), for the processing of one query vector, this query vector and K vectors similar to this vector may be input to the CCT, and information interaction is performed between this query vector and the K similar vectors. Since the objects in the video corresponding to the query vector and the K similar vectors may be considered to be the same object, the query vector may learn its multi-scene and multi-angle semantic information from the K similar vectors.

(3) The new query vector and K similar vectors output by the CCT module in the layer 1 2421 are used as the input of the CCT module in the layer 2 2422, and the CCT module in the layer 2 2422 outputs a new query vector. The size of the output vector is unchanged, and the calculation principle is shown by the above formula (5).

(4) By that analogy, after the CCT operation in the layer L 2423, a new query vector with unchanged size is output. The query vector output by the CCT module in the last layer is the output vector obtained after processing the input query vector by the CCT network.

Each behavior object vector recognized by the behavior object determination module should be processed as a query vector in the steps 1-4 until each behavior object vector completes the CCT operation to obtain a new feature vector corresponding to each behavior object vector.

The CCT module provided in the embodiment of the present application is a new transformer structure. The CCT module adds the splicing and pooling operations (the pool operation in the formula (5)) on multiple input vectors based on the conventional transformer structure. Thus, the calculation amount is saved, and the query vector learns the multi-angle and multi-scene semantic information from other input vectors.

FIG. 24B shows a principle diagram of a calculation process of performing a CCT operation on a single query vector according to an embodiment of the present application. As shown in FIG. 24B, the calculation process may include the following.

(1) The query vector and K similar vectors found by the cosine similarity are input.

(2) The K vectors are spliced and then pooled by 4 convolution kernels with different lengths to obtain 4 vectors with different lengths.

(3) The 4 vectors with different lengths output in the step (2) are spliced to obtain a new vector, which is called Key (query vector).

(4) The process of acquiring Value (value vector) is the same as the process of acquiring Key, and the Value may be obtained by repeating the steps 2 and 3. It is to be noted that, the network parameter of the convolution kernel for acquiring Value and the network parameter of the convolution kernel for acquiring Key may be the same or different. For example, the Value and Key corresponding to one query vector may be the same vector or different vectors.

(5) The Key and the query vector are dot-multiplied, then pass through the Softmax layer and are then multiplied with the Value to obtain a new query vector.

In an embodiment of the post-processing, all behavior object vectors output by the CCT network may be post-processed by two modules. The two modules are a behavior object aggregation module and an event confirmation module, respectively. The final behavior objects and events generated by post-processing are displayed to the user.

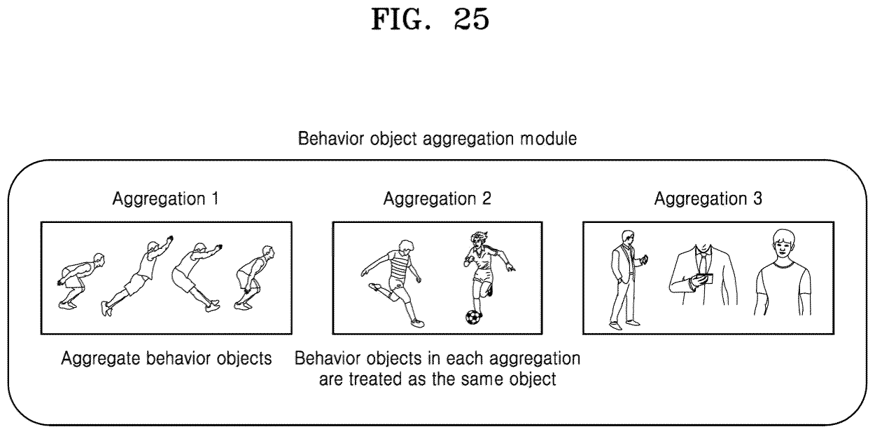

The behavior object aggregation module is mainly configured to aggregate all behavior object vectors (e.g., behavior object features), for example, performing vector aggregation by graph propagation. Similar objects are aggregated as a cluster, and the objects in each cluster will be considered to be the same object. Multiple different objects may form multiple clusters, as shown in the visualization effect diagram of FIG. 25. By aggregating all behavior object vectors, three aggregation results are obtained. The behavior objects output by the behavior object aggregation module may have its own aggregation tag.

The event confirmation module functions to allow all behavior object vectors in the same aggregation to find the corresponding video frames and then generate event clips of the behavior objects corresponding to this aggregation based on these frames. In an embodiment, for all video frames corresponding to the same aggregation, according to the size of the behavior objects in the video frames, rectangular box regions fit for the behavior objects are clipped as new video frames from the video frames, and more than two consecutive rectangular video frames form an event clip. If the distance between video frames exceeds a certain distance, it is considered that the video frames are not consecutive, and a single inconsecutive video frame will be discarded. The events in the same aggregation can be obtained by the above processing. The behavior object in the video frame corresponding to the behavior object vector with the highest quality score in one aggregation and the events in the aggregation to which this vector belongs may be used as a behavior object and events related to this behavior object.

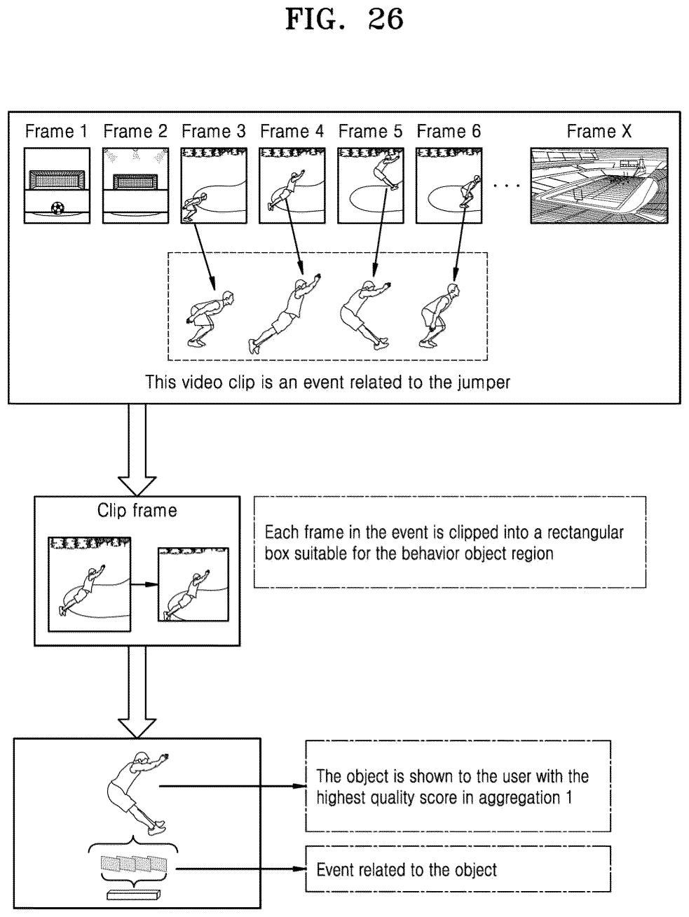

As shown in the schematic diagram of FIG. 26, each video frame in the video to be processed corresponding to all behavior object vectors in one aggregation includes the shown frames 3 to 6. The behavior object region in each frame may be clipped according to the shape of the behavior object in each frame among the four frames (e.g., the object shape in the explicit feature map of each frame output by the last AVT layer of the AVT network), and event clips of the behavior objects corresponding to this aggregation are obtained based on the consecutive frames in the clipped frames.

The behavior object with the highest quality score in each aggregation and the events in this aggregation are found, so that the behavior object and relevant events to be recommended to the user are determined. In an embodiment, the behavior objects corresponding to each aggregation may be displayed to the user, the user may select a behavior object of interest, and this selected object and its relevant events will be displayed to the user.

Of course, it is also possible to adopt the post-processing mode in the above alternative embodiment 2. After each aggregation is obtained by the behavior object aggregation module and the video frames corresponding to all behavior object vectors in each aggregation are found, the pixel values of the regions except for the region where the behavior object is located in each video frame are removed, and event clips of the behavior objects corresponding to each aggregation are generated based on each video frame corresponding to each aggregation in which the pixel values in the non-object region are removed.

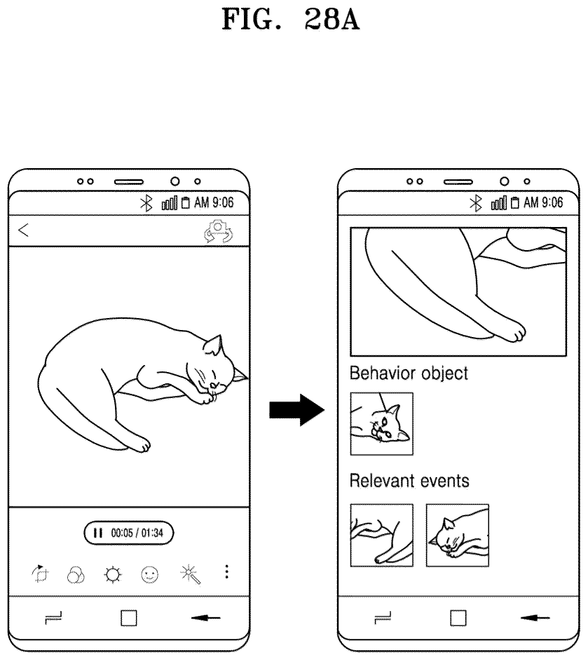

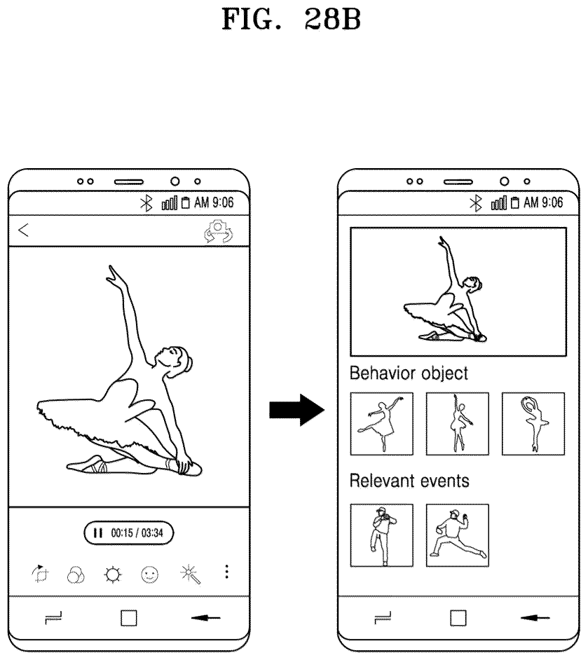

The specific way of displaying at least one of the behavior objects or event clips in the video to the user will not be limited in the present application and may be configured according to actual application requirements and application scenarios. As two examples, FIGS. 28A and 28B show schematic diagrams of two user interfaces. As shown in FIG. 28A, the video in this example contains the content related to a cat. When the user watches this video on a mobile phone, the user may long-press on any region of a video frame containing the cat or long-press on the cat in the video. At this time, in response to the user's operation, the tag of the cat and the related event clip may be displayed to the user, as shown in the user interface on the right side of FIG. 28A. The behavior object may be the cat in an image with the highest object score in the event clip, and the relevant event is two event clips of the cat in the video. The video shown in FIG. 28B is a video related to a person. While watching the video, the user may long-press, or slide or do other specific operations in a specific direction in the video. In response to the user's operation, the tags of multiple behavior objects in the video may be displayed to the user. It is also possible to display the relevant event of at least one behavior object. For example, the related information of the event clip of the behavior object in the video frame where the user's operation is performed is displayed. In an embodiment, the user may also select a behavior object of interest from a tag list of behavior objects. According to the user's selection, the relevant event of the behavior object selected by the user may be displayed to the user. For example, the solution provided in the embodiment of the present application can also support the handover between behavior objects.

The present application provides an event recognition method based on deep learning. If a video is given, event clips in the video can be recognized by this method; or, a behavior object in the video can be recognized and segmented, and event clips related to this behavior object are recorded. The solutions provided in the embodiments of the present application can have at least the following beneficial effects.

(1) The solutions provided in the embodiments of the present application can recognize the events in the video accurately, and can also recognize fast motion behaviors accurately. For example, the solutions can be implemented by the ADT network provided in the embodiments of the present application.

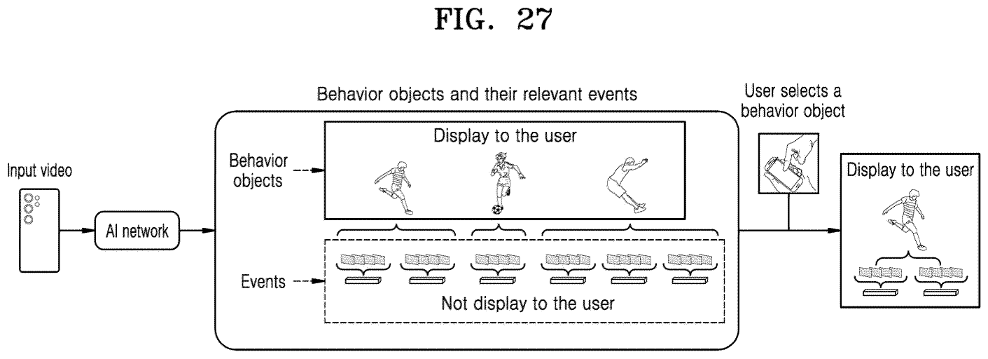

(2) The solutions provided in the embodiments of the present application can recognize the behavior objects and the events related to the behavior objects in the video accurately. For example, the accurate recognition of behavior objects and their associated events is implemented by the AVT network and the CCT network provided in the embodiments of the present application. Thus, the user's demand in finding the relevant events of the user-specified object in the video can be satisfied. As shown in FIG. 27, the user inputs a video, and behavior objects and their relevant events in this video can be generated by the AI network provided in the embodiments of the present application. In this schematic diagram, three behavior objects in the video are recognized. Some behavior objects have one event clip, while some behavior objects have two event clips. In an embodiment, each recognized behavior object (e.g., the sub-map containing this object in the video frame corresponding to the vector with the highest score in the aggregation result corresponding to this object or the video frame with background removed) may be displayed to the user, the user may select an object of interest, and the specific object selected by the user and its relevant event may be provided to the user.

In an embodiment, by using the feature extraction network composed of ADT and AVT provided in the embodiments of the present application, the recognition rate of behaviors in the video can be improved. Especially, the recognition effect on fast motion behaviors is very good. The neural network structure in the AI network provided in the embodiments of the present application can be trained based on a public training set (e.g., ImageNet-21K data set) or other training sets. Tests show that, compared with the related art, the recognition accuracy of the AI network provided by the present application is obviously improved, the number of model parameters of the AI network can be decreased, the calculation amount can also be reduced effectively, and it is easier to deploy in mobile terminals and reduce the problems of fever and jamming of mobile phones. Therefore, the actual application requirements can be better satisfied. In addition, the CCT network provided in the embodiments of the present application can select an object (similar vector) from the dimension of the whole video for information interaction, and improve the accuracy of object recognition. Compared with using the conventional transformer mechanism for information interaction, the calculation amount can be effectively reduced, and the processing efficiency can be improved.

The embodiments of the present application further comprise an electronic device comprising a processor and, optionally, a transceiver and/or memory coupled to the processor configured to perform the steps of the method provided in any of the optional embodiments of the present application.

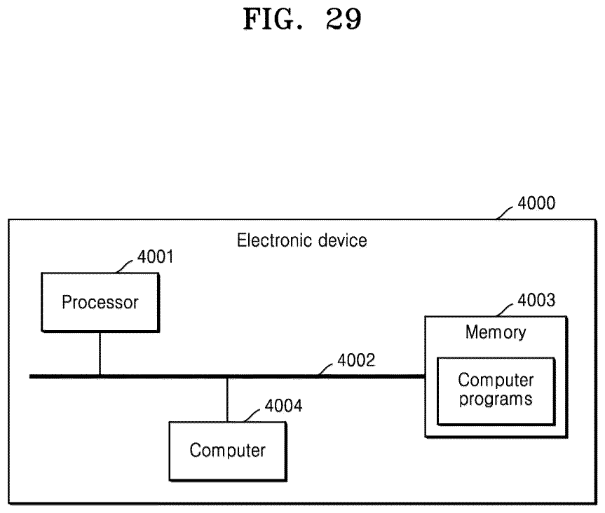

FIG. 29 shows a schematic structure diagram of an electronic device, in an example embodiment. As shown in FIG. 29, the electronic device 4000 shown in FIG. 29 may include a processor 4001, and may further include a memory 4003. The processor 4001 is connected to the memory 4003, for example, through a bus 4002. Optionally, the electronic device 4000 may further include a transceiver 4004, and the transceiver 4004 may be used for data interaction between the electronic device and other electronic devices, such as data transmission and/or data reception. It should be noted that, in practical applications, the transceiver 4004 is not limited to one, and the structure of the electronic device 4000 does not constitute a limitation to the embodiments of the present application. Optionally, the electronic device may be a first network node, a second network node or a third network node.

The processor 4001 may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components, or any combination thereof. It may implement or execute the various exemplary logical blocks, modules and circuits described in connection with this application. The processor 4001 can also be a combination that implements computing functions, such as a combination of one or more microprocessors, a combination of a DSP and a microprocessor, and the like.

The bus 4002 may include a path to transfer information between the components described above. The bus 4002 may be a PCI (Peripheral Component Interconnect) bus or an EISA (Extended Industry Standard Architecture) bus or the like. The bus 4002 can be divided into an address bus, a data bus, a control bus, and the like. For ease of representation, only one thick line is shown in FIG. 29, but it does not mean that there is only one bus or one type of bus.

The memory 4003 may be a ROM (Read Only Memory) or other types of static storage devices that can store static information and instructions, a RAM (Random Access Memory) or other types of dynamic storage devices that can store information and instructions, and can also be EEPROM (Electrically Erasable Programmable Read Only Memory), CD-ROM (Compact Disc Read Only Memory) or other optical disk storage, compact disk storage (including compressed compact disc, laser disc, compact disc, digital versatile disc, blue-ray disc, etc.), magnetic disk storage media, other magnetic storage devices, or any other medium capable of carrying or storing computer programs and capable of being read by a computer, without limitation. An example of a ROM is a non-transitive memory.

The memory 4003 is used for storing computer programs for executing the embodiments of the present application, and the execution is controlled by the processor 4001. The processor 4001 is configured to execute the computer programs stored in the memory 4003 to implement the steps shown in the foregoing method embodiments.

Embodiments of the present application provide a computer-readable storage medium having a computer program stored on the computer-readable storage medium, the computer program, when executed by a processor, implements the steps and corresponding contents of the foregoing method embodiments.

Embodiments of the present application also provide a computer program product including a computer program, the computer program when executed by a processor realizing the steps and corresponding contents of the preceding method embodiments.

The terms “first”, “second”, “third”, “fourth”, “1”, “2”, etc. (if present) in the specification and claims of this application and the accompanying drawings above are used to distinguish similar objects and need not be used to describe a particular order or sequence. It should be understood that the data so used is interchangeable where appropriate so that embodiments of the present application described herein can be implemented in an order other than that illustrated or described in the text.

It should be understood that, although various operational steps are indicated by arrows in the flowcharts of embodiments of the present application, the order in which the steps are performed is not limited to the order indicated by the arrows. Unless explicitly stated herein, in some implementation scenarios of embodiments of the present application, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the present application are not limited thereto.

The above text and accompanying drawings are provided as examples only to assist the reader in understanding the present application. They are not intended and should not be construed as limiting the scope of the present application in any way. Although certain embodiments and examples have been provided, based on what is disclosed herein, it will be apparent to those skilled in the art that the embodiments and examples shown may be altered without departing from the scope of the present application. Employing other similar means of implementation based on the technical ideas of the present application also fall within the scope of protection of embodiments of the present application.

According to an embodiment of the disclosure, a method may include extracting semantic features of the video, the semantic features comprising semantic features in each frame to be processed, the semantic features in each frame comprising spatial semantic features and temporal semantic features. According to an embodiment of the disclosure, the method may include determining, based on the semantic features, the behavior objects and the relevant events in the video.

According to an embodiment of the disclosure, a method may include for each frame, extracting, based on a convolution module, a first semantic feature of the frame and a second semantic feature of an adjacent frame. According to an embodiment of the disclosure, the method may include determining, based on the first semantic feature and the second semantic feature, first semantically related patches in the frame and second semantically related patches in the adjacent frame. According to an embodiment of the disclosure, the method may include extracting, from the first semantically related patches in the frame, first spatial semantic features of objects in the frame. According to an embodiment of the disclosure, the method may include extracting, from the second semantically related patches in the adjacent frame, first temporal semantic features of objects in the frame. According to an embodiment of the disclosure, the method may include fusing the first spatial semantic features and the first temporal semantic features to obtain the semantic features of the frame.

According to an embodiment of the disclosure, a method may include performing convolution on the frame by using a first convolution layer. According to an embodiment of the disclosure, the method may include spatially rearranging features of each channel from among features extracted by the first convolution layer. According to an embodiment of the disclosure, the method may include performing convolution on the rearranged features by a second convolution layer. According to an embodiment of the disclosure, the method may include performing channel rearrangement on features of each space in features extracted by the second convolution layer to obtain semantic features of the frame.

According to an embodiment of the disclosure, a method may include fusing the first semantic feature and the second semantic feature to obtain a first fused feature. According to an embodiment of the disclosure, the method may include determining, based on the first fused feature and in the frame and the adjacent frame, spatial position offshoot information of other patches semantically related to each patch in the frame relative to the patch, respectively. According to an embodiment of the disclosure, the method may include determining, based on the spatial position offshoot information, the first semantically related patches in the frame and the second semantically related patches in the adjacent frame.

According to an embodiment of the disclosure, a method may include determining, based on the semantic features of each frame and using an object mask module, a region where an object in each frame is located. According to an embodiment of the disclosure, the method may include determining, based on the semantic features of the frame and the region where the object in the frame is located, region features of the region where the object in the frame is located. According to an embodiment of the disclosure, the method may include determining, based on the region features of the region where the object in each frame is located, the behavior objects and the relevant events in the video.

According to an embodiment of the disclosure, a method may include for each frame, fusing a first semantic features of the frame and a second semantic features of the adjacent frame to obtain a first fused features. According to an embodiment of the disclosure, the method may include performing an object segmentation on the first fused features by using the object mask module to obtain the region where the object in the frame is located.

According to an embodiment of the disclosure, a method may include for the frame, obtaining object features corresponding to the frame based on the region features of the region where the object in the frame is located. According to an embodiment of the disclosure, the method may include determining, based on the object features and using an object recognition model. According to an embodiment of the disclosure, the method may include whether the behavior objects are contained in the frame. According to an embodiment of the disclosure, the method may include obtaining the behavior objects and the relevant events in the video based on behavior object features, wherein the behavior object features are object features of frames containing the behavior objects.

According to an embodiment of the disclosure, a method may include fusing the region features of the region where the object in the frame is located and the semantic features of the frame to obtain target features of the frame. According to an embodiment of the disclosure, the method may include fusing the target features of the frame and the region features of the region where the object in the frame is located to obtain the object features of the frame.

According to an embodiment of the disclosure, a method may include fusing the region features of the region where the object in the frame is located and the semantic features of the adjacent frame. According to an embodiment of the disclosure, the method may include extracting, from the region where the object in the frame is located, target region features of the object in the frame. According to an embodiment of the disclosure, the method may include fusing the target region features and the semantic features of the frame to obtain the target features of the frame.

According to an embodiment of the disclosure, a method may include aggregating the behavior objects features to obtain at least one aggregation result. According to an embodiment of the disclosure, the method may include obtaining, based on each frame corresponding to the at least one aggregation result, the behavior objects and the relevant events corresponding to the at least one aggregation result.

According to an embodiment of the disclosure, a method may include for each behavior object feature, determining at least one similar object feature of the behavior object feature from the object features. According to an embodiment of the disclosure, the method may include extracting second fused features of the behavior objects based on the behavior object features and the at least one similar object feature. According to an embodiment of the disclosure, the method may include aggregating the second fused features corresponding to the behavior object features.

According to an embodiment of the disclosure, a method may include fusing each similar object feature of the behavior object features to obtain third fused features. According to an embodiment of the disclosure, the method may include performing feature extraction on the third fused features in at least two different feature extraction modes to obtain at least two fused object feature. According to an embodiment of the disclosure, the method may include obtaining a weight corresponding to each fused object features based on a correlation between the behavior object features and each fused object feature. According to an embodiment of the disclosure, the method may include performing weighted fusion on the fused object features by using the weight corresponding to each fused object feature to obtain the second fused features of the behavior objects.

According to an embodiment of the disclosure, a method may include for the aggregation result, determining, based on the behavior object feature in the aggregation result, the quality of the behavior object in the frame corresponding to the behavior object feature. According to an embodiment of the disclosure, the method may include determining the behavior object in the video based on the quality of the behavior object in the frame corresponding to the aggregation result. According to an embodiment of the disclosure, the method may include determining relevant events of the behavior object based on each frame corresponding to the aggregation result.

According to an embodiment of the disclosure, a method may include removing a background in each frame corresponding to the aggregation result, and obtaining relevant events based on each frame with the background removed. According to an embodiment of the disclosure, the method may include clipping each frame based on an object region in each frame corresponding to the aggregation result, and the obtaining relevant events based on each clipped frame.

According to an embodiment of the disclosure, the at least one processor may be further configured to extract semantic features of the video, the semantic features comprising semantic features in each frame to be processed, the semantic features in each frame comprising spatial semantic features and temporal semantic features. According to an embodiment of the disclosure, the at least one processor may be further configured to determine, based on the extracted semantic features, the behavior objects and the relevant events in the video.

According to an embodiment of the disclosure, the at least one processor may be configured for each frame, to extract, based on a convolution module, a first semantic feature of the frame and a second semantic feature of an adjacent frame. According to an embodiment of the disclosure, the at least one processor may be further configured to determine, based on the first semantic feature and the second semantic feature, first semantically related patches in the frame and second semantically related patches in the adjacent frame. According to an embodiment of the disclosure, the at least one processor may be further configured to extract, from the first semantically related patches in the frame, first spatial semantic features of objects in the frame. According to an embodiment of the disclosure, the at least one processor may be further configured to extract, from the second semantically related patches in the adjacent frame, first temporal semantic features of objects in the frame. According to an embodiment of the disclosure, the at least one processor may be further configured to fuse the first spatial semantic features and the first temporal semantic features to obtain the semantic features of the frame.

According to an embodiment of the disclosure, the at least one processor may be further configured to perform convolution on the frame by using a first convolution layer. According to an embodiment of the disclosure, the at least one processor may be further configured to spatially rearrange features of each channel from among features extracted by the first convolution layer. According to an embodiment of the disclosure, the at least one processor may be further configured to perform convolution on the rearranged features by a second convolution layer. According to an embodiment of the disclosure, the at least one processor may be further configured to perform channel rearrangement on features of each space in features extracted by the second convolution layer to obtain semantic features of the frame.

According to an embodiment of the disclosure, the at least one processor may be further configured to fuse the first semantic feature and the second semantic feature to obtain a first fused feature. According to an embodiment of the disclosure, the at least one processor may be further configured to determine, based on the semantic features of each frame and using an object mask module, a region where an object in each frame is located. According to an embodiment of the disclosure, the at least one processor may be further configured to determine, based on the semantic features of the frame and the region where the object in the frame is located, region features of the region where the object in the frame is located. According to an embodiment of the disclosure, the at least one processor may be further configured to determine, based on the region features of the region where the object in each frame is located, the behavior objects and the relevant events in the video.

According to an embodiment of the disclosure, the at least one processor may be further configured to for each frame, fuse a first semantic features of the frame and a second semantic features of the adjacent frame to obtain a first fused features. According to an embodiment of the disclosure, the at least one processor may be further configured to perform an object segmentation on the first fused features by using the object mask module to obtain the region where the object in the frame is located.

According to an embodiment of the disclosure, the at least one processor may be further configured to for the frame, obtain object features corresponding to the frame based on the region features of the region where the object in the frame is located. According to an embodiment of the disclosure, the at least one processor may be further configured to determine, based on the object features and using an object recognition model, whether the behavior objects are contained in the frame. According to an embodiment of the disclosure, the at least one processor may be further configured to obtain the behavior objects and the relevant events in the video based on behavior object features, wherein the behavior object features are object features of frames containing the behavior objects.

According to an embodiment of the disclosure, the at least one processor may be further configured to fuse the region features of the region where the object in the frame is located and the semantic features of the frame to obtain target features of the frame. According to an embodiment of the disclosure, the at least one processor may be further configured to fuse the target features of the frame and the region features of the region where the object in the frame is located to obtain the object features of the frame.

According to an embodiment of the disclosure, the at least one processor may be further configured to fuse the region features of the region where the object in the frame is located and the semantic features of the adjacent frame. According to an embodiment of the disclosure, the at least one processor may be further configured to extract, from the region where the object in the frame is located, target region features of the object in the frame. According to an embodiment of the disclosure, the at least one processor may be further configured to fuse the target region features and the semantic features of the frame to obtain the target features of the frame.

According to an embodiment of the disclosure, the at least one processor may be further configured to aggregate the behavior objects features to obtain at least one aggregation result. According to an embodiment of the disclosure, the at least one processor may be further configured to obtain, based on each frame corresponding to the at least one aggregation result, the behavior objects and the relevant events corresponding to the at least one aggregation result.

According to an embodiment of the disclosure, the at least one processor may be further configured to for each behavior object feature, determine at least one similar object feature of the behavior object feature from the object features. According to an embodiment of the disclosure, the at least one processor may be further configured to extract second fused features of the behavior objects based on the behavior object features and the at least one similar object feature. According to an embodiment of the disclosure, the at least one processor may be further configured to aggregate the second fused features corresponding to the behavior object features.

According to an embodiment of the disclosure, the at least one processor may be further configured to fuse each similar object feature of the behavior object features to obtain third fused features. According to an embodiment of the disclosure, the at least one processor may be further configured to perform feature extraction on the third fused features in at least two different feature extraction modes to obtain at least two fused object features. According to an embodiment of the disclosure, the at least one processor may be further configured to obtain a weight corresponding to each fused object features based on a correlation between the behavior object features and each fused object feature. According to an embodiment of the disclosure, the at least one processor may be further configured to perform weighted fusion on the fused object features by using the weight corresponding to each fused object feature to obtain the second fused features of the behavior objects.

According to an embodiment of the disclosure, the at least one processor may be further configured to for the aggregation result, determine, based on the behavior object feature in the aggregation result, the quality of the behavior object in the frame corresponding to the behavior object feature. According to an embodiment of the disclosure, the at least one processor may be further configured to determine the behavior object in the video based on the quality of the behavior object in the frame corresponding to the aggregation result. According to an embodiment of the disclosure, the at least one processor may be further configured to determine relevant events of the behavior object based on each frame corresponding to the aggregation result.

According to an embodiment of the disclosure, the at least one processor may be further configured to remove a background in each frame corresponding to the aggregation result, and obtaining relevant events based on each frame with the background removed. According to an embodiment of the disclosure, the at least one processor may be further configured to clip each frame based on an object region in each frame corresponding to the aggregation result, and the obtaining relevant events based on each clipped frame.

What is claimed is:

1. A method executed by an electronic device, comprising:
acquiring behavior objects and relevant events associated with the behavior objects in a video to be processed by using an artificial intelligence (AI) network;
providing a behavior object selection interface based on the acquired behavior objects;
receiving a behavior object selected through the selection interface by a user; and
providing an event related to the behavior object selected by the user.

2. The method according to claim 1, wherein the acquiring the behavior objects comprises:
extracting semantic features of the video, the semantic features comprising semantic features in each frame to be processed, the semantic features in each frame comprising spatial semantic features and temporal semantic features; and
determining, based on the semantic features, the behavior objects and the relevant events in the video.

3. The method according to claim 2, wherein the extracting the semantic features comprises:
for each frame, extracting, based on a convolution module, a first semantic feature of the frame and a second semantic feature of an adjacent frame;
determining, based on the first semantic feature and the second semantic feature, first semantically related patches in the frame and second semantically related patches in the adjacent frame;
extracting, from the first semantically related patches in the frame, first spatial semantic features of objects in the frame;
extracting, from the second semantically related patches in the adjacent frame, first temporal semantic features of objects in the frame; and
fusing the first spatial semantic features and the first temporal semantic features to obtain the semantic features of the frame.

4. The method according to claim 3, wherein, for each frame, the extracting comprises:
performing convolution on the frame by using a first convolution layer;
spatially rearranging features of each channel from among features extracted by the first convolution layer;
performing convolution on the rearranged features by a second convolution layer; and
performing channel rearrangement on features of each space in features extracted by the second convolution layer to obtain semantic features of the frame.

5. The method according to claim 3, wherein the determining the first semantically related patches in the frame and the second semantically related patches in the adjacent frame comprises:
fusing the first semantic feature and the second semantic feature to obtain a first fused feature;
determining, based on the first fused feature and in the frame and the adjacent frame, spatial position offshoot information of other patches semantically related to each patch in the frame relative to the patch, respectively; and
determining, based on the spatial position offshoot information, the first semantically related patches in the frame and the second semantically related patches in the adjacent frame.

6. The method according to claim 2, wherein the determining the behavior objects and the relevant events in the video comprises:
determining, based on the semantic features of each frame and using an object mask module, a region where an object in each frame is located;
determining, based on the semantic features of the frame and the region where the object in the frame is located, region features of the region where the object in the frame is located; and
determining, based on the region features of the region where the object in each frame is located, the behavior objects and the relevant events in the video.

7. The method according to claim 6, wherein the determining the region where the object in each frame is located comprises:
for each frame, fusing a first semantic features of the frame and a second semantic features of the adjacent frame to obtain a first fused features; and
performing an object segmentation on the first fused features by using the object mask module to obtain the region where the object in the frame is located.

8. The method according to claim 6, wherein the determining the behavior objects comprises:
for the frame, obtaining object features corresponding to the frame based on the region features of the region where the object in the frame is located;
determining, based on the object features and using an object recognition model, whether the behavior objects are contained in the frame; and
obtaining the behavior objects and the relevant events in the video based on behavior object features, wherein the behavior object features are object features of frames containing the behavior objects.

9. The method according to claim 8, wherein the obtaining object features comprises:
fusing the region features of the region where the object in the frame is located and the semantic features of the frame to obtain target features of the frame; and
fusing the target features of the frame and the region features of the region where the object in the frame is located to obtain the object features of the frame.

10. The method according to claim 9, wherein the fusing the region features comprises:
fusing the region features of the region where the object in the frame is located and the semantic features of the adjacent frame;
extracting, from the region where the object in the frame is located, target region features of the object in the frame; and
fusing the target region features and the semantic features of the frame to obtain the target features of the frame.

11. The method according to claim 8, wherein the obtaining the behavior objects comprises:
aggregating the behavior objects features to obtain at least one aggregation result; and
obtaining, based on each frame corresponding to the at least one aggregation result, the behavior objects and the relevant events corresponding to the at least one aggregation result.

12. The method according to claim 11, wherein the aggregating the behavior object features comprises:
for each behavior object feature, determining at least one similar object feature of the behavior object feature from the object features;
extracting second fused features of the behavior objects based on the behavior object features and the at least one similar object feature; and
aggregating the second fused features corresponding to the behavior object features.

13. The method according to claim 12, wherein the extracting the second fused features comprises:
fusing each similar object feature of the behavior object features to obtain third fused features;
performing feature extraction on the third fused features in at least two different feature extraction modes to obtain at least two fused object features;
obtaining a weight corresponding to each fused object features based on a correlation between the behavior object features and each fused object feature; and
performing weighted fusion on the fused object features by using the weight corresponding to each fused object feature to obtain the second fused features of the behavior objects.

14. The method according to any one of claim 11, wherein the obtaining the behavior objects and the relevant events corresponding to the at least one aggregation result comprises:
for the aggregation result, determining, based on the behavior object feature in the aggregation result, the quality of the behavior object in the frame corresponding to the behavior object feature;
determining the behavior object in the video based on the quality of the behavior object in the frame corresponding to the aggregation result; and
determining relevant events of the behavior object based on each frame corresponding to the aggregation result.

15. The method according to claim 14, wherein the determining relevant events of the behavior object based on each frame corresponding to the aggregation result comprises at least one of the following:
removing a background in each frame corresponding to the aggregation result, and obtaining relevant events based on each frame with the background removed; and
clipping each frame based on an object region in each frame corresponding to the aggregation result, and the obtaining relevant events based on each clipped frame.

16. An electronic device, the electronic device comprising at least one processor, wherein the at least one processor is configured to:
acquire behavior objects and relevant events associated with the behavior objects in a video to be processed by using an artificial intelligence (AI) network;
provide a behavior object selection interface based on the acquired behavior objects;
receive a behavior object selected through the selection interface by a user; and
provide an event related to the behavior object selected by the user.

17. The electronic device according to claim 16, wherein the at least one processor is further configured to:
extract semantic features of the video, the semantic features comprising semantic features in each frame to be processed, the semantic features in each frame comprising spatial semantic features and temporal semantic features; and
determine, based on the extracted semantic features, the behavior objects and the relevant events in the video.

18. The electronic device according to claim 17, wherein the at least one processor is further configured to:
for each frame, extract, based on a convolution module, a first semantic feature of the frame and a second semantic feature of an adjacent frame;
determine, based on the first semantic feature and the second semantic feature, first semantically related patches in the frame and second semantically related patches in the adjacent frame;
extract, from the first semantically related patches in the frame, first spatial semantic features of objects in the frame;
extract, from the second semantically related patches in the adjacent frame, first temporal semantic features of objects in the frame; and
fuse the first spatial semantic features and the first temporal semantic features to obtain the semantic features of the frame.

19. The method according to claim 17, wherein the at least one processor is further configured to:
determine, based on the semantic features of each frame and using an object mask module, a region where an object in each frame is located;
determine, based on the semantic features of the frame and the region where the object in the frame is located, region features of the region where the object in the frame is located; and
determine, based on the region features of the region where the object in each frame is located, the behavior objects and the relevant events in the video.

20. A computer-readable non-transitory storage medium having computer programs stored thereon that, when executed by a processor, implement the method according to claim 1.
